(19) United States
(12) Patent Application Publication
(10) Pub. No.: US 2026/0320631 A1
(43) Pub. Date: Oct. 15, 2026

(54) ENHANCED PRODUCT AND IMPACT TRACEABILITY

(71) Applicant: Genuine Marketing Group, Elko New Market, MN (US)

(72) Inventors: Gregory Scott NEEDHAM, Burnsville, MN (US); Charles Garbis CHASTAIN, Elko New Market, MN (US); Tobias Angus Giles MATHEWS, St. Martin (GB); Lyle Walter PACZKOWSKI, Mission Hills, KS (US)

(21) Appl. No.: 19/549,776

(22) Filed: Feb. 25, 2026

Related U.S. Application Data
(60) Provisional application No. 63/763,253, filed on Feb. 25, 2025.

(51) Int. Cl. G06Q 30/018; G06Q 10/083

(52) U.S. Cl. CPC G06Q 30/018; G06Q 10/083

(57) ABSTRACT

A system for agricultural carbon intensity tracking and certification includes a universal data store configured to store canonical agricultural operation records associated with a plurality of fields, wherein each canonical agricultural operation record comprises at least one of tillage data, irrigation data, fertilizer data, or harvest data. An ingestion layer receives agricultural operation data from multiple sources and normalizes it into canonical records. A program template engine retrieves a program template defining required fields and mapping rules for a carbon intensity program and auto-populates required fields from canonical records. A carbon intensity computation service computes an estimated carbon intensity score. A submission sealing service generates a sealed submission record stored in an immutable record subsystem. A binding service associates the sealed submission record with a shipment identifier corresponding to a physical agricultural product shipment.

### CROSS-REFERENCE TO RELATED APPLICATIONS

This application claims the benefit of U.S. Provisional Application No. 63/763,253, titled “Enhanced Product Traceability,” filed Feb. 25, 2025, which is hereby incorporated by reference in its entirety.

### SUMMARY OF THE INVENTION

The present disclosure addresses technical challenges in supply chain traceability, product authentication, and carbon intensity certification. Conventional traceability systems suffer from fragmentation across siloed platforms, vulnerability to counterfeiting through tag duplication, and computational overhead associated with traditional blockchain consensus mechanisms. The disclosed platform provides a decentralized exchange architecture, referred to as ZPDEX, that enables integration of inputs from linear supply chain systems and distributed ledger systems without requiring a dissociated central authority. The ZPDEX architecture employs smart contracts that manage asset exchanges and data recording operations autonomously, with directive loaders that enable smart contracts to reference external systems and daisy-chain verification steps across multiple contracts.

The platform employs an authentication tag (herein referred to as “ZPTAG”) authentication tags as scannable identifiers that create cryptographic bindings between physical products and blockchain-based traceability records. Each ZPTAG authentication tag may be implemented as a QR code, RFID tag, or NFC chip, and is linked to a corresponding record on a master blockchain that stores Critical Tracking Events and Key Data Elements throughout the supply chain. The platform manages tag lifecycle states including activation upon initial scanning with geolocation verification, deactivation upon custody transfer or consumer purchase, and reactivation for product returns. Consumer applications enable product verification through tag scanning, display of traceability information, and targeted recall notifications based on purchase history associations stored on the blockchain.

A library of distributed applications provides specialized functionality including compliance verification, product tracking, consumer rewards, and carbon intensity scoring. The distributed applications interface with the smart contract layer to execute validation logic and record transactions on the master blockchain. A token management component manages cryptographic tokens for trading fees and incentives, including carbon credits that track carbon created or captured throughout the product lifecycle for both producers and consumers.

In a carbon intensity embodiment, the platform provides a unified technical infrastructure that normalizes heterogeneous agricultural operation data into a canonical schema stored in a universal data store. An ingestion layer receives data through multiple channels including manual entry, file import, and API integration with external farm management systems, recording provenance metadata for each data record. A program template engine retrieves program-specific templates defining required fields, conditional dependencies, and computed field definitions, and auto-populates required fields by mapping data from canonical records according to template-defined mapping rules. A carbon intensity computation service computes estimated carbon intensity scores and supports what-if analysis that enables farmers to explore how practice changes would affect scores before committing to official submissions.

A submission sealing service manages the transition from editable draft submissions to immutable sealed submissions, generating cryptographic hashes and timestamps stored in an audit log. A certification integration service coordinates with accredited certifiers by transmitting sealed submission packages and receiving certified carbon intensity scores. A binding service associates certified carbon intensity submissions with shipment identifiers corresponding to physical agricultural product shipments, enabling downstream verification at receiving facilities. The platform supports silo segregation at co-op facilities by returning carbon intensity attributes in response to scan events, enabling routing decisions that direct shipments to appropriate storage locations based on certified carbon intensity scores and configured threshold bands.

### BRIEF DESCRIPTION OF THE DRAWINGS

FIG. 1 illustrates a high-level system architecture for enhanced product traceability, according to aspects of the present disclosure.

FIG. 2 illustrates a distributed ledger network, according to aspects of the present disclosure.

FIG. 3 illustrates a decentralized exchange architecture, according to aspects of the present disclosure.

FIG. 4 illustrates a distributed application library and smart contract interaction, according to aspects of the present disclosure.

FIG. 5 illustrates an end-to-end supply chain traceability flow, according to aspects of the present disclosure.

FIG. 6 illustrates tag lifecycle states, according to aspects of the present disclosure.

FIG. 7 illustrates product transformation and batch aggregation, according to aspects of the present disclosure.

FIG. 8A illustrates a single-chain blockchain configuration, according to aspects of the present disclosure.

FIG. 8B illustrates a multi-chain blockchain configuration, according to aspects of the present disclosure.

FIG. 9 illustrates smart contract daisy-chaining for verification, according to aspects of the present disclosure.

FIG. 10 illustrates a consumer application architecture and workflow, according to aspects of the present disclosure.

FIG. 11 illustrates a consumer scanning and purchase association flow, according to aspects of the present disclosure.

FIG. 12 illustrates a stakeholder application architecture, according to aspects of the present disclosure.

FIG. 13 illustrates a real-time recall notification system, according to aspects of the present disclosure.

FIG. 14 illustrates external data source integration via an API, according to aspects of the present disclosure.

FIG. 15 illustrates a token economy and carbon credit flow, according to aspects of the present disclosure.

FIG. 16 illustrates a carbon intensity module system architecture, according to aspects of the present disclosure.

FIG. 17 illustrates universal data schema and program template mapping, according to aspects of the present disclosure.

FIG. 18 illustrates a carbon intensity submission lifecycle state machine, according to aspects of the present disclosure.

FIG. 19 illustrates a carbon intensity-to-shipment binding and co-op receiving flow, according to aspects of the present disclosure.

FIG. 20 illustrates a carbon intensity computation and what-if analysis pipeline, according to aspects of the present disclosure.

FIG. 21 illustrates an exemplary computing device, according to aspects of the present disclosure.

### DETAILED DESCRIPTION

By way of background, modern supply chains involve complex networks of interconnected stakeholders that span from agricultural production through final consumer delivery. These stakeholders may include farmers who cultivate and harvest raw materials, processors who transform raw materials into intermediate goods, manufacturers who combine ingredients into finished products, distributors who transport goods across geographic regions, and retailers who present products to consumers. Each stakeholder in the supply chain may operate independently while maintaining relationships with upstream suppliers and downstream customers. The interconnected nature of these supply chain networks creates challenges for tracking products as they move through multiple custody transfers and transformation events.

Regulatory frameworks have emerged to address food safety concerns arising from the complexity of modern supply chains. The Food Safety Modernization Act (FSMA) represents a shift in food safety regulation from reactive response to proactive prevention. Under FSMA, the Food and Drug Administration (FDA) established requirements for enhanced traceability of certain food products. The Food Traceability List identifies categories of foods that present heightened risk and therefore require additional recordkeeping. Foods on the Food Traceability List may include leafy greens, fresh-cut fruits and vegetables, shell eggs, nut butters, and certain seafood products, among others.

FSMA traceability requirements center on the concepts of Critical Tracking Events (CTEs) and Key Data Elements (KDEs). A Critical Tracking Event refers to an event in the supply chain where a food product changes custody, location, or form. CTEs may include growing events, receiving events, transformation events, shipping events, and other events where traceability data should be captured. Key Data Elements refer to the specific data points that should be recorded at each Critical Tracking Event. KDEs may include lot codes, product descriptions, quantities, dates, times, locations, and identifiers of the parties involved in the event. The combination of CTEs and KDEs creates a documentary chain that enables tracing of products both forward to consumers and backward to sources.

Blockchain-based traceability systems provide a technical infrastructure for recording CTEs and KDEs in a manner that supports verification and audit. A blockchain comprises a distributed ledger maintained across multiple nodes, where each node stores a copy of the ledger. Transactions recorded on the blockchain are grouped into blocks, and each block is cryptographically linked to the previous block, creating a chain of blocks. The distributed nature of the ledger and the cryptographic linking of blocks creates resistance to tampering, as modification of a recorded transaction would require modification of all subsequent blocks across all nodes. Blockchain-based traceability systems may record supply chain events as transactions on the blockchain, creating an immutable record of the product journey from origin to consumer.

Conventional blockchain consensus mechanisms present technical limitations that affect performance and scalability in supply chain applications. Traditional proof-of-work consensus requires nodes to perform computationally intensive calculations to validate transactions and generate new blocks. These calculations consume substantial processing resources and electrical energy, introduce latency into transaction confirmation, and limit the throughput of transactions that the network can process. For supply chain traceability applications where numerous Critical Tracking Events may occur across geographically distributed stakeholders, the computational overhead of traditional consensus mechanisms may create bottlenecks that impair real-time data recording. The energy consumption associated with proof-of-work consensus may also conflict with sustainability objectives, particularly for platforms that aim to track and reduce carbon intensity.

The principles underlying supply chain traceability extend beyond regulatory compliance for food products. Authentication of high-value goods presents similar challenges of verifying provenance and chain of custody. Designer products, luxury items, and specialty foods may command premium prices based on their origin, manufacturing process, or brand authenticity. Counterfeit goods entering the supply chain may undermine brand value and consumer trust. Traceability systems that record custody transfers and verify authenticity at each stage may provide mechanisms for distinguishing genuine products from counterfeits. The same technical infrastructure that supports food safety traceability may be adapted to support authentication of luxury goods, designer products, pharmaceuticals, and other high-value items.

Carbon intensity scoring represents an adjacent application that leverages supply chain data for sustainability and monetization purposes. Carbon intensity refers to a measure of greenhouse gas emissions associated with production of a unit of output, such as grams of carbon dioxide equivalent per bushel of grain or per gallon of fuel. Agricultural operations contribute to carbon intensity through various practices including tillage methods, irrigation systems, fertilizer application, and transportation. Different farming practices may result in different carbon intensity scores for otherwise similar products. For example, no-till farming practices may result in lower carbon intensity compared to conventional tillage, and cover cropping may sequester carbon and reduce overall emissions.

Carbon intensity scoring creates opportunities for monetization of sustainable practices. Incentive programs may provide financial benefits to producers who achieve lower carbon intensity scores. The 45Z tax credit program, for example, provides incentives for production of clean fuels, where the credit amount varies based on the carbon intensity of feedstocks used in fuel production. Ethanol producers may value lower carbon intensity feedstocks because lower carbon intensity translates to higher tax credits. Farmers who can demonstrate lower carbon intensity for their grain may receive premium prices from buyers seeking to maximize tax credit benefits. The ability to track, verify, and certify carbon intensity scores throughout the supply chain creates value for multiple stakeholders, from farmers seeking premium prices to fuel producers seeking tax credits to consumers seeking sustainably produced goods.

Conventional approaches to supply chain traceability present various limitations that affect adoption, security, and operational effectiveness. Advanced tracking systems incorporating Internet of Things (IoT) devices, Radio Frequency Identification (RFID) tags, and GS1-based tracking standards may provide granular visibility into product movement and condition monitoring. However, these advanced systems may require substantial capital investment in hardware infrastructure, including readers, sensors, and communication equipment at each tracking point throughout the supply chain. The cost of deploying and maintaining such infrastructure may be prohibitive for smaller stakeholders, including independent farmers, regional processors, and small-scale distributors who lack the resources to implement enterprise-grade tracking solutions. The investment requirements may create barriers to participation that fragment traceability coverage, as gaps emerge wherever stakeholders cannot afford the technology.

Quick Response (QR) codes offer a cost-effective alternative to hardware-intensive tracking systems, as QR codes may be printed on existing packaging materials at minimal incremental cost. Stakeholders may generate and apply QR codes without specialized equipment beyond standard printing capabilities, and consumers may scan QR codes using smartphone cameras without dedicated reader hardware. However, QR codes present a technical security deficiency: they lack inherent cryptographic protocols that would prevent duplication and fraud. A QR code printed on a genuine product may be photographed and reproduced on counterfeit goods, allowing fraudulent products to present the same traceability information as authentic items. The absence of cryptographic binding between the physical product and the digital identifier creates a technical vulnerability to counterfeiting schemes where bad actors replicate codes from legitimate products onto unauthorized goods. This technical deficiency arises because conventional QR codes encode static data without any mechanism to verify that the physical item bearing the code is the same item to which the code was originally assigned. Without cryptographic binding that ties the digital identifier to the physical product in a tamper-evident manner, QR code-based systems may provide a false sense of traceability while remaining susceptible to manipulation.

Existing track-and-trace systems may operate in organizational silos that limit interoperability and data sharing across supply chain boundaries. A farmer may use one platform to record planting and harvest data, while a processor uses a different platform to track receiving and transformation events, and a distributor uses yet another platform to manage shipping and delivery. These disparate systems may store data in incompatible formats, use different identifier schemes, and lack standardized interfaces for exchanging information. The siloed nature of existing systems may require manual data re-entry at each custody transfer, introducing opportunities for error and delay. When a recall event occurs, investigators may need to query multiple disconnected systems and manually correlate records to trace affected products, extending the time required to identify and remove contaminated goods from commerce.

Current inventory control technologies may focus on monitoring stock levels at discrete points within the supply chain, such as warehouse locations or retail shelves, without maintaining continuous traceability from origin to consumer. These systems may track quantities of products entering and leaving a facility without preserving the linkage between specific incoming lots and outgoing shipments. When products from multiple sources are aggregated into common storage, the association between individual source lots and the aggregated inventory may be lost. The lack of end-to-end traceability may limit the ability to perform targeted recalls, as the system cannot identify which consumers received products from a specific contaminated lot. Additionally, many existing systems may function in online environments that depend on continuous network connectivity, rendering the systems ineffective during network failures or in locations with limited connectivity. Stakeholders operating in rural areas or during infrastructure disruptions may be unable to record events or verify product authenticity when network access is unavailable.

Scalability presents challenges as product volumes increase and supply chain networks expand. Systems designed for smaller operations may experience performance degradation when transaction volumes grow, and architectural limitations may constrain the ability to add new stakeholders or tracking points. Regulatory compliance requirements may evolve over time, and systems lacking flexibility may require substantial modification to accommodate new data elements or reporting formats. The combination of scalability constraints and regulatory evolution may create ongoing maintenance burdens that increase total cost of ownership. Additionally, systems that cannot scale horizontally may require expensive hardware upgrades to accommodate growth, creating capital expenditure requirements that may be prohibitive for smaller organizations seeking to participate in traceability programs.

For carbon intensity tracking, farmers may maintain operational data across multiple fragmented platforms and formats, including farm management software, equipment telemetry systems, spreadsheets, and paper records. The fragmentation of data sources may create redundancy and gaps that make compilation of complete carbon intensity datasets burdensome. Different incentive programs may require different sets of fields, validations, and attestations, and without a canonical data layer, each program submission may become a bespoke data collection effort that increases cost and error rate. Existing systems may lack mechanisms to differentiate between editable planning data used for what-if analysis and official submissions that require immutability for audit and certification purposes. The absence of clear lifecycle controls may undermine confidence in submitted data and complicate verification by third-party certifiers.

The absence of lifecycle state controls in existing carbon intensity systems presents a technical integrity problem. When data may be modified after submission, the system cannot provide cryptographic assurance that the data presented for certification or monetization is the same data that was originally recorded. Existing systems may lack mechanisms to enforce state transitions that seal data at defined points in the workflow, creating ambiguity about whether displayed values reflect current edits or officially submitted records. The technical challenge involves implementing application-layer controls that transition data from an editable state to an immutable state, generating tamper-evident records that can be independently verified, and preventing modification through any interface once the data has been sealed. Without such lifecycle controls enforced at the technical architecture level, the integrity of carbon intensity submissions cannot be assured for audit, certification, or commercial transactions.

The present disclosure describes an integrated platform that combines food safety compliance, carbon sustainability tracking, and consumer authentication within a single framework. The platform addresses the fragmentation, interoperability, and security limitations of conventional traceability systems by providing a unified technical infrastructure that serves multiple stakeholder needs across the supply chain. The platform enables farmers, processors, manufacturers, distributors, and retailers to record supply chain events on a shared blockchain ledger while maintaining appropriate access controls for sensitive business data. The platform enables consumers to verify product authenticity and access traceability information through scanning of authentication tags linked to blockchain records.

The platform employs a ZPTAG authentication tag as a scannable identifier that may be implemented as a QR code, an RFID tag, or an NFC chip. ZPTAG is a trade name of a potential product offered by Genuine Marketing Group, and refers to a scannable authentication tag that links physical products to blockchain-based traceability records. While described herein primarily as a QR code, RFID tag, or NFC chip, the ZPTAG authentication tag may take other forms including other optically discernable identifiers, electrically discernable identifiers, or combinations thereof. Each ZPTAG authentication tag may be linked to a corresponding record on a blockchain ledger, creating a cryptographic binding between the physical product and the digital traceability data. This cryptographic binding addresses the technical vulnerability present in conventional QR code systems by ensuring that the digital identifier is uniquely associated with a specific physical product in a manner that cannot be replicated without detection. The ZPTAG authentication tag may encode a unique identifier that, when scanned, retrieves the associated blockchain record containing the complete provenance and chain of custody information for the tagged product. The system may detect duplication attempts by monitoring for scan events that occur at inconsistent locations or times, flagging potential counterfeiting when the same identifier appears in geographically incompatible scan patterns. The linkage between the physical tag and the blockchain record, combined with scan event monitoring, provides a technical solution to the counterfeiting vulnerabilities present in conventional QR code systems.

The blockchain ledger may serve as a decentralized, immutable repository for supply chain data. The blockchain ledger may store FSMA compliance data including Critical Tracking Events and Key Data Elements recorded at each custody transfer and transformation event throughout the supply chain. The blockchain ledger may also store carbon footprint tracking data including agricultural operation records, carbon intensity scores, and certification results. The distributed nature of the blockchain ledger may provide resistance to tampering, as modification of recorded data would require coordinated changes across multiple nodes maintaining copies of the ledger. The immutability of the blockchain ledger may support audit and verification requirements for both regulatory compliance and carbon intensity certification.

The platform may employ a decentralized exchange architecture, referred to as ZPDEX, that addresses the technical limitations of conventional blockchain consensus mechanisms. The ZPDEX architecture enables smart contracts to manage asset exchanges and data recording without requiring computationally intensive proof-of-work calculations. The system is self-sustaining in that data integrity is ensured by the architecture itself rather than by redundant consensus validation across all nodes. By eliminating the computational overhead associated with traditional consensus mechanisms, the ZPDEX architecture reduces latency in transaction confirmation, increases transaction throughput, and decreases energy consumption compared to conventional blockchain implementations. The ZPDEX architecture serves as a controlling self-managed entity that coordinates data flows between participants while maintaining the immutability and transparency properties of blockchain-based systems.

Smart contracts may facilitate automated data collection and validation within the platform. A smart contract comprises executable code stored on the blockchain that executes automatically when predefined conditions are satisfied. Smart contracts may validate incoming data against compliance requirements, verify that required data elements are present and properly formatted, and record validated data to the blockchain ledger. The automated execution of smart contracts may reduce manual intervention in data recording, thereby reducing opportunities for error or manipulation. Smart contracts within the platform may include directive loaders that enable a smart contract to reference external systems to obtain additional data when required information is not present in the immediate transaction context. This capability enables smart contracts to be daisy-chained, where different contracts handle distinct verification steps in sequence. For example, a first smart contract may validate cold chain temperature compliance, then pass control to a second smart contract that validates FSMA compliance data, which in turn passes control to a third smart contract that verifies sustainability credentials. The modular daisy-chain architecture enables verification logic to be updated, extended, or customized without modifying the entire contract infrastructure. Smart contracts may also implement business logic for carbon intensity calculations, certification workflows, and incentive distributions.

The platform may include consumer applications and stakeholder applications that provide interfaces for interacting with the blockchain-based traceability infrastructure. Consumer applications may enable product verification through tag scanning, display of traceability information including origin and distribution path, and receipt of recall notifications for purchased products. Stakeholder applications may enable supply chain participants to record Critical Tracking Events, manage tag inventories, track compliance status, and generate reports for regulatory submission. The applications may communicate with the blockchain ledger through a decentralized exchange architecture that manages asset exchanges and coordinates data flows between participants.

A carbon intensity module may operate as an adjacent feature within the platform, leveraging universal data collected through the traceability infrastructure to generate program-specific submissions for carbon incentive programs. The carbon intensity module may address the data fragmentation problem by maintaining a canonical universal data layer that normalizes agricultural operation data from heterogeneous sources into a standardized schema. The carbon intensity module may address the integrity problem by implementing lifecycle controls that distinguish between editable draft submissions used for what-if planning and sealed submissions that become immutable upon filing. The carbon intensity module may address the digital-to-physical binding problem by associating certified carbon intensity scores with shipment identifiers, enabling verification of carbon credentials at custody transfer points such as co-op receiving facilities. The carbon intensity module may support monetization of sustainable farming practices by facilitating certification of carbon intensity scores and linking certified scores to physical shipments eligible for premium pricing or tax credit programs.

The technical improvements provided by the platform address specific technical problems in supply chain traceability and carbon intensity tracking. First, the cryptographic binding between ZPTAG authentication tags and blockchain records solves the tag duplication vulnerability present in conventional QR code systems by enabling detection of inconsistent scan patterns that indicate counterfeiting attempts. Second, the ZPDEX architecture with simplified consensus reduces the computational overhead, latency, and energy consumption associated with traditional blockchain consensus mechanisms while maintaining data integrity through architectural design rather than redundant validation. Third, the directive loader capability enables smart contracts to reference external data sources and daisy-chain verification steps, providing a modular technical architecture for cross-system data integration that addresses the interoperability limitations of siloed traceability systems. Fourth, the submission lifecycle state machine enforces data immutability at the application layer by implementing state transitions that seal submission records, generate tamper-evident hashes, and prevent modification through any interface after sealing, thereby addressing the integrity problem in carbon intensity certification workflows.

The examples and embodiments described herein are illustrative and are not intended to limit the scope of the present disclosure. Variations, modifications, and equivalents of the described embodiments may be implemented without departing from the principles described. The specific configurations, architectures, and implementations presented serve to explain the concepts and enable practice of the described techniques, but alternative implementations may achieve similar results through different technical approaches. The scope of the disclosure encompasses all such variations and modifications that fall within the spirit of the described principles. References to specific protocols, standards, or technologies are illustrative and do not limit the disclosure to those specific implementations.

Methods described herein may include multiple steps, and the steps are not inherently ordered unless explicitly stated otherwise. Steps may be performed in different sequences than presented, steps may be performed concurrently, steps may be omitted in certain implementations, and additional steps may be included. When a method is described as including a plurality of steps, the description does not imply that all steps are performed in every implementation or that the steps occur in any particular temporal relationship unless the description explicitly specifies an ordering constraint. For example, a description stating that a first step occurs “in response to” a second step indicates a temporal relationship, whereas a description listing steps without such language does not mandate any particular sequence.

Functions described herein may be implemented in hardware, software, firmware, or combinations thereof. Hardware implementations may include application-specific integrated circuits, field-programmable gate arrays, discrete logic components, or general-purpose processors executing instructions. Software implementations may include instructions stored on non-transitory computer-readable media and executed by one or more processors. Firmware implementations may include instructions stored in non-volatile memory and executed during system operation. A function described as performed by a particular component may be distributed across multiple components, and functions described as performed by multiple components may be consolidated into a single component. The allocation of functions to components may vary across implementations based on design considerations including performance, cost, power consumption, and manufacturing constraints.

Reference numerals are used consistently throughout the present disclosure to identify components, modules, and elements. A reference numeral appearing in multiple figures refers to the same component or a corresponding component across the figures unless the context indicates otherwise. Components identified by the same reference numeral may have the same structure and function across embodiments, or may have variations appropriate to the particular embodiment in which the component appears. When a component is described in connection with one figure, the description applies to appearances of that component in other figures unless a different description is provided.

Components described herein may be combined, separated, or implemented differently in various embodiments. A component described as a single unit may be implemented as multiple sub-components in some embodiments, and components described as separate units may be combined into a single component in other embodiments. Modules described as distinct may share underlying hardware or software resources, and modules described as integrated may be implemented as separate processes or circuits. The boundaries between components, modules, layers, and services are conceptual and may not correspond to physical or logical boundaries in a particular implementation. A system described as including particular components may include additional components not explicitly described, and a system may omit components that are described as optional or that are not required for a particular use case.

When the present disclosure describes that a component “may” perform a function or “may” have a characteristic, the description indicates that the function or characteristic is present in some embodiments and absent in other embodiments. The use of “may” does not indicate uncertainty about whether the function or characteristic exists, but rather indicates that the function or characteristic is optional across the scope of the disclosure. Similarly, when the present disclosure describes that a component performs a function “in some embodiments” or “in some cases,” the description indicates that alternative embodiments exist in which the component does not perform that function or performs the function differently.

Numerical values, ranges, and quantities described herein are approximate unless stated otherwise. A value described as “about” a particular number includes values within a reasonable tolerance of that number as understood by persons of ordinary skill in the relevant technical field. Ranges described herein include the endpoints unless stated otherwise, and a range described as “between” two values includes both endpoint values. When a plurality of values or ranges is described, the values and ranges are illustrative and other values within the general scope may be used.

The term “coupled” as used herein refers to a relationship between components that enables communication, interaction, or influence between the components. Coupling may be direct, where components are physically connected or in immediate communication, or indirect, where components communicate through intermediate components. Coupling may be wired or wireless, synchronous or asynchronous, and may involve electrical signals, optical signals, data packets, or other forms of information transfer. The term “communicatively coupled” refers to coupling that enables data communication between components.

The term “configured to” as used herein indicates that a component has structure, circuitry, instructions, or other characteristics that enable the component to perform the described function. A component configured to perform a function may perform that function in response to appropriate inputs, conditions, or commands, and the component may also perform other functions not explicitly described. The term “configured to” does not require that the component perform the function at all times or in all operating modes.

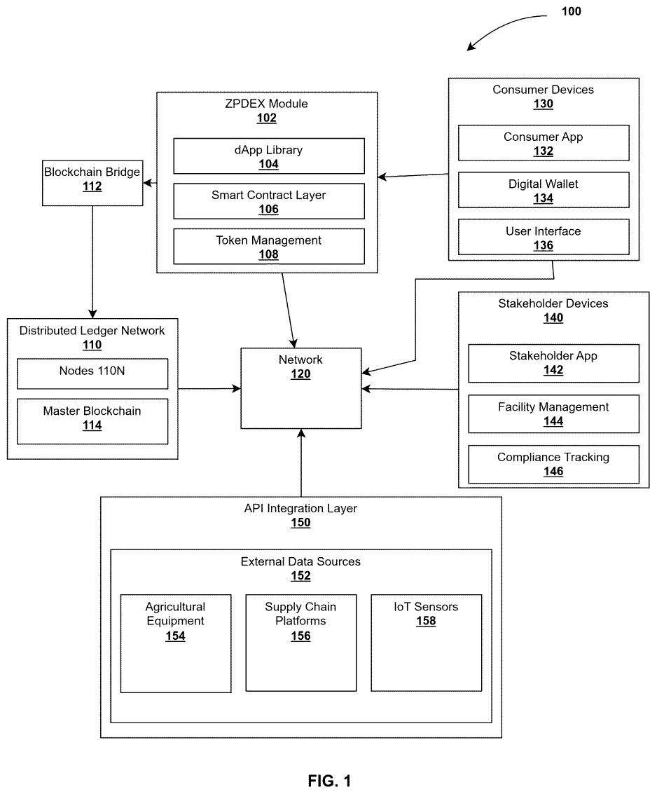

Referring to FIG. 1, a system architecture 100 for enhanced product traceability is illustrated in accordance with some embodiments of the present disclosure. The system architecture 100 comprises an integrated platform that combines food safety compliance, carbon sustainability tracking, and consumer authentication within a unified technical infrastructure. The system architecture 100 includes a ZPDEX module 102, a distributed ledger network 110, a network 120, consumer devices 130, stakeholder devices 140, and an API integration layer 150 that communicate through defined interfaces to record, store, and retrieve supply chain data.

The system architecture 100 includes a ZPDEX module 102 that serves as a central processing component within the platform. The ZPDEX module 102 may function as a decentralized exchange architecture that coordinates data flows, manages asset exchanges, and tracks value statements without requiring a dissociated central authority. The ZPDEX module 102 may serve as a self-managed controlling entity that enables integration of inputs from linear supply chain systems and chain-based distributed ledger systems. The ZPDEX module 102 contains three nested components that provide distinct functional capabilities within the platform architecture. The ZPDEX module 102 communicates with the distributed ledger network 110 through a blockchain bridge 112 that translates application requests into blockchain transactions and retrieves data from the master blockchain 114 in response to queries from connected applications and services.

A decentralized application (dApp) library 104 is contained within the ZPDEX module 102 and comprises a plurality of distributed applications that provide specialized functionality within the traceability ecosystem. The distributed applications within the dApp library 104 include a compliance dApp 312 for regulatory verification, a tracking dApp 314 for product traceability, a rewards dApp 316 for consumer incentive programs, and a carbon dApp 318 for sustainability scoring. Each distributed application within the dApp library 104 interfaces with the smart contract layer 106 to invoke smart contracts that execute the application logic. The dApp library 104 exposes application programming interfaces that the consumer application 132 and the stakeholder application 142 invoke to access platform functionality.

A smart contract layer 106 is contained within the ZPDEX module 102 and includes executable code that manages asset exchanges and data recording operations. The smart contract layer 106 contains smart contracts 322 that execute automatically when predefined conditions are satisfied, validating incoming data and recording validated transactions to the master blockchain 114. The smart contracts within the smart contract layer 106 include directive loaders 324 that query external systems through the API integration layer 150 to obtain additional data when required information is not present in the immediate transaction context. The smart contract layer 106 supports daisy-chaining of verification steps, where a first smart contract invokes a second smart contract upon completion, passing verification results and control to enable sequential multi-domain verification.

A token management component 108 is contained within the ZPDEX module 102 and manages cryptographic tokens used for trading fees, incentives, and value exchange within the ecosystem. The token management component 108 stores records 108 associated with token transactions, carbon credits, and incentive distributions. The token management component 108 tracks carbon created or captured for both producers and consumers by recording carbon intensity scores and associating those scores with token allocations. The token management component 108 interfaces with the smart contract layer 106 to execute token transfers and reward distributions based on predefined rules encoded in smart contracts.

With continued reference to FIG. 1, a distributed ledger network 110 is included within the system architecture 100 and stores supply chain data across multiple nodes. The distributed ledger network 110 comprises multiple nodes that maintain copies of the ledger and participate in transaction validation. The distributed ledger network 110 includes a node 110A, a node 110B, a node 110C, a node 110D, a node 110E, a node 110F, and additional nodes 110N that collectively form the network infrastructure. Each node within the distributed ledger network 110 stores a copy of the blockchain ledger, and transactions recorded on the ledger are replicated across the nodes. Modification of recorded data requires coordinated changes across multiple nodes, as each block contains a cryptographic hash of the previous block that would become invalid if prior data were altered.

A master blockchain 114 is contained within the distributed ledger network 110 and serves as the authoritative ledger for all supply chain transactions. The master blockchain 114 stores Critical Tracking Events, Key Data Elements, carbon intensity submissions, certification results, and other traceability data. The master blockchain 114 employs a simplified consensus mechanism that reduces computational overhead compared to traditional proof-of-work consensus. Transactions recorded on the master blockchain 114 are grouped into blocks that are cryptographically linked to previous blocks through hash references, creating a chain structure where modification of any block invalidates subsequent blocks.

A blockchain bridge 112 is communicatively coupled between the ZPDEX module 102 and the distributed ledger network 110 and translates between application requests and blockchain transactions. The blockchain bridge 112 converts requests from applications into blockchain transaction formats and submits the transactions to the distributed ledger network 110 for validation. The blockchain bridge 112 retrieves data from the master blockchain 114 in response to queries and returns the data in formats consumable by the requesting applications. The blockchain bridge 112 abstracts blockchain protocol details from the consumer application 132 and the stakeholder application 142.

A network 120 is included within the system architecture 100 and provides communication pathways connecting the various system components. The network 120 may comprise one or more communication networks including the Internet, private networks, wireless networks, and combinations thereof. The network 120 carries data packets between the ZPDEX module 102, the distributed ledger network 110, the consumer devices 130, the stakeholder devices 140, and the API integration layer 150. The network 120 supports communication protocols including HTTP for application requests, WebSocket for real-time notifications, and blockchain-specific protocols for transaction submission and block propagation. The network 120 may include routing infrastructure that directs traffic between geographically distributed nodes 110N and client devices.

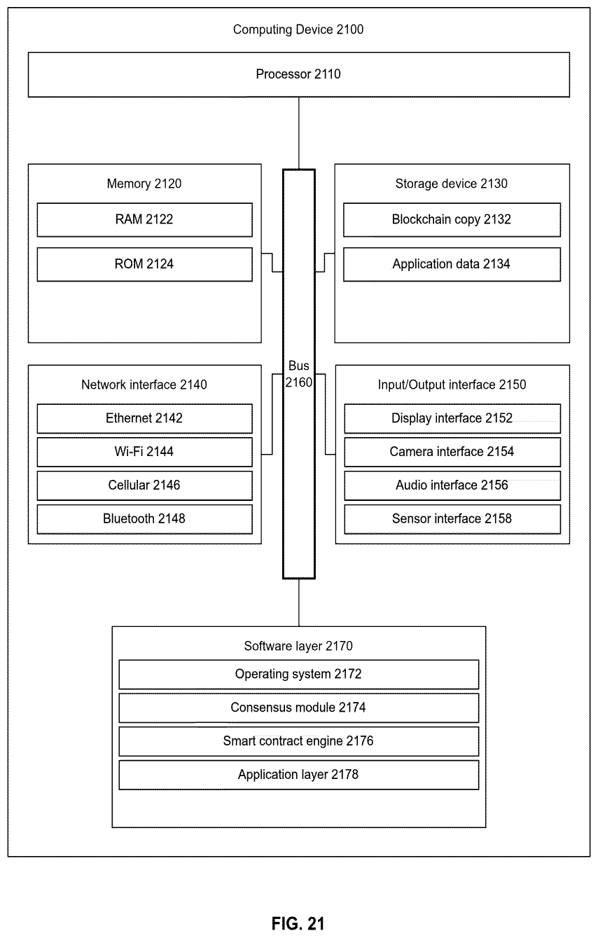

As further shown in FIG. 1, consumer devices 130 are included within the system architecture 100 and provide interfaces for consumers to interact with the traceability platform. The consumer devices 130 may include smartphones, tablets, or other computing devices equipped with cameras for scanning tags and displays for presenting product information. The consumer devices 130 are in communication with the network 120 and communicate with the ZPDEX module 102 through the blockchain bridge 112 to submit scan events and retrieve traceability records. The consumer devices 130 include a consumer application 132, a digital wallet 134, and a user interface 136 that collectively provide product verification, token management, and information display functionality. In other aspects the consumer device 130 may take the form of a desktop computer, or any other types of computer processing device that may or may not have a camera, which may be utilized to interact with the broader system architecture 100, having any one or more features or components of the computer entity 2100 of FIG. 21.

A consumer application 132 is contained within the consumer devices 130 and provides functionality for product verification and authentication. The consumer application 132 includes a scanning module that captures images of ZPTAG authentication tags using a device camera and decodes the tag identifiers. The consumer application 132 transmits decoded tag identifiers to the ZPDEX module 102, which queries the master blockchain 114 to retrieve associated traceability records. The consumer application 132 displays origin information, distribution path, compliance status, and carbon intensity scores retrieved from the blockchain records. The consumer application 132 maintains a local purchase history that associates the consumer with purchased products, and receives push notifications from the platform when recall events affect products in the purchase history.

A digital wallet 134 is contained within the consumer devices 130 and stores cryptographic keys and token balances for the consumer. The digital wallet 134 maintains a private key that the consumer uses to sign transactions submitted to the blockchain, and a corresponding public key that serves as the consumer's wallet address for receiving tokens. The digital wallet 134 queries the master blockchain 114 through the ZPDEX module 102 to retrieve current token balances associated with the wallet address. The digital wallet 134 interfaces with the token management component 108 to execute token transfers, redemptions, and reward claims by submitting signed transactions that the smart contract layer 106 validates and records.

A user interface 136 is contained within the consumer devices 130 and renders visual elements for tag scanning and product information display. The user interface 136 includes a camera viewfinder that frames ZPTAG authentication tags for capture by the scanning module, a results display that presents traceability data retrieved from the blockchain, and input controls for configuring preferences and alerts. The user interface 136 renders drill-down navigation elements that link summary information to detailed records at each stage of the product's supply chain journey. The user interface 136 displays warning indicators when scanned products contain ingredients matching consumer-specified allergens or dietary restrictions stored in the personalization layer 1040.

Stakeholder devices 140 are included within the system architecture 100 and provide interfaces for supply chain participants to interact with the traceability platform. The stakeholder devices 140 may include desktop computers, laptop computers, tablets, or specialized devices used by farmers, processors, manufacturers, distributors, and retailers. The stakeholder devices 140 are in communication with the network 120 and communicate with the ZPDEX module 102 through the blockchain bridge 112 to submit Critical Tracking Events and retrieve compliance data. The stakeholder devices 140 implement role-based access controls that restrict functionality based on the stakeholder type and organizational permissions stored in the organization records 1624. The stakeholder devices 140 include a stakeholder application 142, a facility management module 144, and a compliance tracking module 146. In other aspects the stakeholder device 140 may take the form of a desktop computer, or any other types of computer processing device that may or may not have a camera, which may be utilized to interact with the broader system architecture 100, having any one or more features or components of the computer entity 2100 of FIG. 21.

A stakeholder application 142 is contained within the stakeholder devices 140 and provides interfaces for supply chain management operations. The stakeholder application 142 includes data entry forms for recording Critical Tracking Events at custody transfers and transformation events, capturing lot codes, quantities, timestamps, and party identifiers as Key Data Elements. The stakeholder application 142 includes a tag management interface for activating tags, associating tags with products or batches, deactivating tags upon custody transfer, and invalidating compromised tag batches. The stakeholder application 142 includes reporting functions that query the master blockchain 114 to generate compliance reports containing CTE and KDE records in electronically sortable formats.

A facility management module 144 is contained within the stakeholder devices 140 and maintains records of facility locations and attributes. The facility management module 144 stores facility records 1626 including geographic coordinates, physical addresses, storage capacities, and operational capabilities for each facility operated by the stakeholder organization. The facility management module 144 includes GPS verification that compares scan event coordinates against stored facility coordinates to verify that scan events occur at expected locations. The facility management module 144 supports hierarchical facility structures where a parent organization may contain multiple child facilities, each with distinct location records and operational attributes stored in the universal data store 1620.

A compliance tracking module 146 is contained within the stakeholder devices 140 and monitors FSMA compliance status for the stakeholder organization. The compliance tracking module 146 includes a CTE recorder 1254 that captures Critical Tracking Event data including event type, timestamp, location, and associated product identifiers. The compliance tracking module 146 includes a KDE recorder 1256 that captures Key Data Element data including lot codes, product descriptions, quantities, and party identifiers. The compliance tracking module 146 includes an anomaly detector 1258 that compares recorded data against compliance requirements and generates alerts when required data elements are missing or when recorded values fall outside expected ranges. The compliance tracking module 146 stores compliance records on the master blockchain 114 through the smart contract layer 106.

With continued reference to FIG. 1, an API integration layer 150 is included within the system architecture 100 and provides interfaces for connecting external data sources to the traceability platform. The API integration layer 150 includes an authentication module 1412 that verifies credentials presented by external data sources before accepting data submissions. The API integration layer 150 includes a rate limiter 1414 that controls the volume of incoming data requests to prevent system overload. The API integration layer 150 includes a data normalizer 1442 that transforms data from various external formats into the canonical schema used by the universal data store 1620. The API integration layer 150 records provenance metadata 1648 indicating the ingestion method for each data record.

External data sources 152 are included within the API integration layer 150 and represent systems and devices that provide data to the traceability platform. The external data sources 152 include agricultural equipment 154 such as tractors, harvesters, and irrigation systems that transmit operational data through equipment telemetry interfaces. The external data sources 152 include supply chain platforms 156 such as inventory management systems, warehouse management systems, and transportation management systems that exchange data through standardized APIs. The external data sources 152 include IoT sensors 158 such as temperature sensors, humidity sensors, and GPS trackers that transmit environmental and location data. Each external data source 152 connects to the API integration layer 150 through a defined interface, and the API integration layer 150 records the data source identifier as provenance metadata with each ingested record.

Agricultural equipment 154 is included within the external data sources 152 and represents farm machinery and systems that generate data on crop production activities. The agricultural equipment 154 may include tractors, harvesters, irrigation systems, and other machinery equipped with telemetry capabilities that capture operational data during field activities. The agricultural equipment 154 may provide automated data capture for tillage operations, planting events, fertilizer applications, pesticide treatments, irrigation activities, and harvest operations. Data from the agricultural equipment 154 may be ingested through the API integration layer 150 and normalized into canonical agricultural operation records within the platform's universal data store.

Supply chain platforms 156 are included within the external data sources 152 and represent existing enterprise systems used by stakeholders for inventory management, warehouse management, and transportation management. The supply chain platforms 156 may include systems that stakeholders have deployed prior to adopting the traceability platform, enabling integration with existing operational infrastructure rather than requiring replacement of established systems. Data from the supply chain platforms 156 may be ingested through the API integration layer 150 to capture receiving events, shipping events, and other Critical Tracking Events recorded in stakeholder systems.

IoT sensors 158 are included within the external data sources 152 and represent environmental monitoring devices deployed throughout the supply chain. The IoT sensors 158 may include temperature sensors, humidity sensors, location trackers, and other devices that monitor conditions affecting product quality and safety. The IoT sensors 158 may provide continuous monitoring data that supports cold chain verification for perishable products, enabling automated validation of temperature compliance during storage and transportation. Data from the IoT sensors 158 may be ingested through the API integration layer 150 and associated with specific product lots and shipments for traceability purposes.

A data aggregation infrastructure 170 facilitates aggregation of data from various entities using the distributed ledger network 110. The data aggregation infrastructure 170 may reduce data silos by providing a common data layer that multiple stakeholders can access according to their permissions and roles. The data aggregation infrastructure 170 may enable data sharing between stakeholders who participate in common supply chains, allowing downstream participants to access relevant upstream data without requiring direct integration with each upstream system. The data aggregation infrastructure 170 may normalize data from heterogeneous sources into a canonical schema that supports consistent querying and reporting across the platform. The data aggregation infrastructure 170 may also support aggregation of carbon intensity data from multiple fields and harvests, enabling computation of weighted average carbon intensity scores for aggregated lots at co-op facilities and other aggregation points within the supply chain.

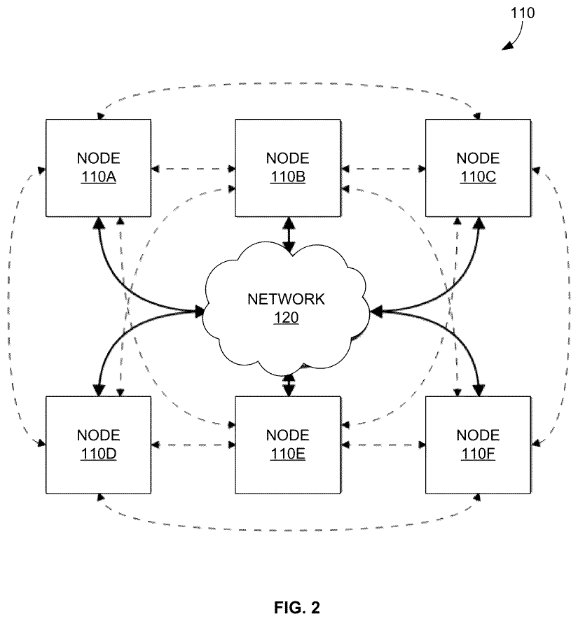

Referring to FIG. 2, the distributed ledger network 110 is illustrated in greater detail in accordance with some embodiments of the present disclosure. The distributed ledger network 110 comprises a decentralized infrastructure for storing and validating supply chain records, FSMA compliance data, carbon intensity submissions, and consumer purchase associations. The distributed ledger network 110 employs a peer-to-peer network topology where each node operates as a peer to every other node within the network, such that no single node is more influential than any other node in determining the validity of transactions or the state of the ledger.

The distributed ledger network 110 includes the node 110A, the node 110B, the node 110C, the node 110D, the node 110E, the node 110F, and additional nodes 110N that collectively maintain the distributed ledger. Each of the nodes 110N communicates directly with other nodes within the network, forming a mesh topology where data propagates across multiple paths rather than through a central coordinator. The nodes 110N may be operated by different stakeholders within the supply chain ecosystem, including farmers, processors, manufacturers, distributors, retailers, and platform operators, distributing control of the ledger across multiple independent parties.

With continued reference to FIG. 2, operations performed by the nodes 110N may include validating transactions, verifying blocks of transactions, and adding records to an immutable database that is collectively maintained by the nodes 110N. When a stakeholder submits a transaction to the distributed ledger network 110, such as a Critical Tracking Event recording a custody transfer or a carbon intensity submission, the transaction may be broadcast to the nodes 110N for validation. Each node receiving the transaction may independently verify that the transaction conforms to the rules and constraints defined by the smart contracts within the smart contract layer 106. The nodes 110N may verify that the transaction includes required data elements, that digital signatures are valid, and that the transaction does not conflict with previously recorded transactions.

The distributed ledger network 110 employs a consensus module that coordinates agreement among the nodes 110N regarding which transactions should be added to the ledger. The consensus module requires records to be added to the master blockchain 114 based on a determination that a consensus of the nodes 110N has collectively validated the transaction. The consensus module implements a simplified consensus protocol that reduces computational overhead compared to traditional proof-of-work mechanisms. The simplified consensus protocol relies on the architectural design of the platform and the trust relationships among participating nodes rather than computationally intensive cryptographic puzzles.

Validation within the distributed ledger network 110 may be facilitated using features of asymmetric key cryptography. Each participant within the platform may be assigned a public-private key pair that enables digital signatures and identity verification. The private key may be maintained securely by the participant and used to generate digital signatures that authenticate transactions submitted by that participant. The public key may be shared with other participants and the nodes 110N, enabling verification that a digital signature was generated by the holder of the corresponding private key. Wallet addresses may be derived from public keys and may serve as identifiers for participants within the distributed ledger network 110. When a stakeholder submits a transaction, the stakeholder may sign the transaction using the stakeholder's private key, and the nodes 110N may verify the signature using the stakeholder's public key to confirm that the transaction originated from an authorized party.

As further shown in FIG. 2, the master blockchain 114 within the distributed ledger network 110 may store various record types that support supply chain traceability and carbon intensity tracking. The master blockchain 114 may store transaction records that capture Critical Tracking Events including receiving events, shipping events, transformation events, and custody transfers. The master blockchain 114 may store smart contracts comprising executable code that automates validation and business logic within the platform. The master blockchain 114 may store electronic documents including compliance certificates, certification results, and attestations from accredited certifiers. The master blockchain 114 may store images including photographs of products, facilities, or documentation that support verification and audit activities.

The master blockchain 114 may also store uniform resource identifiers (URIs) that reference external resources including detailed documentation, supporting evidence, or supplementary data that exceeds the storage capacity appropriate for direct blockchain storage. The master blockchain 114 may store unique identifiers including ZPTAG identifiers, lot codes, batch identifiers, and shipment identifiers that enable association between blockchain records and physical products or shipments. The master blockchain 114 may store timestamps that record when events occurred and when records were added to the ledger, providing temporal ordering for audit and compliance purposes. The master blockchain 114 may store cryptographic hashes that provide tamper-evident fingerprints of data, enabling verification that referenced data has not been modified since the hash was recorded.

The distributed ledger network 110 stores supply chain records that support FSMA compliance requirements. Critical Tracking Events and Key Data Elements recorded on the master blockchain 114 are preserved in an unalterable form. The cryptographic chaining of blocks within the master blockchain 114 prevents modification of recorded data without detection, as any change to a recorded transaction would invalidate the hash references in subsequent blocks.

The distributed ledger network 110 stores carbon intensity submissions and certification results. When a farmer submits a carbon intensity package for certification, the submission is sealed and recorded on the master blockchain 114 with a cryptographic hash that references the submission contents. Certified carbon intensity scores returned by accredited certifiers are recorded on the master blockchain 114 in association with the corresponding submission records, linking the certified score to the sealed submission through a common submission identifier.

The distributed ledger network 110 stores consumer purchase associations that link consumers to purchased products. When a consumer purchases a product and the associated tag is deactivated, a purchase record is created on the master blockchain 114 that associates the consumer identifier with the product identifier. The purchase association record includes the consumer wallet address, the ZPTAG identifier, the transaction timestamp, and the lot code of the purchased product. When recall events occur, the platform queries the master blockchain 114 to identify purchase association records matching the affected lot codes, returning the consumer identifiers for notification.

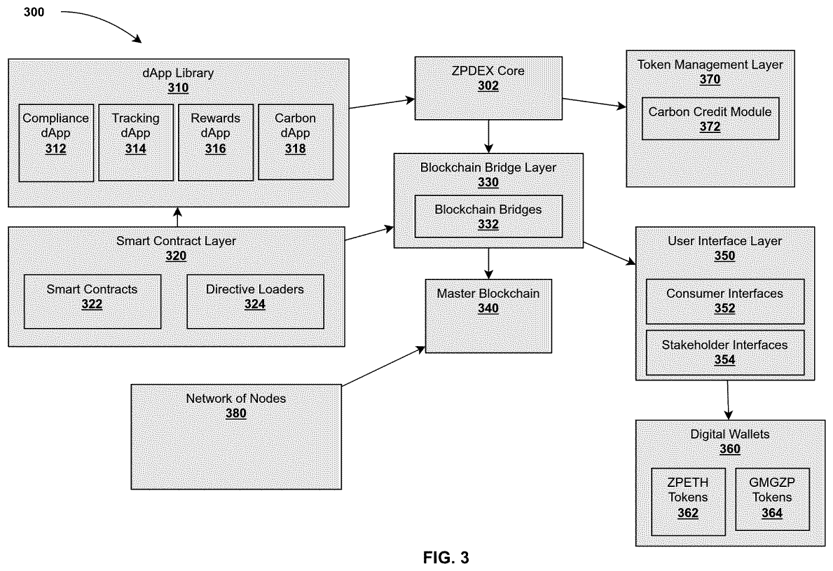

Referring to FIG. 3, a ZPDEX decentralized exchange architecture 300 is illustrated in accordance with some embodiments of the present disclosure. The ZPDEX decentralized exchange architecture 300 represents a core logic processor that enables integration of inputs from linear supply chain systems and chain-based distributed ledger systems without requiring a dissociated central authority. The ZPDEX decentralized exchange architecture 300 may provide the technical infrastructure that supports the ZPDEX module 102 described with reference to FIG. 1, implementing the functional capabilities for asset exchange management, data recording, and value tracking within the traceability platform.

A ZPDEX core 302 is included within the ZPDEX decentralized exchange architecture 300 and functions as a self-managed controlling entity within the platform. The ZPDEX core 302 may manage asset exchanges between participants within the ecosystem, coordinating transfers of tokens, carbon credits, and other digital assets. The ZPDEX core 302 may track future value statements associated with assets throughout their lifecycle, enabling participants to record and verify claims about product attributes, sustainability credentials, and compliance status. The ZPDEX core 302 may operate autonomously based on predefined rules encoded in smart contracts, reducing reliance on manual intervention or centralized administrative control. The self-managed nature of the ZPDEX core 302 may provide operational continuity and consistency, as the rules governing asset exchanges and value tracking are enforced programmatically rather than through discretionary decisions by a central authority.

A dApp library 310 is communicatively coupled to the ZPDEX core 302 and comprises a plurality of distributed applications that provide specialized functionality within the traceability ecosystem. The dApp library 310 may correspond to the dApp library 104 described with reference to FIG. 1, providing a more detailed view of the distributed applications available within the platform. Each distributed application within the dApp library 310 may be customizable by individual subscription within the ecosystem, enabling stakeholders to select and configure the specific functionality appropriate to their operational requirements without requiring adoption of the entire application suite.

A compliance dApp 312 is included within the dApp library 310 and handles regulatory compliance functions within the platform. The compliance dApp 312 may support FSMA compliance verification by validating that Critical Tracking Events include required Key Data Elements and conform to regulatory requirements. The compliance dApp 312 may support organic certification tracking by maintaining records of organic certifications and verifying that products claiming organic status have appropriate certification documentation. The compliance dApp 312 may generate compliance reports in formats suitable for regulatory submission, enabling stakeholders to demonstrate compliance with applicable requirements.

A tracking dApp 314 is included within the dApp library 310 and manages product traceability functions within the platform. The tracking dApp 314 may record Critical Tracking Events at each custody transfer and transformation event throughout the supply chain, capturing the data elements required for end-to-end traceability. The tracking dApp 314 may capture Key Data Elements including lot codes, product descriptions, quantities, dates, times, locations, and party identifiers associated with each tracking event. The tracking dApp 314 may enable forward tracing from source to consumer and backward tracing from consumer to source, supporting both recall investigations and provenance verification.

A rewards dApp 316 is included within the dApp library 310 and manages consumer incentive programs within the platform. The rewards dApp 316 may track loyalty points accumulated by consumers through scanning and purchasing activities, enabling consumers to earn rewards for participation in the traceability ecosystem. The rewards dApp 316 may manage promotional offers and discounts provided by brands and retailers to consumers who engage with the platform. The rewards dApp 316 may interface with the token management layer 370 to distribute token-based rewards to consumers, enabling monetization of consumer engagement within the ecosystem.

A carbon dApp 318 is included within the dApp library 310 and manages carbon intensity scoring and sustainability tracking within the platform. The carbon dApp 318 calculates carbon intensity scores based on agricultural operation data including tillage practices, irrigation usage, fertilizer application, and harvest yields. The carbon dApp 318 supports what-if analysis by computing adjusted carbon intensity scores based on hypothetical practice parameter modifications without altering the underlying canonical data. The carbon dApp 318 coordinates certification workflows by transmitting sealed submission packages to accredited certifiers and recording returned certified carbon intensity scores in association with shipment identifiers.

With continued reference to FIG. 3, a smart contract layer 320 is communicatively communicatively coupled to the dApp library 310 and contains executable code that automates validation and business logic within the platform. The smart contract layer 320 may correspond to the smart contract layer 106 described with reference to FIG. 1, providing a more detailed view of the smart contract infrastructure. The distributed applications within the dApp library 310 invoke smart contracts within the smart contract layer 320 to execute their functionality. The smart contract layer 320 is also communicatively coupled to a blockchain bridge layer 330, enabling smart contract execution results to be recorded on the distributed ledger.

Smart contracts 322 are contained within the smart contract layer 320 and define actions that are triggered when conditions precedent are satisfied. The smart contracts 322 may execute automatically when predefined conditions are met, without requiring manual intervention or approval from a central authority. The smart contracts 322 may validate incoming data against compliance requirements, verify that required data elements are present and properly formatted, and record validated data to the master blockchain 340. The smart contracts 322 may implement business logic for carbon intensity calculations, determining carbon intensity scores based on input parameters according to defined calculation methodologies. The smart contracts 322 may implement certification workflows, coordinating the submission of sealed packages to accredited certifiers and the recording of certified results. The smart contracts 322 may implement incentive distributions, automatically transferring tokens to participants who satisfy defined criteria for rewards.

Directive loaders 324 are contained within the smart contract layer 320 and enable smart contracts to query external systems to obtain additional data when required information is not present in the immediate transaction context. The directive loaders 324 query external databases, regulatory systems, or market data sources through the API integration layer 150 to retrieve information needed for smart contract execution. The directive loaders 324 enable smart contracts to be daisy-chained by invoking a second smart contract upon completion of a first smart contract, passing execution results and control between contracts. The directive loaders 324 interface with external data sources 152 described with reference to FIG. 1, incorporating data from agricultural equipment 154, supply chain platforms 156, and IoT sensors 158 into smart contract execution logic.

A blockchain bridge layer 330 is communicatively coupled to the ZPDEX core 302 and facilitates communication between user interfaces and back-end data elements stored on the distributed ledger. The blockchain bridge layer 330 may correspond to the blockchain bridge 112 described with reference to FIG. 1, providing a more detailed view of the bridging infrastructure. The blockchain bridge layer 330 connects the ZPDEX core 302 to the master blockchain 340, enabling the ZPDEX core 302 to read from and write to the distributed ledger.

Blockchain bridges 332 are contained within the blockchain bridge layer 330 and provide the technical mechanisms for translating between application-layer requests and blockchain transactions. The blockchain bridges 332 may translate requests from the consumer interfaces 352 and stakeholder interfaces 354 into blockchain transactions that record data on the master blockchain 340. The blockchain bridges 332 may retrieve data from the master blockchain 340 in response to queries from applications, formatting the retrieved data for presentation in user interfaces. The blockchain bridges 332 may manage transaction signing using cryptographic keys associated with participants, ensuring that transactions are properly authenticated before submission to the distributed ledger network 110.

A consensus module 330 is associated with the blockchain bridge layer 330 and coordinates transaction validation within the platform. The consensus module 330 may implement a simplified consensus protocol that reduces computational overhead compared to traditional proof-of-work mechanisms while maintaining sufficient validation to ensure data integrity. The consensus module 330 may coordinate agreement among the nodes 110N within the distributed ledger network 110 regarding which transactions should be added to the ledger. The consensus module 330 may rely on the architectural design of the platform and the trust relationships among participating nodes rather than computationally intensive cryptographic puzzles, enabling faster transaction confirmation and reduced energy consumption.

As further shown in FIG. 3, a master blockchain 340 is included within the ZPDEX decentralized exchange architecture 300 and stores all transactions immutably and transparently within the platform. The master blockchain 340 may correspond to the master blockchain 114 described with reference to FIG. 1 and FIG. 2, serving as the authoritative ledger for supply chain records, carbon intensity submissions, and consumer purchase associations. The master blockchain 340 may store Critical Tracking Events and Key Data Elements recorded at each custody transfer and transformation event throughout the supply chain. The master blockchain 340 may store sealed carbon intensity submissions and certified carbon intensity scores returned by accredited certifiers. The master blockchain 340 may store consumer purchase associations that enable targeted recall notifications.

A GMG network of nodes 380 is communicatively coupled to the master blockchain 340 and processes transactions submitted to the platform. The GMG network of nodes 380 may correspond to the nodes 110N within the distributed ledger network 110 described with reference to FIG. 1 and FIG. 2. Transactions submitted to the platform are processed by the GMG network of nodes 380, which validates transactions and adds validated transactions to the master blockchain 340. The GMG network of nodes 380 may ensure blockchain interaction with the ZPDEX core 302 serving as the controlling self-managed entity that coordinates data flows and asset exchanges. The distributed nature of the GMG network of nodes 380 may provide resilience against single points of failure and resistance to tampering, as modification of recorded data would require coordinated changes across multiple nodes.

A user interface layer 350 is configured to exchanged data with the blockchain bridge layer 330 and provides interfaces for participants to interact with the platform. The user interface layer 350 communicates with the distributed ledger through the blockchain bridges 332. The user interface layer 350 may support various device types and form factors, enabling participants to access platform functionality through web browsers, mobile applications, and specialized devices appropriate to their operational contexts.

Consumer interfaces 352 are contained within the user interface layer 350 and provide interfaces for consumers to interact with the platform. The consumer interfaces 352 may correspond to the user interface 136 within the consumer devices 130 described with reference to FIG. 1. The consumer interfaces 352 may enable consumers to scan ZPTAG authentication tags, view traceability information for scanned products, configure allergen and dietary preference alerts, and receive recall notifications for purchased products. The consumer interfaces 352 may display carbon intensity scores for products, enabling consumers to make purchasing decisions based on sustainability attributes.

Stakeholder interfaces 354 are contained within the user interface layer 350 and provide interfaces for supply chain participants to interact with the platform. The stakeholder interfaces 354 may correspond to the stakeholder application 142 within the stakeholder devices 140 described with reference to FIG. 1. The stakeholder interfaces 354 may enable stakeholders to record Critical Tracking Events, manage tag inventories, track compliance status, and generate reports for regulatory submission. The stakeholder interfaces 354 may enable farmers to enter agricultural operation data, submit carbon intensity packages for certification, and associate certified carbon intensity scores with shipment identifiers.

With continued reference to FIG. 3, digital wallets 360 are communicatively coupled to the user interface layer 350 and enable participants to interact with the ZPDEX decentralized exchange architecture 300 for token-based transactions. The digital wallets 360 may correspond to the digital wallet 134 within the consumer devices 130 described with reference to FIG. 1. The digital wallets 360 may store cryptographic keys that enable participants to sign transactions and prove ownership of digital assets. The digital wallets 360 may display token balances and transaction histories, enabling participants to track their holdings and activities within the ecosystem.

ZPETH tokens 362 are included within the digital wallets 360 and represent a token type that may be used for transactions within the platform. The ZPETH tokens 362 may serve as a utility token that enables access to platform services, payment of transaction fees, or participation in governance activities. The ZPETH tokens 362 may be traded on supported exchanges, enabling participants to acquire or dispose of tokens based on their needs within the ecosystem.

GMGZP tokens 364 are included within the digital wallets 360 and represent a token type that may be used for incentive distributions and value exchange within the platform. The GMGZP tokens 364 may be distributed to producers who contribute data to the system, to consumers who scan products and complete purchases, and to other participants who provide value to the ecosystem. The GMGZP tokens 364 may be redeemed for discounts, services, or other benefits within the platform, or may be traded on supported exchanges.

A token management layer 370 is communicatively coupled to the ZPDEX core 302 and manages cryptographic tokens used for trading fees, incentives, and value exchange within the ecosystem. The token management layer 370 may correspond to the token management component 108 described with reference to FIG. 1. The token management layer 370 may control the generation, distribution, and redemption of tokens within the platform, implementing rules that govern token economics. The token management layer 370 may add value statements on assets throughout their lifecycle, enabling participants to record and verify claims about product attributes and sustainability credentials.

A carbon credit module 372 is included within the token management layer 370 and measures carbon created or captured for both producers and consumers throughout the supply chain. The carbon credit module 372 may calculate carbon intensity scores based on agricultural operation data and may convert carbon tracking data into tradeable carbon credits. The carbon credit module 372 may track carbon contributions at the producer level, measuring emissions associated with farming practices and crediting producers who achieve lower carbon intensity. The carbon credit module 372 may track carbon impact at the consumer level, enabling consumers to understand the carbon footprint of their purchases and to offset emissions through carbon credit purchases. The carbon credit module 372 may interface with external carbon credit markets, enabling participants to trade carbon credits with third parties outside the platform ecosystem.

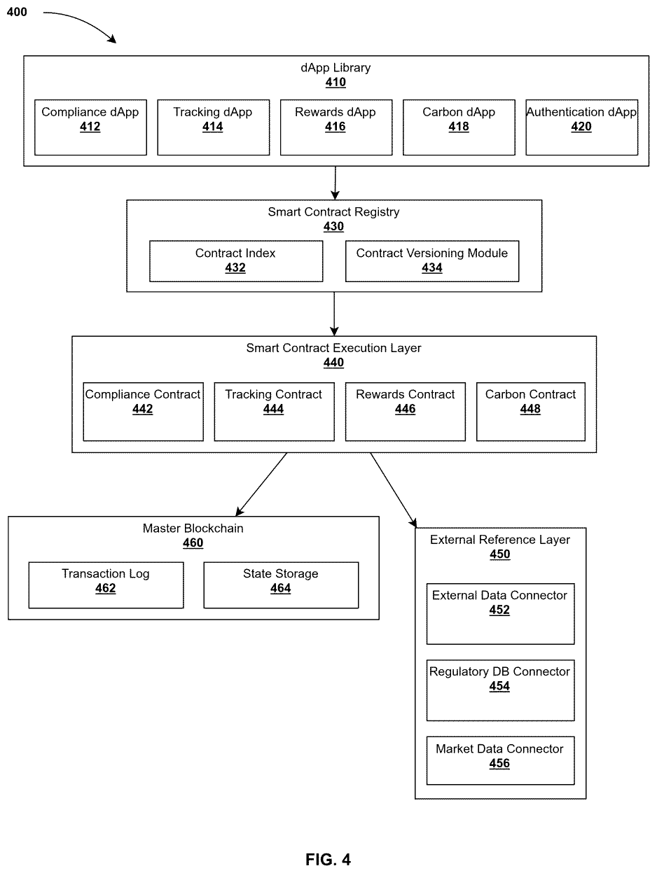

Referring to FIG. 4, a dApp library and smart contract interaction 400 is illustrated in accordance with some embodiments of the present disclosure. The dApp library and smart contract interaction 400 depicts a hierarchical relationship between distributed applications and corresponding smart contracts within a platform architecture. In some embodiments, distributed applications may invoke smart contracts to execute validation logic, business rules, and state transitions, and smart contracts may record execution results, state changes, and other transaction artifacts on a distributed ledger. The layered structure of the dApp library and smart contract interaction 400 may provide a modular technical framework that enables independent development, deployment, and updating of individual applications and smart contracts without requiring modification of an entire system architecture. In some embodiments, smart contracts may coordinate with external systems for data enrichment and verification when required information is not present in an immediate transaction context.

A dApp library 410 may include a plurality of specialized distributed applications. The dApp library 410 may correspond to the dApp library 104 described with reference to FIG. 1 and the dApp library 310 described with reference to FIG. 3, and may have one or more functionalities thereof. Each distributed application within the dApp library 410 may provide specialized functionality within a traceability ecosystem, and stakeholders may select and configure specific applications appropriate to operational requirements. In some embodiments, the dApp library 410 may support modular adoption where stakeholders deploy individual applications by individual subscription or other selective enablement mechanism without requiring adoption of an entire application suite. The distributed applications within the dApp library 410 may address distinct operational requirements including compliance verification, product tracking, consumer engagement, sustainability measurement, and authentication.

A compliance dApp 412 may be included within the dApp library 410 and may handle regulatory compliance functions within the platform, including FSMA compliance verification and organic certification tracking. The compliance dApp 412 may correspond to the compliance dApp 312 described with reference to FIG. 3 and may have one or more functionalities thereof. The compliance dApp 412 may validate that recorded Critical Tracking Events include required Key Data Elements and conform to regulatory requirements established under the Food Safety Modernization Act and other applicable regulations. The compliance dApp 412 may enable stakeholders to record Critical Tracking Events at custody transfers and transformation events, capturing Key Data Elements including lot codes, product descriptions, quantities, dates, times, locations, and identifiers of parties involved in each tracking event. The compliance dApp 412 may maintain records of organic certifications and verify that products claiming organic status have appropriate certification documentation from accredited certifying agents, and may further verify that certifications remain valid throughout a product lifecycle. The compliance dApp 412 may generate compliance reports in electronically sortable formats suitable for regulatory submission, enabling stakeholders to demonstrate compliance during inspections or audits. In some embodiments, the compliance dApp 412 may monitor compliance status across operations and generate alerts when compliance documentation is incomplete, when recorded data deviates from expected patterns, or when compliance violations are detected.

A tracking dApp 414 may be included within the dApp library 410 and may manage product traceability functions within the platform, including Critical Tracking Event recording and Key Data Element capture. The tracking dApp 414 may correspond to the tracking dApp 314 described with reference to FIG. 3 and may have one or more functionalities thereof. The tracking dApp 414 may enable stakeholders to record receiving events when products arrive at a facility, shipping events when products depart from a facility, and transformation events when products are processed, aggregated, or combined with other ingredients. The tracking dApp 414 may capture Key Data Elements associated with each Critical Tracking Event, creating a documentary chain that enables tracing of products both forward to consumers and backward to sources. The tracking dApp 414 may support hierarchical linking structures that maintain traceability through aggregation and transformation events, enabling identification of source lots and ingredient inputs that contributed to a transformed product. The tracking dApp 414 may enable forward tracing from source to consumer to support recall investigations that identify downstream recipients of potentially affected products, and may enable backward tracing from consumer to source to support provenance verification and chain-of-custody validation.

A rewards dApp 416 may be included within the dApp library 410 and may manage consumer incentive programs within the platform, including loyalty points and promotional offers. The rewards dApp 416 may correspond to the rewards dApp 316 described with reference to FIG. 3 and may have one or more functionalities thereof. The rewards dApp 416 may track loyalty points accumulated by consumers through scanning and purchasing activities within the traceability ecosystem. The rewards dApp 416 may manage promotional offers and discounts provided by brands and retailers to consumers who engage with the platform, enabling targeted marketing based on consumer preferences and purchase history. The rewards dApp 416 may interface with the token management layer 370 to distribute token-based rewards to consumers, enabling monetization of consumer engagement through cryptographic tokens that may be redeemed for discounts, services, premium features, or other benefits. In some embodiments, the rewards dApp 416 may support gamification features that encourage continued consumer participation in traceability verification activities, including challenges, badges, tiered rewards, or other engagement mechanisms.

A carbon dApp 418 may be included within the dApp library 410 and may manage carbon intensity scoring and sustainability tracking within the platform. The carbon dApp 418 may correspond to the carbon dApp 318 described with reference to FIG. 3 and may have one or more functionalities thereof. The carbon dApp 418 may calculate carbon intensity scores based on agricultural operation data including tillage practices, irrigation usage, fertilizer application, chemical treatments, cover crop usage, and harvest yields. The carbon dApp 418 may support what-if analysis that enables farmers to explore how practice changes would affect carbon intensity scores before committing to official submissions, thereby providing a controlled planning environment for iterative optimization. The carbon dApp 418 may coordinate certification workflows with accredited certifiers, transmitting sealed submission packages and receiving certified carbon intensity scores. The carbon dApp 418 may associate certified carbon intensity scores with shipment identifiers, enabling downstream verification of carbon credentials at custody transfer points such as co-op receiving facilities and other logistics nodes.

An authentication dApp 420 may be included within the dApp library 410 and may manage product verification and counterfeit prevention within the platform. The authentication dApp 420 may verify product authenticity by validating that scanned ZPTAG identifiers correspond to legitimate products recorded on the distributed ledger and by retrieving associated ledger records for presentation to consumers and other stakeholders. The authentication dApp 420 may detect potential counterfeiting attempts by monitoring for scan events that occur at inconsistent locations or times, flagging identifiers that appear in geographically incompatible scan patterns. The authentication dApp 420 may maintain records of tag lifecycle states, tracking transitions among inactive, active, deactivated, and invalidated states, and may prevent fraudulent reuse of tags by validating that scanned tags are associated with active products that have not been deactivated or invalidated due to purchase, recall, or suspected fraud. The authentication dApp 420 may provide visual and auditory feedback indicating whether a scanned product is authentic, enabling rapid verification at a point of purchase or custody transfer. In some embodiments, the authentication dApp 420 may support brand protection by enabling manufacturers and other rights holders to verify that products bearing their trademarks are genuine and have not been tampered with during distribution.

A smart contract registry 430 may be associated with the dApp library 410 and may maintain references to active smart contracts within the platform, enabling distributed applications to locate and invoke appropriate contracts for respective functionality. The smart contract registry 430 may provide an index that maps contract identifiers to deployed contract addresses and may further map contract addresses to respective functions and interfaces within the platform architecture. The smart contract registry 430 may support contract lifecycle management, tracking deployment, activation, update, deprecation, and retirement of contracts throughout an operational lifetime. In some embodiments, the smart contract registry 430 may support coexistence of multiple contract versions and may facilitate gradual migration from older versions to newer versions without disrupting ongoing operations. In some embodiments, the smart contract registry 430 may support multiple contract implementations that satisfy a common functional interface, enabling selection among alternative implementations based on performance characteristics, cost considerations, governance policies, or stakeholder preferences.

A contract index 432 may be included within the smart contract registry 430 and may maintain references to deployed smart contracts within the platform. The contract index 432 may store contract addresses that identify a location of each smart contract on a blockchain, enabling distributed applications to submit transactions to a contract address without hardcoding addresses into application code. The contract index 432 may store contract metadata including contract identifiers, descriptions, interface definitions, function signatures, dependency information, and supported versions. The contract index 432 may store access control information specifying which participants are authorized to invoke particular contract functions, enabling role-based access controls that restrict sensitive operations to authorized parties. The contract index 432 may be updated when new contracts are deployed, when existing contracts are deprecated, or when retired contracts are removed from active use, thereby maintaining an accurate registry of available contract functionality.

A contract versioning module 434 may be included within the smart contract registry 430 and may track and manage contract updates to ensure backward compatibility and orderly upgrades. The contract versioning module 434 may maintain version histories for deployed contracts, recording a sequence of updates and changes introduced in each version. The contract versioning module 434 may support parallel deployment of multiple contract versions, enabling a transition period during which both older and newer versions remain available while dependent distributed applications migrate. The contract versioning module 434 may maintain mappings between contract versions and distributed applications that depend on those versions, enabling impact analysis during upgrade planning. The contract versioning module 434 may enforce compatibility constraints that prevent deployment of versions that would break existing integrations, including requirements that newer versions accept compatible inputs and produce compatible outputs relative to prior versions. In some embodiments, the contract versioning module 434 may provide rollback capabilities that enable reversion to a previous contract version when issues are discovered after deployment.

A smart contract execution layer 440 may be associated with the smart contract registry 430 and may include a plurality of smart contracts that execute logic for respective functional domains within the platform. The smart contract execution layer 440 may provide a runtime environment for smart contract execution, managing computational resources, enforcing security constraints, and recording execution results and state changes. In some embodiments, the smart contract execution layer 440 may support concurrent execution of multiple contracts, enabling parallel processing of independent transactions to increase throughput. Each smart contract within the smart contract execution layer 440 may execute automatically when invoked by a distributed application or when predefined conditions are satisfied, implementing validation logic, business rules, and data recording operations without requiring manual intervention. The smart contract execution layer 440 may include directive loaders 324 described with reference to FIG. 3, enabling smart contracts to reference external systems to obtain additional data when required information is not present in an immediate transaction context.

A compliance contract 442 may be included within the smart contract execution layer 440 and may execute compliance verification logic within the platform. The compliance contract 442 may validate that Critical Tracking Events include required Key Data Elements and conform to regulatory requirements defined by FSMA and other applicable regulations. The compliance contract 442 may verify that lot codes are properly formatted and unique within the system, and may verify that organic certification claims are supported by valid certification documentation, including by querying certification databases to confirm that certifications remain active and have not expired. The compliance contract 442 may generate compliance verification results that are recorded on a master blockchain 460 to create an immutable audit trail of compliance validation activities. The compliance contract 442 may trigger alerts when compliance violations are detected, when required documentation is missing, or when anomalous patterns suggest noncompliance.

A tracking contract 444 may be included within the smart contract execution layer 440 and may execute traceability recording logic within the platform. The tracking contract 444 may record Critical Tracking Events on the master blockchain 460, capturing custody transfers, transformation events, and other supply chain activities that affect product traceability. The tracking contract 444 may validate that tracking events include required data elements such as timestamps, locations, and party identifiers, ensuring that recorded events provide sufficient information for forward and backward tracing. The tracking contract 444 may establish hierarchical links between source products and transformed products, maintaining traceability through aggregation and transformation events. The tracking contract 444 may update tag states in response to tracking events, including transitioning tags among inactive, active, deactivated, and invalidated states when custody transfers occur, when products are purchased by consumers, or when fraud is suspected. The tracking contract 444 may generate traceability records that enable identification of products affected by a contamination event, thereby supporting targeted recall operations.

A rewards contract 446 may be included within the smart contract execution layer 440 and may execute incentive distribution logic within the platform. The rewards contract 446 may calculate loyalty points earned by consumers based on scanning and purchasing activities and may apply rules that define point values for different types of engagement, including gamified engagement actions. The rewards contract 446 may distribute tokens to participants who satisfy defined criteria for rewards, transferring tokens from a rewards pool to participant wallets. The rewards contract 446 may validate redemption requests, verifying that participants have sufficient point balances or token holdings to redeem requested benefits. The rewards contract 446 may record incentive transactions on the master blockchain 460 to create an auditable record of rewards earned and redeemed. In some embodiments, the rewards contract 446 may interface with external promotional systems, manufacturer coupon systems, or retailer point-of-sale systems to apply discounts at a point of purchase and to coordinate redemption settlement.

A carbon contract 448 may be included within the smart contract execution layer 440 and may execute carbon intensity scoring and carbon credit calculation logic within the platform. The carbon contract 448 may calculate carbon intensity scores based on agricultural operation data received from farmers and may apply calculation methodologies consistent with recognized standards. The carbon contract 448 may validate that carbon intensity submissions include required data elements such as field acreage, crop type, tillage practices, irrigation usage, fertilizer application rates, chemical treatment records, and harvest yields. The carbon contract 448 may seal carbon intensity submissions upon receiving submission requests by generating cryptographic hashes that enable verification of submission contents and by recording sealed submissions on the master blockchain 460. The carbon contract 448 may coordinate with accredited certifiers to transmit sealed submission packages and receive certified carbon intensity scores, recording certified results in association with corresponding submission records. The carbon contract 448 may associate certified carbon intensity scores with shipment identifiers to enable downstream verification of carbon credentials at custody transfer points.

An external reference layer 450 may be associated with the smart contract execution layer 440 and may enable smart contracts to obtain data from external sources that are not stored on the blockchain. The external reference layer 450 may support integration with third-party databases, regulatory systems, and market information sources through bidirectional data exchange, enabling smart contracts to query external systems for data and to transmit data to external systems when required. The external reference layer 450 may implement directive loader functionality described with reference to directive loaders 324 in FIG. 3, enabling smart contracts to reference external systems for additional data used in validation logic, certification verification, carbon scoring, incentive valuation, or other business rule execution.

An external data connector 452 may be included within the external reference layer 450 and may interface with third-party databases that store information relevant to supply chain traceability, compliance, and operational context. The external data connector 452 may query farm management systems to retrieve agricultural operation data not directly entered into the platform, may query inventory management systems to retrieve stock levels and product locations, and may query transportation management systems to retrieve shipment tracking data including carrier information and delivery locations. The external data connector 452 may authenticate with external systems using secure credentials and may implement rate limiting or other traffic management controls to reduce load on external systems.

A regulatory database connector 454 may be included within the external reference layer 450 and may interface with government or certification databases that store regulatory requirements, certification records, and recall notices. The regulatory database connector 454 may query FDA databases to retrieve Food Traceability List requirements, enabling the platform to enforce current standards for Critical Tracking Events and Key Data Elements. The regulatory database connector 454 may query organic certification databases to verify certifications from accredited certifying agents and may query recall databases to retrieve recall notices to support targeted consumer notifications. The regulatory database connector 454 may submit compliance reports to regulatory agencies when required, including transmission of electronically sortable data in formats specified by regulatory requirements.

A market data connector 456 may be included within the external reference layer 450 and may interface with pricing and market information sources that provide data relevant to carbon credit trading and incentive program valuation. The market data connector 456 may query carbon credit exchanges to retrieve market prices for carbon credits, may query commodity markets to retrieve commodity prices used in premium calculations, and may query incentive program databases to retrieve program rules and credit values. In some embodiments, the market data connector 456 may enable participants to execute trades on external exchanges, thereby facilitating monetization of carbon credits and tokens earned through platform participation.

A master blockchain 460 may be associated with the smart contract execution layer 440 and may serve as an authoritative ledger for transactions processed by the smart contracts. The master blockchain 460 may correspond to the master blockchain 114 described with reference to FIG. 1 and FIG. 2 and the master blockchain 340 described with reference to FIG. 3, and may have one or more functionalities thereof. The master blockchain 460 may store executed transactions immutably, providing a permanent record of compliance verifications, traceability events, incentive distributions, carbon intensity submissions, and other smart contract activities. The distributed nature of the master blockchain 460 across nodes 110N within a distributed ledger network 110 may provide resistance to tampering and may maintain availability of recorded data when individual nodes become unavailable.

A transaction log 462 may be included within the master blockchain 460 and may record smart contract executions within the platform. The transaction log 462 may store transaction identifiers that uniquely identify transactions, transaction timestamps that record submission and confirmation times, transaction inputs that capture data submitted to smart contracts, and transaction outputs that capture results generated by smart contracts including validation results, computed values, and state changes. The transaction log 462 may store digital signatures or other authentication artifacts that enable verification that transactions originated from authorized participants.

A state storage 464 may be included within the master blockchain 460 and may maintain current state information managed by the platform. The state storage 464 may store current tag states indicating whether tags are inactive, active, deactivated, or invalidated, enabling lifecycle controls that prevent fraudulent reuse of tags. The state storage 464 may store current compliance status for products and facilities, token balances for participants, and carbon intensity scores for submitted and certified records. The state storage 464 may be updated by smart contract executions that modify state variables, and the state storage 464 may be queried by distributed applications to retrieve current state information for display in user interfaces and for operational decision-making.

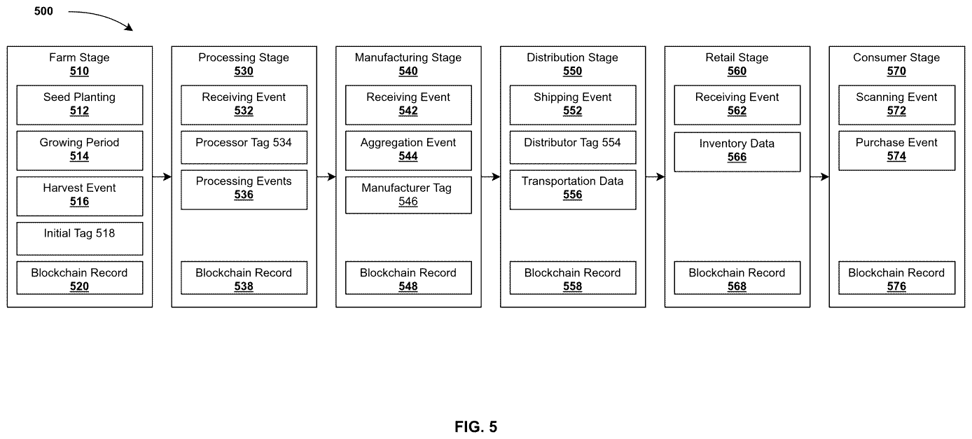

Referring to FIG. 5, an end-to-end supply chain traceability flow 500 is illustrated in accordance with some embodiments of the present disclosure. The end-to-end supply chain traceability flow 500 depicts the complete journey of a product from origin to consumer, showing tag activations, Critical Tracking Events, and blockchain recordings at each stage of the supply chain. The end-to-end supply chain traceability flow 500 may ensure full provenance and pedigree traceability by creating an unbroken chain of custody documentation that links each stage of the product journey to immutable blockchain records. The sequential stages within the end-to-end supply chain traceability flow 500 may be connected by arrows indicating the flow of products through the supply chain, with each stage maintaining blockchain records that link to records from prior stages to form a continuous documentary chain.

A farm stage 510 is included within the end-to-end supply chain traceability flow 500 and represents the origin of agricultural products within the supply chain. The farm stage 510 may capture the initial provenance data that establishes the foundation for downstream traceability, recording the conditions and practices under which raw agricultural materials were produced. The farm stage 510 may include multiple activities that occur over the course of a growing season, each contributing data elements that become part of the product's traceability record. The farm stage 510 may be associated with a specific field within a farm facility, enabling granular traceability to the geographic location where the product originated.

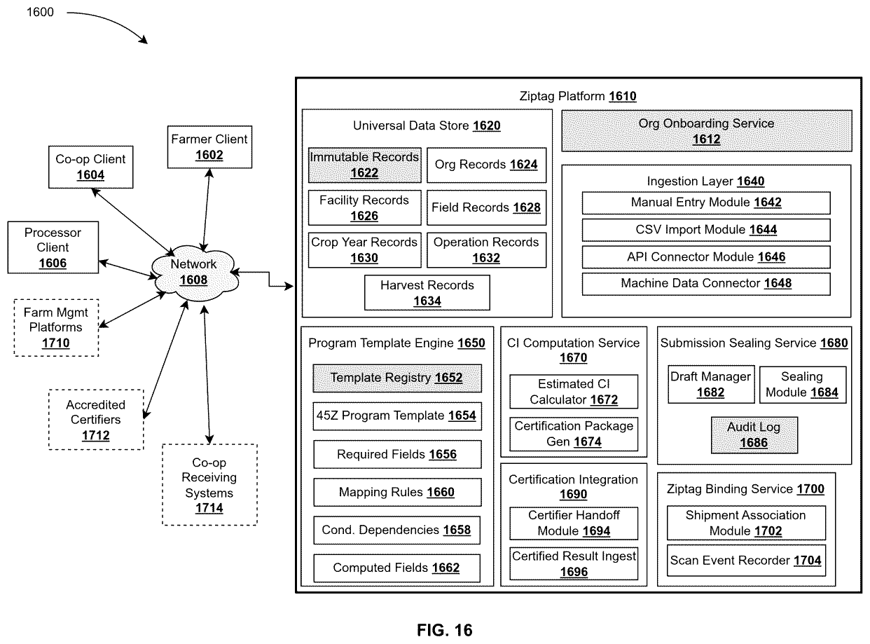

A seed planting event 512 is included within the farm stage 510 and represents the initial activity that begins the product lifecycle. The seed planting event 512 may capture data elements including the seed source, seed variety, planting date, planting method, and field location where planting occurred. The seed planting event 512 may record the identity of the seed supplier and any certifications associated with the seed, such as organic certification or non-GMO verification. The seed planting event 512 may establish the starting point for carbon intensity calculations by recording baseline conditions at the time of planting. The data captured at the seed planting event 512 may be ingested through the ingestion layer 1640 described with reference to FIG. 16, using manual entry, CSV import, or API integration with farm management platforms.

A growing period 514 is included within the farm stage 510 and represents the interval during which the crop develops from planting to harvest. The growing period 514 may encompass multiple agricultural operations that affect product quality, safety, and carbon intensity. During the growing period 514, the platform may capture data regarding tillage practices including no-till, reduced till, or conventional tillage methods. The growing period 514 may include irrigation events that record water application rates, irrigation methods, and total water usage. The growing period 514 may include fertilizer application events that record fertilizer types, nitrogen content, application rates, and total quantities applied. The growing period 514 may include chemical treatment events that record pesticide and herbicide applications, including product names, application rates, and application dates. The growing period 514 may include cover crop data indicating whether cover crops were planted and the species used. The data captured during the growing period 514 may be recorded as operation records 1632 within the universal data store 1620 described with reference to FIG. 16.

With continued reference to FIG. 5, a harvest event 516 is included within the farm stage 510 and represents the culmination of the growing period 514 when the crop is collected from the field. The harvest event 516 may capture data elements including harvest date, harvest method, yield quantity, yield units, and moisture content at harvest. The harvest event 516 may record the equipment used for harvesting and any quality assessments performed at the time of harvest. The harvest event 516 may trigger the activation of a tag that associates the harvested product with its traceability record, creating the initial link between the physical product and the digital provenance data stored on the blockchain.

An initial tag 518 is assigned at the harvest event 516 and represents the first ZPTAG authentication tag associated with the product in the supply chain. The initial tag 518 may be implemented as a QR code, an RFID tag, or an NFC chip that encodes a unique identifier linking the physical product to its blockchain record. The initial tag 518 may be activated through a scan event performed by a registered device at the farm facility, with the activation event recorded on the distributed ledger network 110. The initial tag 518 may include geolocation verification that confirms the tag was activated at the expected farm location, providing assurance that the tag is associated with product from the claimed origin. The initial tag 518 may transition from an inactive state to an active state upon activation, with the state transition recorded on the master blockchain 114.

A first blockchain record 520 is created at the farm stage 510 and captures all farm data associated with the harvested product. The first blockchain record 520 may include seed source information recorded at the seed planting event 512, planting date, and field identification. The first blockchain record 520 may include fertilization details recorded during the growing period 514, including fertilizer types, application rates, and total quantities. The first blockchain record 520 may include pesticide application data recorded during the growing period 514, including product names, application dates, and application rates. The first blockchain record 520 may include irrigation data recorded during the growing period 514, including water sources, application methods, and total water usage. The first blockchain record 520 may include harvest information recorded at the harvest event 516, including harvest date, yield quantity, and quality assessments. The first blockchain record 520 may be stored on the master blockchain 114 through the tracking contract 444 within the smart contract execution layer 440, creating an immutable record of the product's origin and production practices.

A processing stage 530 follows the farm stage 510 within the end-to-end supply chain traceability flow 500 and represents the transformation of raw agricultural materials into processed goods. The processing stage 530 may occur at a processing facility operated by a processor organization that receives raw materials from multiple farm sources. The processing stage 530 may include activities such as washing, sorting, cutting, packaging, and other operations that prepare raw materials for further distribution or manufacturing. The processing stage 530 may capture Critical Tracking Events and Key Data Elements required for FSMA compliance, recording the custody transfer from farm to processor and the transformation activities performed at the processing facility.

A receiving event 532 is included within the processing stage 530 and represents the custody transfer when raw materials arrive at the processing facility. At the receiving event 532, the initial tag 518 associated with the incoming product may be scanned using a registered device at the processing facility. The scan event at the receiving event 532 may retrieve the first blockchain record 520 associated with the initial tag 518, enabling the processor to verify the origin and production practices of the incoming materials. The receiving event 532 may trigger deactivation of the initial tag 518, transitioning the tag from an active state to a deactivated state to indicate that custody has transferred from the farm to the processor. The receiving event 532 may capture Key Data Elements including the receiving date, receiving time, receiving location, quantity received, and identity of the receiving party.

A processor tag 534 is activated at the processing stage 530 and represents a new ZPTAG authentication tag associated with the processed product. The processor tag 534 may be assigned to the product after processing activities are complete, creating a new identifier that links the processed product to its traceability record. The processor tag 534 may be linked to the initial tag 518 through a hierarchical linking structure that maintains the association between the processed product and its source materials. The processor tag 534 may enable downstream participants to trace the processed product back to its farm origin by following the links between the processor tag 534, the initial tag 518, and the first blockchain record 520.

Processing events 536 are recorded during the processing stage 530 and capture the transformation activities performed on the raw materials. The processing events 536 may include washing operations that record water sources, sanitization methods, and quality control results. The processing events 536 may include sorting operations that record grading criteria, rejection rates, and quality classifications. The processing events 536 may include cutting operations that record cutting methods, portion sizes, and yield rates. The processing events 536 may include packaging operations that record packaging materials, package sizes, and lot assignments. The processing events 536 may be recorded through the tracking dApp 414 and the tracking contract 444, capturing the Key Data Elements required for FSMA compliance at each transformation step.

A second blockchain record 538 is created at the processing stage 530 and captures all processing data associated with the product. The second blockchain record 538 may include the receiving event 532 data, the processing events 536 data, and the processor tag 534 assignment. The second blockchain record 538 may include a link to the first blockchain record 520, establishing the chain of custody from farm to processor. The second blockchain record 538 may be stored on the master blockchain 114, creating an immutable record of the processing activities and maintaining the traceability link to the farm origin. The second blockchain record 538 may enable forward tracing from the farm stage 510 to the processing stage 530 and backward tracing from the processing stage 530 to the farm stage 510.

As further shown in FIG. 5, a manufacturing stage 540 follows the processing stage 530 within the end-to-end supply chain traceability flow 500 and represents the combination of processed ingredients into finished products. The manufacturing stage 540 may occur at a manufacturing facility operated by a manufacturer organization that receives processed materials from multiple processor sources. The manufacturing stage 540 may involve aggregation of multiple ingredient streams, where products from different farms and processors are combined into a single finished product. The manufacturing stage 540 may capture Critical Tracking Events and Key Data Elements that record the aggregation relationships and transformation activities performed at the manufacturing facility.

A receiving event 542 is included within the manufacturing stage 540 and represents the custody transfer when processed materials arrive at the manufacturing facility. At the receiving event 542, the processor tag 534 associated with each incoming ingredient may be scanned using a registered device at the manufacturing facility. The scan event at the receiving event 542 may retrieve the second blockchain record 538 associated with each processor tag 534, enabling the manufacturer to verify the processing history and farm origin of each incoming ingredient. The receiving event 542 may trigger deactivation of the processor tags 534 for incoming ingredients, transitioning the tags from active states to deactivated states to indicate that custody has transferred from the processor to the manufacturer.

An aggregation event 544 is included within the manufacturing stage 540 and represents the combination of multiple ingredient sources into a single product batch. The aggregation event 544 may occur when ingredients from multiple farms and processors are combined during manufacturing, such as when vegetables from different sources are combined into a soup or when grains from different fields are blended into a flour product. The aggregation event 544 may create a hierarchical linking structure that associates the finished product with all source ingredients, maintaining traceability to each contributing farm and processor. The aggregation event 544 may record the quantities of each ingredient used, the lot codes of source materials, and the batch identifier assigned to the aggregated product. The aggregation event 544 may enable identification of all source farms and processors that contributed to a finished product, supporting recall investigations that need to trace contamination to its origin.

A manufacturer tag 546 is activated at the manufacturing stage 540 and represents a new ZPTAG authentication tag associated with the finished product. A single manufacturer tag 546 may be associated with a single unit (e.g., a can of tomato sauce) or a set of individual units (e.g., a case of tomato sauce cans or a pallet of tomato sauce cases). When implemented in a tiered scheme, a single unit may be associated with multiple manufacturer tags 546 at different tiers (e.g., a single can of tomato sauce is associated with a manufacturer tag 546 at each of the individual, case, and pallet tiers). In the tiered scheme, when higher tier manufacturer tags 546 are taken out of service (a pallet is unloaded or a case is unpacked), subordinate tier manufacturer tags 546 remain. The manufacturer tag 546 may be assigned to the product after manufacturing activities are complete, creating a new identifier that links the finished product to its traceability record. The manufacturer tag 546 may be linked to all processor tags 534 that were deactivated at the receiving event 542, maintaining the hierarchical linking structure that enables traceability through the aggregation event 544. The manufacturer tag 546 may enable downstream participants to trace the finished product back to all contributing farms by following the links through the manufacturing, processing, and farm stages.

A third blockchain record 548 is created at the manufacturing stage 540 and captures all manufacturing data associated with the finished product. The third blockchain record 548 may include the receiving event 542 data, the aggregation event 544 data, and the manufacturer tag 546 assignment. The third blockchain record 548 may include links to all second blockchain records 538 associated with the source ingredients, establishing the chain of custody from processors to manufacturer. The third blockchain record 548 may capture manufacturing activities including mixing, cooking, packaging, and quality control operations. The third blockchain record 548 may be stored on the master blockchain 114, creating an immutable record of the manufacturing activities and maintaining the traceability links to all source ingredients and their farm origins.

With continued reference to FIG. 5, a distribution stage 550 follows the manufacturing stage 540 within the end-to-end supply chain traceability flow 500 and represents the transportation of finished products from manufacturing facilities to retail locations. The distribution stage 550 may involve multiple transportation legs and intermediate storage at distribution centers. The distribution stage 550 may capture Critical Tracking Events and Key Data Elements that record shipping activities, transportation conditions, and custody transfers during distribution. The distribution stage 550 may be particularly relevant for perishable products that require cold chain monitoring to ensure product safety and quality.

A shipping event 552 is included within the distribution stage 550 and represents the departure of products from the manufacturing facility or distribution center. The shipping event 552 may capture Key Data Elements including shipping date, shipping time, shipping location, carrier information, and destination address. The shipping event 552 may record the manufacturer tag 546 or distributor tag 554 associated with the shipped products, enabling tracking of specific product lots during transportation. The shipping event 552 may trigger notifications to downstream recipients, alerting them to expected arrivals and enabling preparation for receiving activities.

A distributor tag 554 may be activated at the distribution stage 550 and represents a ZPTAG authentication tag associated with the product during distribution. The distributor tag 554 may be assigned when products are received at a distribution center and prepared for onward shipment to retail locations. For example, a distributor tag 554 may be activated when aggregating pallets received from a manufacturer or deactivated when disaggregating pallets that are sent to a retailer. The distributor tag 554 may be linked to the manufacturer tag 546, maintaining the chain of custody through the distribution stage 550. In some embodiments, the manufacturer tag 546 may remain active throughout distribution without assignment of a separate distributor tag 554, depending on the distribution model and custody transfer requirements.

Transportation data 556 is captured during the distribution stage 550 and records conditions during product transportation. The transportation data 556 may include carrier information identifying the transportation company, vehicle, and driver responsible for the shipment. The transportation data 556 may include departure times and delivery times that record the duration of transportation. The transportation data 556 may include temperature logs for perishable goods, recording temperature readings throughout transportation to verify cold chain compliance. The transportation data 556 may be captured through the IoT sensors 158 described with reference to FIG. 1, enabling automated monitoring of transportation conditions without manual data entry. The transportation data 556 may be validated by the compliance contract 442 to verify that temperature conditions remained within acceptable thresholds throughout transportation.

A fourth blockchain record 558 is created at the distribution stage 550 and captures all distribution data associated with the product. The fourth blockchain record 558 may include the shipping event 552 data, the distributor tag 554 assignment if applicable, and the transportation data 556. The fourth blockchain record 558 may include a link to the third blockchain record 548, establishing the chain of custody from manufacturer to distributor. The fourth blockchain record 558 may be stored on the master blockchain 114, creating an immutable record of the distribution activities and maintaining the traceability link through the supply chain. The fourth blockchain record 558 may enable verification that products were transported under appropriate conditions, supporting quality assurance and regulatory compliance.

A retail stage 560 follows the distribution stage 550 within the end-to-end supply chain traceability flow 500 and represents the final commercial stage before products reach consumers. The retail stage 560 may occur at retail locations including grocery stores, supermarkets, specialty food stores, and other establishments that sell products directly to consumers. The retail stage 560 may capture Critical Tracking Events and Key Data Elements that record receiving activities, inventory management, and product placement within the retail environment.

A receiving event 562 is included within the retail stage 560 and represents the custody transfer when products arrive at the retail location. At the receiving event 562, the distributor tag 554 or manufacturer tag 546 associated with the incoming products may be scanned using a registered device at the retail facility. The scan event at the receiving event 562 may retrieve the fourth blockchain record 558 associated with the incoming products, enabling the retailer to verify the distribution history and chain of custody. The receiving event 562 may capture Key Data Elements including receiving date, receiving time, receiving location, quantity received, and identity of the receiving party. In aspects where a tiered manufacturer tagging scheme is utilized, a receiving event may deactivate higher tier manufacturer tags 546 (e.g., on cases or pallets).

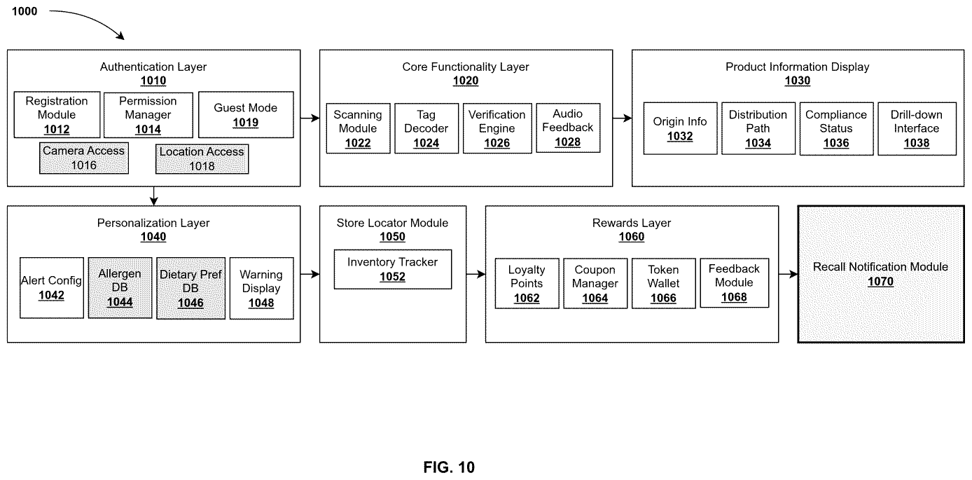

Inventory data 566 is captured at the retail stage 560 and records product placement and availability within the retail environment. The inventory data 566 may include store location identifying the specific retail establishment where the product is available. The inventory data 566 may include shelf placement indicating the department, aisle, and shelf position where the product is displayed. The inventory data 566 may include inventory quantities indicating the number of units available for purchase. The inventory data 566 may be updated as products are sold or restocked, enabling real-time visibility into product availability for consumers using the store locator module 1050 described with reference to FIG. 10.

A fifth blockchain record 568 is created at the retail stage 560 and captures all retail data associated with the product. The fifth blockchain record 568 may include the receiving event 562 data, the retail tag 564 assignment, and the inventory data 566. The fifth blockchain record 568 may include a link to the fourth blockchain record 558, establishing the chain of custody from distributor to retailer. The fifth blockchain record 568 may be stored on the master blockchain 114, creating an immutable record of the retail activities and maintaining the traceability link through the supply chain. The fifth blockchain record 568 may enable consumers to verify that products have passed through legitimate distribution channels before reaching the retail shelf.

As further shown in FIG. 5, a consumer stage 570 follows the retail stage 560 within the end-to-end supply chain traceability flow 500 and represents the final destination of the product where consumers interact with the traceability system. The consumer stage 570 may occur at the retail location during shopping or at the consumer's home after purchase. The consumer stage 570 may enable consumers to verify product authenticity, view traceability information, and establish purchase associations that enable future recall notifications.

A scanning event 572 is included within the consumer stage 570 and represents the consumer's interaction with the product tag using the consumer application 132 on the consumer devices 130. At the scanning event 572, the consumer may use a device camera to scan the retail tag 564, triggering retrieval of the associated blockchain records. The scanning event 572 may display traceability information to the consumer, including origin information from the first blockchain record 520, processing information from the second blockchain record 538, manufacturing information from the third blockchain record 548, distribution information from the fourth blockchain record 558, and retail information from the fifth blockchain record 568. The scanning event 572 may provide visual and auditory feedback indicating whether the product is authentic, enabling consumers to verify that the product has passed through legitimate supply chain channels.

A purchase event 574 is included within the consumer stage 570 and represents the consumer's acquisition of the product through a commercial transaction. The purchase event 574 may trigger deactivation of the retail tag 564, transitioning the tag from an active state to a deactivated state to indicate that the product has been sold. The purchase event 574 may associate the product with the consumer's account, creating a link between the consumer and the purchased product that enables future recall notifications. The purchase event 574 may be recorded through various mechanisms including scanning of an aggregated QR code at checkout, integration with loyalty account systems, or scanning of a receipt QR code after purchase.

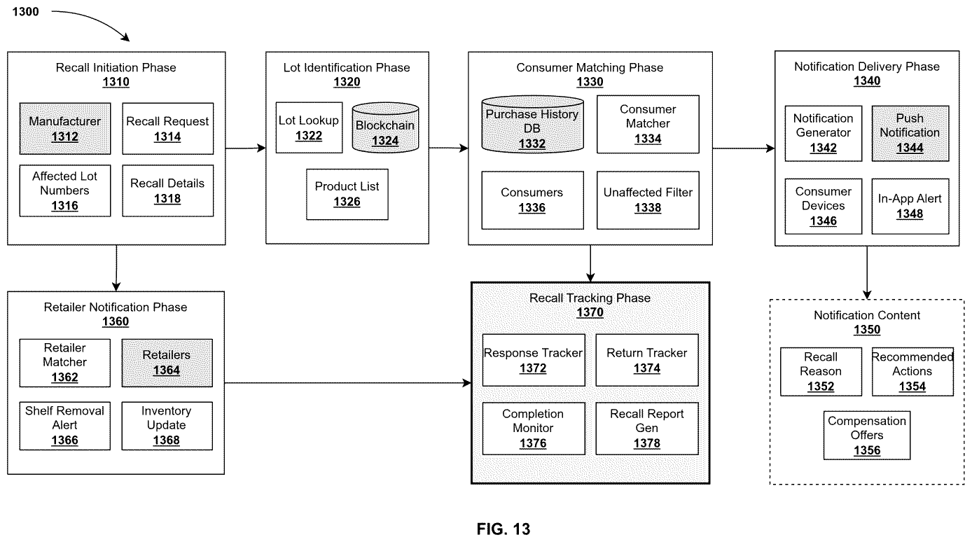

A sixth blockchain record 576 is created at the consumer stage 570 and captures the consumer purchase data associated with the product. The sixth blockchain record 576 may include the scanning event 572 data, the purchase event 574 data, and the consumer association. The sixth blockchain record 576 may include a link to the fifth blockchain record 568, completing the chain of custody from farm to consumer. The sixth blockchain record 576 may be stored on the master blockchain 114, creating an immutable record of the consumer purchase that enables future recall notifications. The sixth blockchain record 576 may enable the real-time recall notification system 1300 described with reference to FIG. 13 to identify consumers who have purchased products from specific lots when recall events occur, enabling targeted notifications that reach affected consumers while avoiding unnecessary alerts to consumers who have not purchased affected products.

Throughout the end-to-end supply chain traceability flow 500, each Critical Tracking Event creates an immutable blockchain record that links to previous records, establishing full provenance and pedigree traceability from seed to consumer. The continuous chain of custody documentation formed by the first blockchain record 520, the second blockchain record 538, the third blockchain record 548, the fourth blockchain record 558, the fifth blockchain record 568, and the sixth blockchain record 576 may ensure that no counterfeit items enter the supply chain without detection. The cryptographic binding between physical tags and blockchain records may enable detection of counterfeiting attempts, as fraudulent products would lack legitimate blockchain records or would present scan patterns inconsistent with the recorded chain of custody. The hierarchical linking structure maintained through aggregation events may enable identification of all source materials that contributed to a finished product, supporting recall investigations that need to trace contamination through complex supply chain relationships. The immutable storage of traceability records on the master blockchain 114 may provide assurance that recorded data has not been modified after recording, supporting the integrity requirements of regulatory compliance programs and consumer trust in product authenticity.

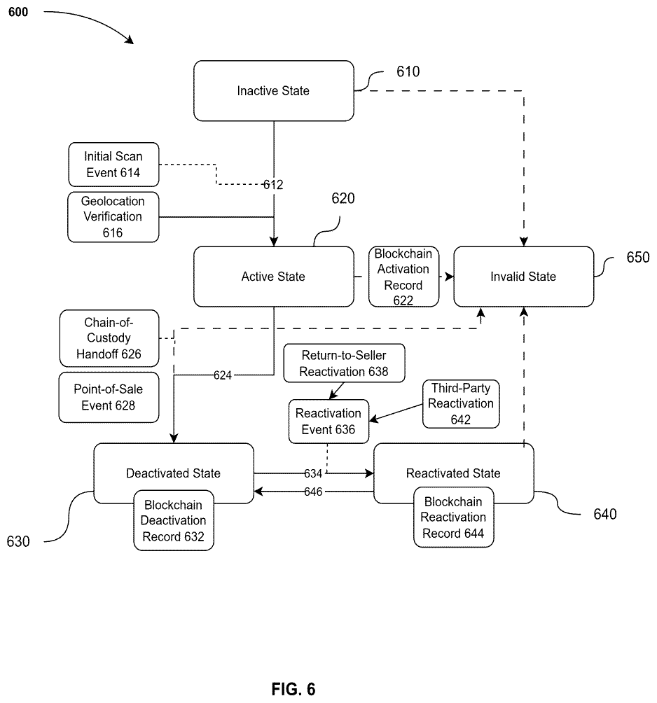

Referring to FIG. 6, tag lifecycle states 600 are illustrated in accordance with some embodiments of the present disclosure. The tag lifecycle states 600 depict the various states a tag may occupy and the transitions between states throughout the product lifecycle, ensuring accurate tracking and authenticity verification as products move through the supply chain. The tag lifecycle states 600 may provide a technical framework for managing tag status that prevents fraudulent reuse of tags, enables detection of counterfeiting attempts, and maintains an auditable record of all state transitions on the distributed ledger network 110. The state machine represented by the tag lifecycle states 600 may enforce constraints that ensure tags progress through defined states in a controlled manner, with each state transition recorded on the master blockchain 114 to create an immutable history of the tag's lifecycle.

An inactive state 610 represents the initial state where tags begin upon creation and assignment to a tag batch. When a stakeholder organization orders tags from the platform, the tags may be generated with unique identifiers and assigned to a tag batch associated with that organization, but the tags remain in the inactive state 610 until they are activated through a scan event. Tags in the inactive state 610 may be stored in inventory at the stakeholder's facility, awaiting assignment to specific products. The inactive state 610 may prevent premature use of tags by ensuring that tags cannot be associated with products or recorded on the blockchain until an authorized activation event occurs. Tags in the inactive state 610 may not return traceability data when scanned, as no product association has been established. The inactive state 610 may serve as a holding state that enables stakeholders to maintain inventories of tags for future use while preventing unauthorized activation or fraudulent association with products.

A first transition 612 moves a tag from the inactive state 610 to an active state 620 when the tag is activated through an authorized scan event. The first transition 612 represents the point at which a tag becomes associated with a specific product and begins recording traceability data on the distributed ledger network 110. The first transition 612 may be triggered by an initial scan event 614 performed by a registered device at a stakeholder facility. The initial scan event 614 may occur when a farmer activates a tag at harvest time, when a processor activates a tag after processing operations, when a manufacturer activates a tag after production, or at other points in the supply chain where tags are assigned to products. The initial scan event 614 may require that the scanning device be registered with the platform and associated with an authorized user account, preventing unauthorized parties from activating tags.

The initial scan event 614 may include geolocation verification 616 to ensure the tag is associated with a specific geographic location at the time of activation. The geolocation verification 616 may capture GPS coordinates from the scanning device and compare the captured coordinates against expected facility locations registered in the platform. The geolocation verification 616 may provide assurance that the tag was activated at the claimed location, supporting provenance claims that associate products with specific farms, processing facilities, or manufacturing plants. The geolocation verification 616 may detect activation attempts that occur at unexpected locations, flagging potential fraud when tags are activated at locations inconsistent with the registered facilities of the activating organization. The geolocation verification 616 may record the verified location as part of the activation record, creating an immutable association between the tag and its activation location that can be verified by downstream participants and consumers.

Upon entering the active state 620, a blockchain activation record 622 is created on the master blockchain 114. The blockchain activation record 622 may capture the tag identifier, the activation timestamp, the verified location from the geolocation verification 616, the identity of the activating party, and the product association established at activation. The blockchain activation record 622 may serve as the foundation for the tag's traceability record, establishing the starting point from which subsequent custody transfers and events are recorded. The blockchain activation record 622 may be linked to product data including lot codes, batch identifiers, and product descriptions that enable identification of the specific product associated with the tag. The active state 620 indicates that the tag is currently in use within the supply chain and may be scanned to retrieve traceability information. Tags in the active state 620 may return complete traceability data when scanned, enabling consumers and stakeholders to verify product authenticity and view the chain of custody.

With continued reference to FIG. 6, a second transition 624 moves a tag from the active state 620 to a deactivated state 630 when the tag is no longer actively tracking a product in the supply chain. The second transition 624 may be triggered by one of several deactivation events that indicate the product has changed custody or has been purchased by a consumer. The second transition 624 may ensure that tags are deactivated at appropriate points in the supply chain, preventing continued use of tags after products have been transferred or sold.

A chain-of-custody handoff 626 represents one trigger for the second transition 624 and occurs when a subsequent tag is scanned in the supply chain, deactivating the prior tag. The chain-of-custody handoff 626 may occur when a processor receives raw materials from a farm and activates a processor tag 534, triggering deactivation of the initial tag 518 that was active during transportation from the farm. The chain-of-custody handoff 626 may occur when a manufacturer receives processed ingredients and activates a manufacturer tag 546, triggering deactivation of the processor tags 534 associated with the incoming materials. The chain-of-custody handoff 626 may establish links between the deactivated tag and the newly activated tag, maintaining the hierarchical linking structure that enables end-to-end traceability through the supply chain. The chain-of-custody handoff 626 may record the custody transfer on the master blockchain 114, capturing the identities of the transferring and receiving parties, the transfer timestamp, and the location where the transfer occurred.

A point-of-sale event 628 represents another trigger for the second transition 624 and occurs when a consumer purchases the product at a retail location. The point-of-sale event 628 may be triggered when the consumer completes a purchase transaction and the retail tag 564 is associated with the consumer's account. The point-of-sale event 628 may deactivate the retail tag 564 to indicate that the product has been sold and is no longer available for purchase by other consumers. The point-of-sale event 628 may create a purchase association that links the consumer to the purchased product, enabling the real-time recall notification system 1300 to identify affected consumers when recall events occur. The point-of-sale event 628 may be recorded through various mechanisms including scanning of an aggregated QR code at checkout, integration with loyalty account systems, or scanning of a receipt QR code after purchase.

Upon entering the deactivated state 630, a blockchain deactivation record 632 is created on the master blockchain 114. The blockchain deactivation record 632 may capture the tag identifier, the deactivation timestamp, the deactivation trigger indicating whether the deactivation resulted from a chain-of-custody handoff 626 or a point-of-sale event 628, and the identity of the party associated with the deactivation. The blockchain deactivation record 632 may indicate that the item has been purchased or transferred while the tag record remains on the blockchain for audit and traceability purposes. The deactivated state 630 does not remove the tag from the blockchain or delete the associated traceability records; rather, the deactivated state 630 indicates that the tag is no longer actively tracking a product in commerce. Tags in the deactivated state 630 may still return traceability information when scanned, enabling consumers to verify the authenticity and provenance of products they have already purchased. The blockchain deactivation record 632 may preserve the complete history of the tag's lifecycle, including the activation record, all custody transfer records, and the deactivation record, creating an auditable trail that supports regulatory compliance and consumer trust.

A third transition 634 moves a tag from the deactivated state 630 to a reactivated state 640 in limited circumstances where a product returns to commerce after having been deactivated. The third transition 634 may be triggered by a reactivation event 636 that occurs when specific conditions are satisfied that justify returning the tag to an active tracking state. The third transition 634 may be restricted to defined scenarios to prevent fraudulent reactivation of tags that have been legitimately deactivated, ensuring that reactivation occurs only when appropriate controls are in place to verify product authenticity and integrity.

A return-to-seller reactivation 638 represents one scenario for the reactivation event 636 and occurs when a product is returned to the point of sale and undergoes an inspection or acceptance process by the original seller. The return-to-seller reactivation 638 may occur when a consumer returns a product to the retailer where the product was purchased, and the retailer inspects the product to verify that the product remains unopened, untampered, and suitable for resale. The return-to-seller reactivation 638 may require that the retailer confirm the product's condition through a documented inspection process before the tag is reactivated. The return-to-seller reactivation 638 may record the return event, the inspection results, and the reactivation authorization on the master blockchain 114, creating an auditable record of the return and reactivation process.

A third-party reactivation 642 represents another scenario for the reactivation event 636 and occurs when a registered third-party seller certifies that the product remains untampered and authentic. The third-party reactivation 642 may occur in secondary market scenarios where products are resold through authorized resellers, consignment shops, or other legitimate secondary channels. The third-party reactivation 642 may require that the third-party seller be registered with the platform and authorized to perform reactivation certifications. The third-party reactivation 642 may require that the third-party seller perform verification procedures to confirm product authenticity and condition before reactivating the tag. The third-party reactivation 642 may enable legitimate secondary market transactions while maintaining traceability and preventing fraudulent reactivation by unauthorized parties.

Upon entering the reactivated state 640, a blockchain reactivation record 644 is created on the master blockchain 114. The blockchain reactivation record 644 may capture the tag identifier, the reactivation timestamp, the reactivation scenario indicating whether the reactivation resulted from a return-to-seller reactivation 638 or a third-party reactivation 642, the identity of the party performing the reactivation, and any inspection or certification results associated with the reactivation. The blockchain reactivation record 644 may preserve the complete traceability history of the tag, including the original activation, all prior custody transfers, the deactivation, and the reactivation, ensuring that the product's full history remains accessible to downstream participants and consumers. The reactivated state 640 indicates that the tag is once again actively tracking a product in commerce and may be scanned to retrieve traceability information. Tags in the reactivated state 640 may display the complete lifecycle history including the reactivation event, enabling consumers to understand that the product was previously sold and has returned to commerce through a documented process.

A fourth transition 646 moves a tag from the reactivated state 640 back to the deactivated state 630 upon a subsequent purchase event. The fourth transition 646 may be triggered when a consumer purchases the reactivated product, completing a new sales transaction that deactivates the tag. The fourth transition 646 may follow the same process as the second transition 624 triggered by a point-of-sale event 628, creating a new blockchain deactivation record 632 that captures the subsequent purchase. The fourth transition 646 may create a new purchase association linking the new consumer to the product, enabling recall notifications to reach the current owner of the product. The fourth transition 646 may enable products to cycle between the reactivated state 640 and the deactivated state 630 multiple times as products are resold through legitimate secondary market channels, with each cycle recorded on the master blockchain 114 to maintain complete traceability.

As further shown in FIG. 6, an invalid state 650 represents a terminal state for tags that have been determined to be compromised, counterfeit, duplicated, or stolen. The invalid state 650 may be entered from any other state when the platform detects conditions indicating that the tag should no longer be trusted for traceability purposes. Tags may be transitioned to the invalid state 650 when scan patterns indicate potential counterfeiting, such as when the same tag identifier appears in geographically incompatible locations within a timeframe that would be impossible for legitimate product movement. Tags may be transitioned to the invalid state 650 when a stakeholder reports that a tag batch has been lost or stolen, preventing fraudulent use of the compromised tags. Tags may be transitioned to the invalid state 650 when verification procedures identify tags that do not correspond to legitimate products recorded on the distributed ledger network 110.

Tags in the invalid state 650 cannot be reactivated and may not return normal traceability information when scanned. When a tag in the invalid state 650 is scanned, the consumer application 132 or stakeholder application 142 may display a warning indicating that the tag has been invalidated and that the associated product should not be trusted. The invalid state 650 may record the reason for invalidation on the master blockchain 114, creating an auditable record of why the tag was removed from legitimate use. The invalid state 650 may support brand protection by enabling manufacturers to invalidate tags associated with counterfeit products, preventing fraudulent products from presenting legitimate traceability information. The invalid state 650 may support supply chain security by enabling rapid response to theft or loss of tag batches, preventing stolen tags from being used to introduce unauthorized products into the supply chain.

Throughout all state transitions within the tag lifecycle states 600, the tag remains recorded on the blockchain, maintaining a complete history of the tag's lifecycle for traceability and audit purposes. The state storage 464 within the master blockchain 114 may maintain the current state of each tag, enabling rapid determination of whether a tag is inactive, active, deactivated, reactivated, or invalid. The transaction log 462 within the master blockchain 114 may maintain the complete history of state transitions for each tag, enabling reconstruction of the tag's lifecycle from creation through its current state. The tracking contract 444 within the smart contract execution layer 440 may enforce the state transition rules defined by the tag lifecycle states 600, ensuring that tags progress through states in accordance with the defined transitions and that unauthorized state changes are rejected. The authentication dApp 420 within the dApp library 410 may query the state storage 464 to determine tag states when processing scan events, enabling appropriate responses based on whether tags are active, deactivated, reactivated, or invalid.

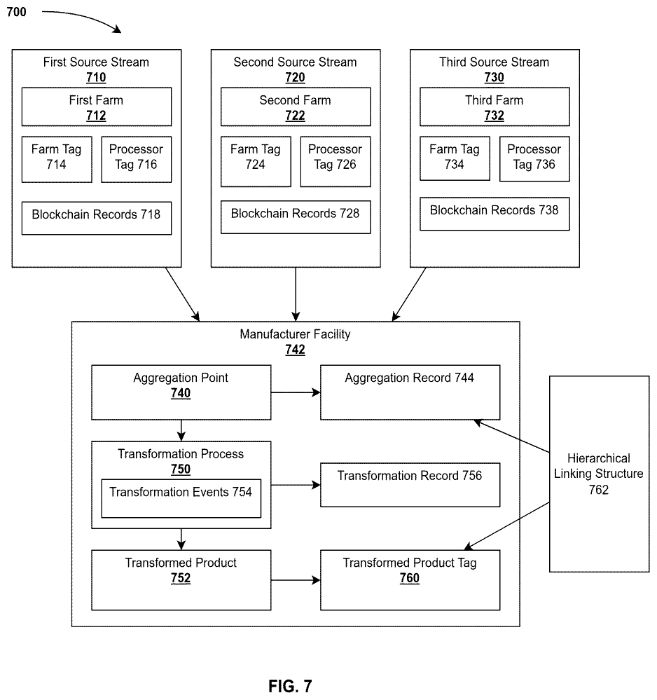

Referring to FIG. 7, a product transformation and batch aggregation 700 is illustrated in accordance with some embodiments of the present disclosure. The product transformation and batch aggregation 700 depicts how multiple source products are aggregated into a transformed product while maintaining traceability links to all source materials, addressing the technical challenge of preserving end-to-end traceability when products undergo transformation such as ingredients being incorporated into packaged meals. The product transformation and batch aggregation 700 may enable identification of all source farms and processing facilities that contributed to a finished product, supporting recall investigations and contamination tracing through complex supply chain relationships where multiple ingredient streams converge at manufacturing facilities.

A first source stream 710 represents a first ingredient originating from agricultural production and flowing through processing before reaching the manufacturing stage. The first source stream 710 may represent ingredients such as tomatoes that are grown at a farm, processed at a processing facility, and then delivered to a manufacturer for incorporation into a finished product. The first source stream 710 may maintain complete traceability from farm origin through processing, with each stage recording Critical Tracking Events and Key Data Elements on the distributed ledger network 110. The first source stream 710 may capture agricultural operation data including planting, growing, and harvest activities, as well as processing activities including receiving, washing, sorting, and packaging operations.

A first farm 712 is included within the first source stream 710 and represents the agricultural origin of the first ingredient. The first farm 712 may be a facility registered within the platform as a farm organization, with defined fields, crop years, and agricultural operation records stored in the universal data store 1620. The first farm 712 may capture data regarding tillage practices, irrigation usage, fertilizer application, chemical treatments, and harvest yields for the first ingredient. The first farm 712 may be associated with carbon intensity data that enables calculation of carbon intensity scores for the first ingredient, supporting sustainability tracking and monetization of sustainable farming practices.

A first farm tag 714 is associated with the first ingredient at the first farm 712 and represents the initial ZPTAG authentication tag assigned to the product at harvest. The first farm tag 714 may be activated through an initial scan event 614 performed by a registered device at the first farm 712, with the activation recorded on the master blockchain 114. The first farm tag 714 may include geolocation verification 616 that confirms the tag was activated at the expected farm location, providing assurance that the first ingredient originated from the claimed source. The first farm tag 714 may transition from the inactive state 610 to the active state 620 upon activation, with the blockchain activation record 622 capturing the tag identifier, activation timestamp, verified location, and product association.

A first processor tag 716 is associated with the first ingredient after processing operations and represents the ZPTAG authentication tag assigned by the processor. The first processor tag 716 may be activated when the processor receives the first ingredient from the first farm 712 and completes processing operations such as washing, sorting, and packaging. The first processor tag 716 may be linked to the first farm tag 714 through a hierarchical linking structure that maintains the association between the processed ingredient and its farm origin. The activation of the first processor tag 716 may trigger deactivation of the first farm tag 714 through the chain-of-custody handoff 626, recording the custody transfer from farm to processor on the master blockchain 114.

Blockchain records 718 are associated with the first source stream 710 and capture all traceability data for the first ingredient from farm origin through processing. The blockchain records 718 may include the first blockchain record 520 created at the first farm 712 capturing seed source, planting date, growing period activities, and harvest information. The blockchain records 718 may include the second blockchain record 538 created at the processing stage capturing receiving events, processing events, and the first processor tag 716 assignment. The blockchain records 718 may be stored on the master blockchain 114 through the tracking contract 444, creating an immutable record of the first ingredient's journey from farm to processor.

With continued reference to FIG. 7, a second source stream 720 represents a second ingredient originating from agricultural production and flowing through processing before reaching the manufacturing stage. The second source stream 720 may represent ingredients such as onions that follow a parallel path to the first source stream 710, with independent farm origin, processing activities, and traceability records. The second source stream 720 may maintain complete traceability from farm origin through processing, enabling identification of the specific farm and processor that handled the second ingredient. The second source stream 720 may capture agricultural operation data and processing activities that are recorded on the distributed ledger network 110 independently of the first source stream 710.

A second farm 722 is included within the second source stream 720 and represents the agricultural origin of the second ingredient. The second farm 722 may be a different farm organization than the first farm 712, potentially located in a different geographic region and operated by a different farmer. The second farm 722 may capture data regarding agricultural practices specific to the second ingredient, including planting dates, growing conditions, and harvest yields that may differ from those recorded at the first farm 712. The second farm 722 may be associated with carbon intensity data that enables calculation of carbon intensity scores for the second ingredient, which may differ from the carbon intensity of the first ingredient based on different farming practices.

A second farm tag 724 is associated with the second ingredient at the second farm 722 and represents the initial ZPTAG authentication tag assigned to the second ingredient at harvest. The second farm tag 724 may be activated through an initial scan event 614 performed by a registered device at the second farm 722, with the activation recorded on the master blockchain 114 independently of the first farm tag 714. The second farm tag 724 may include geolocation verification 616 that confirms the tag was activated at the second farm 722 location, providing assurance that the second ingredient originated from the claimed source.

A second processor tag 726 is associated with the second ingredient after processing operations and represents the ZPTAG authentication tag assigned by the processor handling the second ingredient. The second processor tag 726 may be assigned by the same processor that handled the first ingredient or by a different processor, depending on the supply chain configuration. The second processor tag 726 may be linked to the second farm tag 724 through a hierarchical linking structure that maintains the association between the processed second ingredient and its farm origin at the second farm 722. The activation of the second processor tag 726 may trigger deactivation of the second farm tag 724 through the chain-of-custody handoff 626.

Blockchain records 728 are associated with the second source stream 720 and capture all traceability data for the second ingredient from farm origin through processing. The blockchain records 728 may include blockchain records created at the second farm 722 capturing agricultural operation data and harvest information for the second ingredient. The blockchain records 728 may include blockchain records created at the processing stage capturing receiving events, processing events, and the second processor tag 726 assignment. The blockchain records 728 may be stored on the master blockchain 114 independently of the blockchain records 718, creating a separate but parallel traceability chain for the second ingredient.

A third source stream 730 represents a third ingredient originating from agricultural production and flowing through processing before reaching the manufacturing stage. The third source stream 730 may represent ingredients such as celery that follow a parallel path to the first source stream 710 and the second source stream 720, with independent farm origin, processing activities, and traceability records. The third source stream 730 may maintain complete traceability from farm origin through processing, enabling identification of the specific farm and processor that handled the third ingredient.

A third farm 732 is included within the third source stream 730 and represents the agricultural origin of the third ingredient. The third farm 732 may be a different farm organization than the first farm 712 and the second farm 722, potentially operated by a different farmer with different agricultural practices. The third farm 732 may capture data regarding agricultural practices specific to the third ingredient, including tillage methods, irrigation usage, and fertilizer application that may result in different carbon intensity scores compared to the first farm 712 and the second farm 722.

A third farm tag 734 is associated with the third ingredient at the third farm 732 and represents the initial ZPTAG authentication tag assigned to the third ingredient at harvest. The third farm tag 734 may be activated through an initial scan event 614 performed by a registered device at the third farm 732, with the activation recorded on the master blockchain 114 independently of the first farm tag 714 and the second farm tag 724.

A third processor tag 736 is associated with the third ingredient after processing operations and represents the ZPTAG authentication tag assigned by the processor handling the third ingredient. The third processor tag 736 may be linked to the third farm tag 734 through a hierarchical linking structure that maintains the association between the processed third ingredient and its farm origin at the third farm 732. The activation of the third processor tag 736 may trigger deactivation of the third farm tag 734 through the chain-of-custody handoff 626.

Blockchain records 738 are associated with the third source stream 730 and capture all traceability data for the third ingredient from farm origin through processing. The blockchain records 738 may include blockchain records created at the third farm 732 and at the processing stage, stored on the master blockchain 114 independently of the blockchain records 718 and the blockchain records 728.

As further shown in FIG. 7, an aggregation point 740 is included within the product transformation and batch aggregation 700 where the first source stream 710, the second source stream 720, and the third source stream 730 converge at a manufacturing location. The aggregation point 740 represents the point in the supply chain where multiple independent ingredient streams are combined into a single product batch, creating a many-to-one relationship between source ingredients and the finished product. The aggregation point 740 may capture the quantities of each ingredient received, the lot codes of source materials, and the associations between incoming ingredients and the outgoing product batch.

A manufacturer facility 742 is associated with the aggregation point 740 and represents the manufacturing location where ingredients are combined and transformed into finished products. The manufacturer facility 742 may be a facility registered within the platform as a manufacturer organization, with defined production lines, batch management capabilities, and compliance tracking functionality. The manufacturer facility 742 may receive ingredients from multiple farms and processors, aggregating materials from diverse sources into unified product batches. The manufacturer facility 742 may capture Critical Tracking Events and Key Data Elements required for FSMA compliance at the aggregation point 740 and throughout the transformation process.

At the aggregation point 740, the first processor tag 716, the second processor tag 726, and the third processor tag 736 are scanned and deactivated using registered devices at the manufacturer facility 742. The scan events at the aggregation point 740 may retrieve the blockchain records 718, the blockchain records 728, and the blockchain records 738 associated with each incoming ingredient, enabling the manufacturer to verify the origin and processing history of all source materials. The deactivation of the processor tags 716, 726, and 736 may transition the tags from the active state 620 to the deactivated state 630, with the blockchain deactivation record 632 capturing the custody transfer from processors to manufacturer.

An aggregation record 744 is created at the aggregation point 740 and links to all source blockchain records associated with the incoming ingredients. The aggregation record 744 may capture the identifiers of the first processor tag 716, the second processor tag 726, and the third processor tag 736 that were deactivated at the aggregation point 740. The aggregation record 744 may include links to the blockchain records 718, the blockchain records 728, and the blockchain records 738, establishing the many-to-one relationship between source ingredients and the aggregated batch. The aggregation record 744 may capture the quantities of each ingredient used in the aggregation, enabling proportional tracing when contamination affects only a portion of the source materials. The aggregation record 744 may be stored on the master blockchain 114 through the tracking contract 444, creating an immutable record of the aggregation relationships.

A transformation process 750 occurs at the manufacturer facility 742 where the source ingredients from the first source stream 710, the second source stream 720, and the third source stream 730 are combined and processed into a finished product. The transformation process 750 may involve multiple manufacturing operations that change the form, composition, or packaging of the source ingredients. The transformation process 750 may include mixing operations where ingredients are combined according to product recipes, cooking operations where ingredients are heated or otherwise processed, and packaging operations where the finished product is placed into consumer-ready containers. The transformation process 750 may capture data regarding manufacturing conditions, quality control results, and production parameters that affect product safety and quality.

A transformed product 752 results from the transformation process 750 and represents the finished product that incorporates ingredients from all source streams. The transformed product 752 may be a product such as vegetable soup that contains tomatoes from the first farm 712, onions from the second farm 722, and celery from the third farm 732. The transformed product 752 may be assigned a batch identifier and lot code that enable identification of the specific production run. The transformed product 752 may inherit traceability attributes from all source ingredients through the hierarchical linking structure established at the aggregation point 740.

Transformation events 754 are recorded during the transformation process 750 and capture the manufacturing operations performed on the source ingredients. The transformation events 754 may include mixing events that record the combination of ingredients according to product recipes, including mixing times, temperatures, and equipment used. The transformation events 754 may include cooking events that record heating operations, including cooking temperatures, cooking times, and quality control measurements. The transformation events 754 may include packaging events that record the placement of finished product into containers, including package sizes, packaging materials, and lot assignments. The transformation events 754 may be recorded through the tracking dApp 414 and the tracking contract 444, capturing the Key Data Elements required for FSMA compliance at each transformation step.

A transformation record 756 is created during the transformation process 750 and captures all transformation events 754 associated with the production of the transformed product 752. The transformation record 756 may include the transformation events 754 data, the batch identifier assigned to the transformed product 752, and links to the aggregation record 744 that establishes the relationship to source ingredients. The transformation record 756 may capture manufacturing conditions including production line identification, production timestamps, and quality control results. The transformation record 756 may be stored on the master blockchain 114, creating an immutable record of the transformation activities and maintaining the traceability link through the manufacturing stage.

A transformed product tag 760 is activated and associated with the transformed product 752 after the transformation process 750 is complete. The transformed product tag 760 may be implemented as a QR code, an RFID tag, or an NFC chip that encodes a unique identifier linking the transformed product 752 to its blockchain record. The transformed product tag 760 may be activated through an initial scan event 614 performed by a registered device at the manufacturer facility 742, with the activation recorded on the master blockchain 114. The transformed product tag 760 may be linked to the aggregation record 744, which in turn links to the blockchain records 718, the blockchain records 728, and the blockchain records 738 associated with all source ingredients.

A hierarchical linking structure 762 is established through the relationships between the transformed product tag 760, the aggregation record 744, and the source blockchain records. The hierarchical linking structure 762 ensures that the transformed product 752 maintains traceability to all source ingredients and their respective origins at the first farm 712, the second farm 722, and the third farm 732. The hierarchical linking structure 762 may enable forward tracing from any source farm to all finished products that incorporated ingredients from that farm. The hierarchical linking structure 762 may enable backward tracing from the transformed product 752 to all source farms and processors that contributed ingredients.

In cases of contamination or recall affecting one of the source ingredients, the hierarchical linking structure 762 enables identification of all potentially affected source farms and processing facilities. When a contamination event is identified at the first farm 712, the platform may trace forward through the blockchain records 718, the aggregation record 744, and the transformation record 756 to identify all transformed products 752 that incorporated ingredients from the first farm 712. When a contamination event is identified in the transformed product 752, the platform may trace backward through the hierarchical linking structure 762 to identify the first farm 712, the second farm 722, and the third farm 732 as potential sources of contamination. The hierarchical linking structure 762 may narrow the contamination source to a defined set of contributing farms and processing facilities, enabling targeted investigation and recall activities. The hierarchical linking structure 762 may support the real-time recall notification system 1300 by enabling identification of all consumers who purchased transformed products 752 that incorporated ingredients from affected source lots.

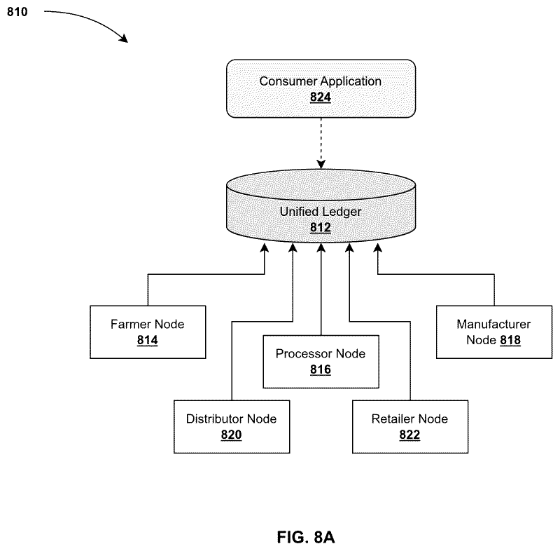

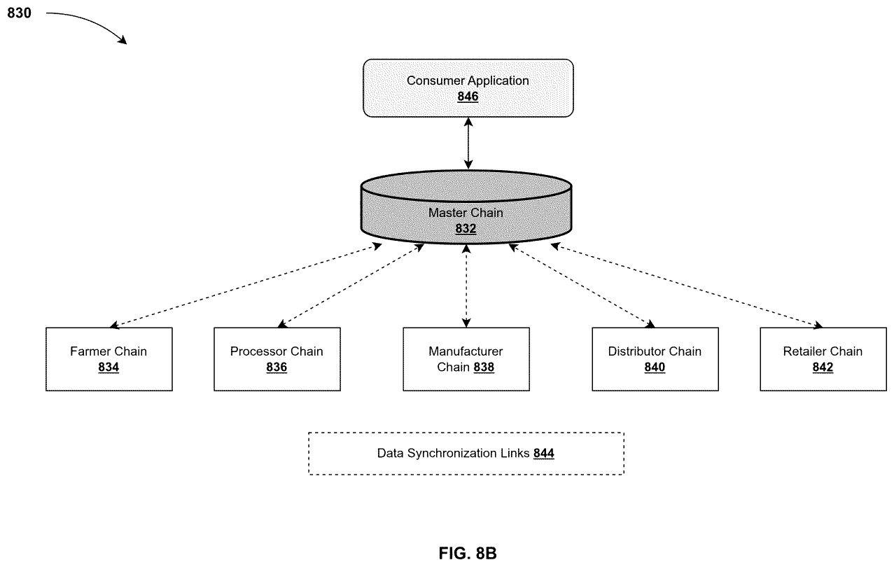

Referring to FIG. 8A, a single-chain configuration 810 is illustrated in accordance with some embodiments of the present disclosure. The single-chain configuration 810 represents a blockchain deployment architecture where all supply chain transactions from all stakeholders are stored on a unified ledger that is accessible to all participants within the traceability ecosystem. The single-chain configuration 810 may provide a straightforward implementation approach where the distributed ledger network 110 maintains a single authoritative record of all supply chain events, enabling complete visibility into product journeys from farm origin through consumer purchase. The single-chain configuration 810 may be suitable for supply chain networks where stakeholders prioritize transparency and interoperability over data compartmentalization, and where the participating organizations have established trust relationships that support open data sharing.

The single-chain configuration 810 includes a unified ledger that stores all supply chain transactions from all stakeholders participating in the traceability platform. The unified ledger may correspond to the master blockchain 114 described with reference to FIG. 1 and FIG. 2, serving as the single authoritative repository for Critical Tracking Events, Key Data Elements, carbon intensity submissions, and consumer purchase associations. The unified ledger may store transactions submitted by stakeholders at each stage of the supply chain, creating a comprehensive record that enables end-to-end traceability without requiring data aggregation from multiple separate ledgers. The unified ledger may employ the consensus module 330 described with reference to FIG. 3 to validate transactions and ensure that all nodes maintain consistent copies of the ledger state.

A farmer node 814 is connected directly to the unified ledger within the single-chain configuration 810 and represents a node operated by or on behalf of farmer stakeholders within the supply chain. The farmer node 814 may submit transactions to the unified ledger that record agricultural operations including planting events, growing period activities, and harvest events as described with reference to the farm stage 510 in FIG. 5. The farmer node 814 may submit carbon intensity data including tillage practices, irrigation usage, fertilizer application, and cover crop information that is stored in the universal data store 1620 and recorded on the unified ledger for certification and monetization purposes. The farmer node 814 may retrieve transactions from the unified ledger to verify the status of submitted data and to access traceability information for products that have moved downstream in the supply chain.

A processor node 816 is connected directly to the unified ledger within the single-chain configuration 810 and represents a node operated by or on behalf of processor stakeholders within the supply chain. The processor node 816 may submit transactions to the unified ledger that record processing activities including receiving events, processing events, and custody transfers as described with reference to the processing stage 530 in FIG. 5. The processor node 816 may retrieve transactions from the unified ledger to verify the origin and agricultural practices associated with incoming raw materials, enabling processors to confirm that received products match expected provenance claims. The processor node 816 may access farm-level data recorded by the farmer node 814, providing visibility into upstream supply chain activities that affect product quality and compliance status.

A manufacturer node 818 is connected directly to the unified ledger within the single-chain configuration 810 and represents a node operated by or on behalf of manufacturer stakeholders within the supply chain. The manufacturer node 818 may submit transactions to the unified ledger that record manufacturing activities including receiving events, aggregation events, transformation events, and product tagging as described with reference to the manufacturing stage 540 in FIG. 5. The manufacturer node 818 may create aggregation records 744 that link transformed products to all source ingredients, establishing the hierarchical linking structure 762 that enables traceability through product transformation. The manufacturer node 818 may retrieve transactions from the unified ledger to verify the processing history and farm origin of incoming ingredients, enabling manufacturers to confirm compliance with sourcing requirements and sustainability standards.

With continued reference to FIG. 8A, a distributor node 820 is connected directly to the unified ledger within the single-chain configuration 810 and represents a node operated by or on behalf of distributor stakeholders within the supply chain. The distributor node 820 may submit transactions to the unified ledger that record distribution activities including shipping events, transportation data, and custody transfers as described with reference to the distribution stage 550 in FIG. 5. The distributor node 820 may record cold chain monitoring data captured by the IoT sensors 158 during transportation, enabling verification that perishable products were maintained within acceptable temperature ranges throughout distribution. The distributor node 820 may retrieve transactions from the unified ledger to verify the manufacturing history and compliance status of products being distributed, enabling distributors to confirm that products meet quality and regulatory requirements before delivery to retail locations.

A retailer node 822 is connected directly to the unified ledger within the single-chain configuration 810 and represents a node operated by or on behalf of retailer stakeholders within the supply chain. The retailer node 822 may submit transactions to the unified ledger that record retail activities including receiving events, inventory data, and product placement as described with reference to the retail stage 560 in FIG. 5. The retailer node 822 may record point-of-sale events 628 that deactivate retail tags and create purchase associations linking consumers to purchased products. The retailer node 822 may retrieve transactions from the unified ledger to verify the complete supply chain history of products on retail shelves, enabling retailers to respond to consumer inquiries about product origin and to identify affected products when recall events occur.

A consumer application 824 accesses the unified ledger within the single-chain configuration 810 to retrieve product traceability data for display to consumers. The consumer application 824 may correspond to the consumer application 132 described with reference to FIG. 1, providing functionality for scanning ZPTAG authentication tags and viewing traceability information. The consumer application 824 may query the unified ledger to retrieve the complete chain of custody for scanned products, including farm origin data recorded by the farmer node 814, processing data recorded by the processor node 816, manufacturing data recorded by the manufacturer node 818, distribution data recorded by the distributor node 820, and retail data recorded by the retailer node 822. The consumer application 824 may display carbon intensity scores, compliance status, and origin information retrieved from the unified ledger, enabling consumers to make informed purchasing decisions based on product attributes and sustainability credentials.

The single-chain configuration 810 offers simplicity in implementation and operation, as all stakeholders interact with a single unified ledger rather than maintaining separate ledgers that require synchronization. The single-chain configuration 810 may reduce the complexity of data aggregation and cross-chain queries, as all traceability data is stored in a single location that can be queried directly by any authorized participant. The single-chain configuration 810 may provide complete transparency among all stakeholders, as each node has visibility into all transactions recorded on the unified ledger by other nodes. The complete transparency provided by the single-chain configuration 810 may support regulatory compliance by enabling auditors and regulators to access comprehensive supply chain records through a single query interface.

The single-chain configuration 810 may raise privacy concerns for sensitive business data that stakeholders prefer to keep confidential from competitors or other supply chain participants. In the single-chain configuration 810, transactions recorded by the farmer node 814 may be visible to the processor node 816, the manufacturer node 818, the distributor node 820, and the retailer node 822, potentially exposing pricing information, supplier relationships, production volumes, or other commercially sensitive data. Stakeholders operating in competitive markets may be reluctant to participate in a single-chain configuration 810 if participation requires disclosure of business information that could provide competitive advantages to other participants. The privacy concerns associated with the single-chain configuration 810 may be addressed through access control mechanisms that restrict visibility of certain data fields, though such mechanisms may add complexity to the implementation.

Referring to FIG. 8B, a multi-chain configuration 830 is illustrated in accordance with some embodiments of the present disclosure. The multi-chain configuration 830 represents a blockchain deployment architecture where individual stakeholders maintain their own private chains with selective data sharing to a consolidated master chain. The multi-chain configuration 830 may address the privacy concerns associated with the single-chain configuration 810 by enabling stakeholders to store sensitive business data on private chains that are not directly accessible to other stakeholders, while still providing consolidated traceability data through a shared master chain. The multi-chain configuration 830 may be suitable for supply chain networks where stakeholders require data compartmentalization to protect competitive information while still participating in end-to-end traceability programs.

A master chain 832 may consolidate data from individual stakeholder chains to provide a unified view of supply chain traceability. The master chain 832 may correspond to the master blockchain 114 described with reference to FIG. 1 and FIG. 2, serving as the authoritative repository for consolidated traceability data that is shared across all stakeholders. The master chain 832 may store summary records and traceability links that enable end-to-end product tracking without requiring storage of detailed business data that stakeholders prefer to keep private. The master chain 832 may store Critical Tracking Events and Key Data Elements required for FSMA compliance, carbon intensity scores certified by accredited certifiers, and consumer purchase associations that enable recall notifications. The master chain 832 may employ the consensus module 330 described with reference to FIG. 3 to validate transactions and ensure consistency across the consolidated ledger.

A farmer chain 834 is maintained by farmer stakeholders within the multi-chain configuration 830 and stores farm-related transactions that may include sensitive agricultural operation data. The farmer chain 834 may store detailed records of tillage practices, fertilizer applications, chemical treatments, irrigation usage, and harvest yields that farmers prefer to keep confidential from downstream supply chain participants. The farmer chain 834 may store carbon intensity input data captured through the ingestion layer 1640 and stored in the universal data store 1620, enabling farmers to maintain complete records of agricultural operations without exposing detailed practice data to processors, manufacturers, or retailers. The farmer chain 834 may be operated by individual farm organizations or by cooperative organizations that aggregate data from multiple member farms while maintaining privacy from external parties.

A processor chain 836 is maintained by processor stakeholders within the multi-chain configuration 830 and stores processing-related transactions that may include sensitive operational data. The processor chain 836 may store detailed records of processing activities, quality control results, yield rates, and supplier relationships that processors prefer to keep confidential from other supply chain participants. The processor chain 836 may store receiving records that identify specific farm sources and quantities received, enabling processors to maintain complete traceability records without exposing supplier relationships to competitors. The processor chain 836 may be operated by individual processor organizations or by industry consortia that aggregate data from multiple processors while maintaining privacy from external parties.

A manufacturer chain 838 is maintained by manufacturer stakeholders within the multi-chain configuration 830 and stores manufacturing-related transactions that may include sensitive production data. The manufacturer chain 838 may store detailed records of manufacturing processes, product formulations, production volumes, and supplier relationships that manufacturers prefer to keep confidential from other supply chain participants. The manufacturer chain 838 may store aggregation records that identify specific ingredient sources and quantities used in product batches, enabling manufacturers to maintain complete traceability records without exposing formulation details to competitors. The manufacturer chain 838 may be operated by individual manufacturer organizations or by industry groups that aggregate data from multiple manufacturers while maintaining privacy from external parties.

With continued reference to FIG. 8B, a distributor chain 840 is maintained by distributor stakeholders within the multi-chain configuration 830 and stores distribution-related transactions that may include sensitive logistics data. The distributor chain 840 may store detailed records of shipping routes, carrier relationships, delivery schedules, and customer information that distributors prefer to keep confidential from other supply chain participants. The distributor chain 840 may store transportation data 556 including temperature logs and location tracking that enables distributors to verify cold chain compliance without exposing logistics details to manufacturers or retailers. The distributor chain 840 may be operated by individual distributor organizations or by logistics networks that aggregate data from multiple distributors while maintaining privacy from external parties.

A retailer chain 842 is maintained by retailer stakeholders within the multi-chain configuration 830 and stores retail-related transactions that may include sensitive sales data. The retailer chain 842 may store detailed records of inventory levels, sales volumes, pricing information, and customer purchase patterns that retailers prefer to keep confidential from other supply chain participants. The retailer chain 842 may store point-of-sale records that enable retailers to track product movement and customer associations without exposing sales data to manufacturers or distributors. The retailer chain 842 may be operated by individual retailer organizations or by retail consortia that aggregate data from multiple retailers while maintaining privacy from external parties.

Data synchronization links 844 connect each stakeholder chain to the master chain 832 within the multi-chain configuration 830, enabling selective data sharing while maintaining stakeholder privacy on individual chains. The data synchronization links 844 may transfer summary records and traceability links from the farmer chain 834, the processor chain 836, the manufacturer chain 838, the distributor chain 840, and the retailer chain 842 to the master chain 832 without transferring detailed business data that stakeholders prefer to keep private. The data synchronization links 844 may implement filtering logic that determines which data elements are shared with the master chain 832 and which data elements remain private on the stakeholder chains. The data synchronization links 844 may transfer Critical Tracking Events and Key Data Elements required for FSMA compliance while filtering out pricing information, supplier identities, production volumes, and other commercially sensitive data.

The data synchronization links 844 may operate bidirectionally, enabling stakeholder chains to receive data from the master chain 832 as well as transmitting data to the master chain 832. The data synchronization links 844 may enable stakeholders to retrieve consolidated traceability data from the master chain 832 for products that have passed through other stages of the supply chain, providing visibility into upstream and downstream activities without requiring direct access to other stakeholder chains. The data synchronization links 844 may implement access control policies that determine which stakeholders can retrieve which data elements from the master chain 832, enabling fine-grained control over data visibility. The data synchronization links 844 may correspond to the blockchain bridges 332 described with reference to FIG. 3, facilitating communication between the stakeholder chains and the master chain 832.

A consumer application 846 accesses the master chain 832 within the multi-chain configuration 830 to retrieve consolidated product traceability data for display to consumers. The consumer application 846 may correspond to the consumer application 132 described with reference to FIG. 1, providing functionality for scanning ZPTAG authentication tags and viewing traceability information. The consumer application 846 may query the master chain 832 to retrieve the consolidated chain of custody for scanned products, including summary records synchronized from the farmer chain 834, the processor chain 836, the manufacturer chain 838, the distributor chain 840, and the retailer chain 842. The consumer application 846 may display origin information, compliance status, and carbon intensity scores retrieved from the master chain 832, enabling consumers to verify product authenticity and make informed purchasing decisions. The consumer application 846 may not have direct access to the individual stakeholder chains, ensuring that detailed business data remains private while consolidated traceability data is available for consumer verification.

The multi-chain configuration 830 offers enhanced privacy for individual stakeholders compared to the single-chain configuration 810, as sensitive business data remains on private stakeholder chains that are not directly accessible to other participants. The multi-chain configuration 830 may enable stakeholders to participate in end-to-end traceability programs while protecting competitive information from disclosure to competitors or other supply chain participants. The multi-chain configuration 830 may support compliance with data protection regulations that restrict sharing of certain data categories, as stakeholders can control which data elements are synchronized to the master chain 832 through the data synchronization links 844.

The multi-chain configuration 830 may introduce additional complexity compared to the single-chain configuration 810, as the platform must manage multiple stakeholder chains and coordinate data synchronization through the data synchronization links 844. The multi-chain configuration 830 may require additional infrastructure to operate and maintain the individual stakeholder chains, potentially increasing operational costs for stakeholders who must manage their own chain infrastructure. The multi-chain configuration 830 may introduce latency in data availability, as data must be synchronized from stakeholder chains to the master chain 832 before becoming available for consolidated queries.

Both the single-chain configuration 810 and the multi-chain configuration 830 may be implemented as private blockchains where participation is restricted to authorized stakeholders within the supply chain network. Private blockchain implementations may provide control over network membership, enabling supply chain organizers to determine which stakeholders are permitted to operate nodes and submit transactions. Private blockchain implementations may provide performance advantages compared to public blockchains, as the reduced number of nodes and controlled network membership may enable faster transaction confirmation and higher throughput. Private blockchain implementations may provide confidentiality advantages compared to public blockchains, as transaction data is not exposed to the general public.

Public blockchain implementations are also possible for both the single-chain configuration 810 and the multi-chain configuration 830, though public implementations may require additional consideration of data privacy and transaction costs. Public blockchain implementations may provide enhanced transparency and auditability, as transaction data is recorded on a publicly accessible ledger that can be verified by any interested party. Public blockchain implementations may provide enhanced security through broader network participation, as the larger number of nodes may increase resistance to attacks that attempt to manipulate the ledger. Public blockchain implementations may incur transaction fees that increase operational costs compared to private implementations, and may expose transaction data to public visibility that conflicts with stakeholder privacy requirements. The choice between private and public blockchain implementations may depend on the specific requirements of the supply chain network, including privacy needs, performance requirements, cost constraints, and regulatory considerations.

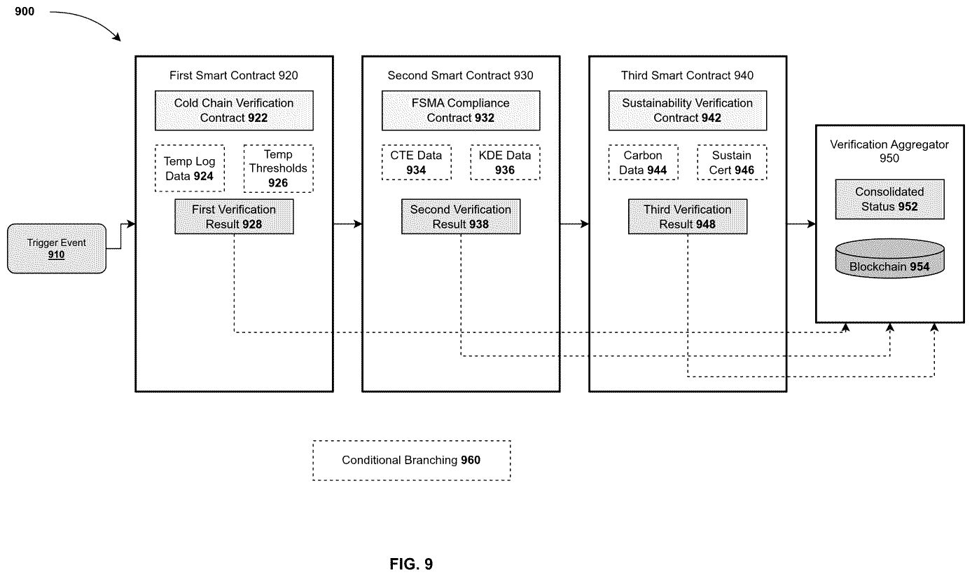

Referring to FIG. 9, a smart contract daisy-chaining 900 is illustrated in accordance with some embodiments of the present disclosure. The smart contract daisy-chaining 900 depicts how multiple smart contracts are sequentially linked to handle complex verification scenarios involving distinct verification steps, enabling modular verification architectures where different contracts handle different verification domains. The smart contract daisy-chaining 900 may address verification requirements that span multiple compliance areas, such as cold chain monitoring, regulatory compliance, and sustainability certification, by decomposing the verification process into discrete steps that are executed by specialized contracts in sequence. The smart contract daisy-chaining 900 may leverage the directive loaders 324 described with reference to FIG. 3 and FIG. 4, which enable smart contracts to reference external systems and pass control to subsequent contracts when additional verification steps are required.

A trigger event 910 initiates the smart contract execution sequence within the smart contract daisy-chaining 900. The trigger event 910 may be a tag scan performed by a consumer using the consumer application 132 or by a stakeholder using the stakeholder application 142, where the scan event requests verification of product authenticity and compliance status. The trigger event 910 may be a data submission where a stakeholder submits Critical Tracking Events or carbon intensity data that requires validation before recording on the distributed ledger network 110. The trigger event 910 may be a verification request initiated by a downstream supply chain participant who needs to confirm the compliance status of incoming products before accepting custody. The trigger event 910 may be generated automatically by the platform when products reach defined checkpoints in the supply chain, such as when products arrive at a distribution center or retail location. The trigger event 910 may include parameters that identify the product or shipment being verified, the verification requirements applicable to that product, and the requesting party who will receive the verification results.

A first smart contract 920 receives the trigger event 910 and executes a first verification step within the smart contract daisy-chaining 900. The first smart contract 920 may be specialized for a particular verification domain, implementing validation logic that is specific to that domain while remaining independent of other verification domains handled by subsequent contracts in the chain. The first smart contract 920 may access data from external sources through the external reference layer 450 described with reference to FIG. 4, retrieving information needed for verification that is not included in the trigger event 910 parameters. The first smart contract 920 may generate a verification result that indicates whether the verification step passed or failed, along with supporting data that documents the basis for the verification determination. Upon completing the first verification step, the first smart contract 920 may pass control to a second smart contract 930 for execution of a subsequent verification step, implementing the daisy-chain pattern that enables sequential execution of multiple verification contracts.

In the illustrated example within FIG. 9, the first smart contract 920 is implemented as a cold chain verification contract 922 that validates temperature conditions during transit of perishable food products. The cold chain verification contract 922 may be invoked when products on the Food Traceability List, such as fresh-cut fruits and vegetables or seafood products, require verification that temperature conditions remained within acceptable ranges throughout transportation and storage. The cold chain verification contract 922 may address the technical challenge of ensuring that perishable products were maintained at safe temperatures from the point of origin through delivery to the verification checkpoint, supporting food safety requirements that depend on continuous cold chain maintenance.

The cold chain verification contract 922 accesses temperature log data 924 that captures temperature readings recorded during product transportation and storage. The temperature log data 924 may be captured by the IoT sensors 158 described with reference to FIG. 1, including temperature sensors deployed in refrigerated trucks, cold storage facilities, and product packaging. The temperature log data 924 may include timestamped temperature readings that document the temperature conditions at regular intervals throughout the product journey, enabling reconstruction of the complete temperature history from origin to the verification checkpoint. The temperature log data 924 may be retrieved from the distributed ledger network 110 where temperature readings were recorded as part of the transportation data 556 described with reference to FIG. 5, or may be retrieved from external systems through the external data connector 452 described with reference to FIG. 4. The temperature log data 924 may include sensor identifiers that enable verification that the temperature readings correspond to the specific shipment being verified, preventing substitution of temperature data from different shipments.

The cold chain verification contract 922 compares the temperature log data 924 against acceptable temperature thresholds 926 that define the temperature ranges within which products must be maintained to ensure safety and quality. The acceptable temperature thresholds 926 may be defined based on product type, with different thresholds applicable to different product categories such as fresh produce, dairy products, frozen foods, and seafood. The acceptable temperature thresholds 926 may be retrieved from the regulatory database connector 454 described with reference to FIG. 4, ensuring that the verification contract applies current regulatory requirements for temperature control. The acceptable temperature thresholds 926 may include both upper and lower temperature limits, as some products may be damaged by temperatures that are too cold as well as temperatures that are too warm. The acceptable temperature thresholds 926 may include duration limits that specify how long products may be exposed to temperatures outside the acceptable range before the cold chain is considered broken, accommodating brief temperature excursions that may occur during loading and unloading operations.

The cold chain verification contract 922 generates a first verification result 928 that indicates whether the temperature conditions documented in the temperature log data 924 satisfied the acceptable temperature thresholds 926 throughout the product journey. The first verification result 928 may include a pass or fail determination that summarizes the overall cold chain verification status. The first verification result 928 may include detailed data documenting the minimum and maximum temperatures recorded, the duration of any temperature excursions outside acceptable ranges, and the timestamps and locations where temperature excursions occurred. The first verification result 928 may include confidence indicators that reflect the completeness and reliability of the temperature log data 924, such as whether temperature readings were recorded at expected intervals and whether any gaps exist in the temperature record. The first verification result 928 may be stored temporarily within the smart contract execution environment pending aggregation with results from subsequent verification contracts.

With continued reference to FIG. 9, a second smart contract 930 receives control from the first smart contract 920 and executes a second verification step within the smart contract daisy-chaining 900. The second smart contract 930 may be specialized for a different verification domain than the first smart contract 920, implementing validation logic that addresses distinct compliance requirements. The second smart contract 930 may receive the first verification result 928 as input, enabling the second smart contract 930 to consider the outcome of the first verification step when executing the second verification step. The second smart contract 930 may access different data sources than the first smart contract 920, retrieving information specific to the verification domain handled by the second smart contract 930.

In the illustrated example within FIG. 9, the second smart contract 930 is implemented as an FSMA compliance contract 932 that validates compliance with Food Safety Modernization Act requirements. The FSMA compliance contract 932 may verify that products on the Food Traceability List have complete and accurate traceability records that satisfy regulatory requirements for Critical Tracking Events and Key Data Elements. The FSMA compliance contract 932 may correspond to the compliance contract 442 described with reference to FIG. 4, implementing the compliance verification logic within the daisy-chain verification sequence. The FSMA compliance contract 932 may address the technical challenge of verifying that all required traceability data has been recorded at each stage of the supply chain, ensuring that products can be traced forward to consumers and backward to sources as required by FSMA regulations.

The FSMA compliance contract 932 accesses critical tracking event data 934 that captures the Critical Tracking Events recorded for the product being verified. The critical tracking event data 934 may include receiving events recorded at the processing stage 530, the manufacturing stage 540, the distribution stage 550, and the retail stage 560 as described with reference to FIG. 5. The critical tracking event data 934 may include shipping events, transformation events, and aggregation events that document custody transfers and product transformations throughout the supply chain. The critical tracking event data 934 may be retrieved from the master blockchain 114 where Critical Tracking Events were recorded through the tracking contract 444 described with reference to FIG. 4. The critical tracking event data 934 may include event identifiers, timestamps, locations, and party identifiers that enable verification of the completeness and consistency of the traceability record.

The FSMA compliance contract 932 also accesses key data element data 936 that captures the Key Data Elements recorded at each Critical Tracking Event. The key data element data 936 may include lot codes, product descriptions, quantities, dates, times, and identifiers of parties involved in each tracking event as required by FSMA regulations. The key data element data 936 may be retrieved from the master blockchain 114 in association with the critical tracking event data 934, enabling verification that each Critical Tracking Event includes all required Key Data Elements. The key data element data 936 may be validated against regulatory requirements retrieved from the regulatory database connector 454, ensuring that the verification contract applies current FSMA requirements for Key Data Element capture.

The FSMA compliance contract 932 generates a second verification result 938 that indicates whether the traceability records documented in the critical tracking event data 934 and the key data element data 936 satisfy FSMA compliance requirements. The second verification result 938 may include a pass or fail determination that summarizes the overall FSMA compliance status. The second verification result 938 may include detailed data documenting which Critical Tracking Events were recorded, which Key Data Elements were captured at each event, and whether any required data elements are missing or incomplete. The second verification result 938 may identify specific compliance gaps that require remediation, enabling stakeholders to address deficiencies before regulatory inspections or audits. The second verification result 938 may be stored temporarily within the smart contract execution environment pending aggregation with results from other verification contracts.

As further shown in FIG. 9, a third smart contract 940 receives control from the second smart contract 930 and executes a third verification step within the smart contract daisy-chaining 900. The third smart contract 940 may be specialized for sustainability verification, implementing validation logic that addresses carbon intensity and environmental certification requirements. The third smart contract 940 may receive the first verification result 928 and the second verification result 938 as inputs, enabling the third smart contract 940 to consider the outcomes of prior verification steps when executing the third verification step. The third smart contract 940 may access data sources related to sustainability credentials and carbon intensity calculations.

In the illustrated example within FIG. 9, the third smart contract 940 is implemented as a sustainability verification contract 942 that validates carbon footprint and sustainability credentials for products being verified. The sustainability verification contract 942 may verify that products have certified carbon intensity scores from accredited certifiers, that sustainability claims are supported by appropriate documentation, and that carbon credentials are properly associated with the physical products being verified. The sustainability verification contract 942 may correspond to the carbon contract 448 described with reference to FIG. 4, implementing sustainability verification logic within the daisy-chain verification sequence. The sustainability verification contract 942 may address the technical challenge of verifying that carbon intensity claims are accurate and that certified carbon credentials are properly linked to specific product lots and shipments.

The sustainability verification contract 942 accesses carbon intensity data 944 that captures the carbon intensity scores and underlying agricultural operation data for the products being verified. The carbon intensity data 944 may include estimated carbon intensity scores computed by the CI computation service 1670 and certified carbon intensity scores returned by accredited certifiers as described with reference to FIG. 16. The carbon intensity data 944 may include the agricultural operation records stored in the universal data store 1620, including tillage data, irrigation data, fertilizer data, and harvest data that form the basis for carbon intensity calculations. The carbon intensity data 944 may be retrieved from the master blockchain 114 where carbon intensity submissions and certification results were recorded through the submission sealing service 1680 described with reference to FIG. 16. The carbon intensity data 944 may include submission identifiers and certification timestamps that enable verification of the authenticity and currency of carbon intensity credentials.

The sustainability verification contract 942 also accesses sustainability certification data 946 that captures certifications and attestations related to sustainable farming practices and environmental stewardship. The sustainability certification data 946 may include organic certifications, non-GMO verifications, and other sustainability credentials that support premium pricing or regulatory compliance. The sustainability certification data 946 may include certifier identities, certification dates, and certification scopes that enable verification that certifications are valid and applicable to the products being verified. The sustainability certification data 946 may be retrieved from the master blockchain 114 or from external certification databases through the regulatory database connector 454 described with reference to FIG. 4.

The sustainability verification contract 942 generates a third verification result 948 that indicates whether the carbon intensity and sustainability credentials documented in the carbon intensity data 944 and the sustainability certification data 946 satisfy applicable requirements. The third verification result 948 may include a pass or fail determination that summarizes the overall sustainability verification status. The third verification result 948 may include the certified carbon intensity score associated with the product, enabling downstream participants to make decisions based on carbon credentials. The third verification result 948 may include detailed data documenting which sustainability certifications are in effect, the scope and validity period of each certification, and whether any certifications have expired or been revoked. The third verification result 948 may identify the accredited certifier who issued the carbon intensity certification, enabling verification of certifier credentials and authority.

A verification aggregator 950 receives the verification results from all smart contracts in the daisy-chain sequence and generates a consolidated verification status 952 that summarizes the overall verification outcome. The verification aggregator 950 may receive the first verification result 928 from the cold chain verification contract 922, the second verification result 938 from the FSMA compliance contract 932, and the third verification result 948 from the sustainability verification contract 942. The verification aggregator 950 may combine the individual verification results into a unified status that indicates whether all verification steps passed, whether any verification steps failed, and which specific verification domains require attention. The verification aggregator 950 may apply aggregation logic that determines the overall verification status based on the individual results, such as requiring all verification steps to pass for an overall pass status or allowing certain verification failures to be flagged as warnings rather than failures.

The consolidated verification status 952 generated by the verification aggregator 950 is recorded on a blockchain 954 within the smart contract daisy-chaining 900. The blockchain 954 may correspond to the master blockchain 114 described with reference to FIG. 1 and FIG. 2, providing immutable storage for the verification results. The consolidated verification status 952 may be recorded through the tracking contract 444 or a dedicated verification recording contract within the smart contract execution layer 440. The consolidated verification status 952 may include a verification identifier, a verification timestamp, the product or shipment identifier that was verified, and the individual verification results from each contract in the daisy-chain sequence. The consolidated verification status 952 may be linked to the blockchain records associated with the verified product, enabling retrieval of verification results when the product is scanned or when traceability queries are executed.

The consolidated verification status 952 is returned to the requesting application that initiated the trigger event 910, enabling the application to display verification results to users or to take automated actions based on the verification outcome. The consumer application 132 may display the consolidated verification status 952 to consumers who scan products, indicating whether the product passed cold chain verification, FSMA compliance verification, and sustainability verification. The stakeholder application 142 may display the consolidated verification status 952 to stakeholders who receive products, enabling acceptance or rejection decisions based on verification results. The consolidated verification status 952 may trigger automated workflows such as routing products to quarantine areas when verification fails or releasing products for sale when verification passes.

With continued reference to FIG. 9, conditional branching 960 may route control to different contracts based on product type or verification requirements within the smart contract daisy-chaining 900. The conditional branching 960 enables the daisy-chain sequence to adapt to different verification scenarios, executing different combinations of verification contracts based on the characteristics of the product being verified and the requirements of the requesting party. The conditional branching 960 may evaluate product attributes such as product category, Food Traceability List status, perishability, and sustainability certification requirements to determine which verification contracts should be invoked. The conditional branching 960 may evaluate requestor attributes such as regulatory jurisdiction, customer requirements, and verification preferences to customize the verification sequence.

The conditional branching 960 may skip verification contracts that are not applicable to a particular product or verification scenario. For products that are not perishable and do not require cold chain maintenance, the conditional branching 960 may bypass the cold chain verification contract 922 and proceed directly to the FSMA compliance contract 932. For products that are not on the Food Traceability List and do not require FSMA compliance verification, the conditional branching 960 may bypass the FSMA compliance contract 932 and proceed to other applicable verification contracts. For products that do not have carbon intensity certifications or sustainability credentials, the conditional branching 960 may bypass the sustainability verification contract 942 or may flag the absence of sustainability credentials in the verification results.

The conditional branching 960 may add verification contracts that are required for specific product types or verification scenarios. For products that require organic certification verification, the conditional branching 960 may route control to an organic certification contract that validates organic credentials in addition to the verification contracts shown in FIG. 9. For products that require country-of-origin verification, the conditional branching 960 may route control to an origin verification contract that validates geographic provenance claims. For products that require allergen verification, the conditional branching 960 may route control to an allergen verification contract that validates ingredient declarations against allergen databases.

The modular architecture enabled by the smart contract daisy-chaining 900 and the conditional branching 960 allows verification contracts to be added, removed, or modified independently without affecting other contracts in the chain. New verification requirements may be addressed by deploying new verification contracts and configuring the conditional branching 960 to invoke the new contracts for applicable products. Existing verification contracts may be updated to reflect changes in regulatory requirements or verification methodologies without requiring modification of other contracts in the chain. Verification contracts that are no longer needed may be deprecated and removed from the daisy-chain sequence through configuration changes to the conditional branching 960. The contract versioning module 434 described with reference to FIG. 4 may manage versions of verification contracts, enabling gradual migration from older contract versions to newer versions while maintaining backward compatibility for ongoing verification operations.

Referring to FIG. 10, a consumer application architecture and workflow 1000 is illustrated in accordance with some embodiments of the present disclosure. The consumer application architecture and workflow 1000 provides an intuitive interface for product verification, recall notifications, and enhanced shopping experiences within the traceability platform. The consumer application architecture and workflow 1000 may correspond to the consumer application 132 described with reference to FIG. 1, providing a detailed view of the functional components and user workflow that enable consumers to interact with the distributed ledger network 110 for product authentication and traceability verification. The consumer application architecture and workflow 1000 may be implemented as a mobile application executing on the consumer devices 130, providing access to blockchain-based traceability data through the user interface 136 and the digital wallet 134.

An authentication layer 1010 is included within the consumer application architecture and workflow 1000 and manages user identity and access permissions within the consumer application. The authentication layer 1010 may provide the foundation for personalized features including dietary alerts, purchase history tracking, and recall notifications that require association between the consumer and their activities within the platform. The authentication layer 1010 may support multiple authentication methods including username and password credentials, biometric authentication, and social login integration, enabling consumers to select authentication approaches that balance security and convenience according to their preferences. The authentication layer 1010 may interface with the blockchain bridges 332 described with reference to FIG. 3 to associate consumer identities with wallet addresses on the distributed ledger network 110, enabling token transactions and purchase associations to be linked to authenticated consumer accounts.

A registration module 1012 is included within the authentication layer 1010 and enables users to create accounts with username and password credentials for accessing the consumer application. The registration module 1012 may capture consumer information including email address, name, and optional demographic data that enables personalized experiences within the platform. The registration module 1012 may validate email addresses through confirmation messages, ensuring that consumers provide valid contact information for recall notifications and account recovery. The registration module 1012 may generate cryptographic key pairs that enable consumers to sign transactions and prove ownership of digital assets within the digital wallet 134. The registration module 1012 may create wallet addresses derived from public keys that serve as identifiers for consumers within the distributed ledger network 110, enabling purchase associations and token distributions to be recorded on the master blockchain 114.

A permission manager 1014 is included within the authentication layer 1010 and requests and manages device permissions required for consumer application functionality. The permission manager 1014 may present permission requests to consumers during initial application setup or when consumers first attempt to use features that require specific device capabilities. The permission manager 1014 may explain the purpose of each requested permission, enabling consumers to make informed decisions about granting access to device resources. The permission manager 1014 may track which permissions have been granted and which have been denied, adapting application functionality based on available permissions. The permission manager 1014 may provide guidance for consumers who wish to modify permissions after initial setup, directing consumers to device settings where permissions can be adjusted.

Camera access 1016 is managed by the permission manager 1014 and enables tag scanning functionality within the consumer application. The camera access 1016 may be requested when consumers first attempt to scan a ZPTAG authentication tag, with the permission manager 1014 explaining that camera access is required to capture and decode tag images. The camera access 1016 may enable the scanning module 1022 to activate the device camera, capture images of QR codes or other visual tags, and process the captured images to extract tag identifiers. Without the camera access 1016, consumers may be unable to scan tags for product verification, though other application features that do not require camera functionality may remain available. The camera access 1016 may be revoked by consumers through device settings, and the permission manager 1014 may detect revoked permissions and prompt consumers to restore camera access when they attempt to use scanning features.

Location access 1018 is managed by the permission manager 1014 and enables product placement verification and store locator functionality within the consumer application. The location access 1018 may be requested when consumers first attempt to use location-dependent features such as finding nearby stores or verifying that scanned products are located at expected retail locations. The location access 1018 may enable the consumer application to capture GPS coordinates from the device and compare captured coordinates against expected product locations, supporting detection of products that appear at unexpected locations which may indicate counterfeiting or diversion. The location access 1018 may enable the store locator module 1050 to identify retail locations near the consumer's current position, displaying stores that carry products of interest and providing directions to those locations. The location access 1018 may be configured for different access levels including always-on access, access only while using the application, or no access, with the permission manager 1014 adapting functionality based on the granted access level.

A guest mode 1019 is included within the authentication layer 1010 and enables limited functionality without account creation for consumers who prefer not to register. The guest mode 1019 may provide access to core scanning and verification features, enabling consumers to scan ZPTAG authentication tags and view traceability information without creating an account or providing personal information. The guest mode 1019 may disable features that require consumer identification, including purchase history tracking, recall notifications, loyalty points accumulation, and personalized dietary alerts. The guest mode 1019 may display prompts encouraging consumers to create accounts to access additional features, explaining the benefits of registration while respecting consumer preferences for anonymous usage. The guest mode 1019 may store limited session data locally on the device, enabling consumers to view recently scanned products within a session without persisting data across sessions or associating data with a consumer identity.

The consumer application 132 supports a proxy shopping mode that enables a consumer to grant temporary access to a designated proxy shopper, such as a personal shopper, a grocery delivery service operator, or a retail staff member shopping on behalf of the consumer. The proxy shopper may use the consumer application 132 on a separate device to scan ZPTAG authentication tags, verify product authenticity, and accumulate scanned items on behalf of the consumer. Scan events performed by the proxy shopper are associated with the consumer's account, enabling the consumer to receive traceability data, recall notifications, and reward tokens for products selected and purchased by the proxy shopper. The proxy shopping mode may grant limited permissions that enable scanning and verification functions while restricting access to the consumer's personal preferences, purchase history, and wallet information.

The consumer application 132 supports multiple languages, enabling the user interface 136 to render text, labels, notifications, and product information in a language selected by the consumer. The consumer application 132 may detect the device language setting and automatically configure the display language, or may provide a language selection interface that enables the consumer to choose from available languages. Multi-language support extends to recall notifications delivered through the push notification service 1184, product information displayed through the product information display 1030, and warning messages generated by the warning display module 1048.

With continued reference to FIG. 10, a core functionality layer 1020 is included within the consumer application architecture and workflow 1000 and provides the primary features for product scanning, verification, and information display. The core functionality layer 1020 may implement the technical mechanisms that enable consumers to interact with the distributed ledger network 110 for product authentication and traceability verification. The core functionality layer 1020 may be accessible to both registered consumers and consumers using the guest mode 1019, providing universal access to product verification capabilities regardless of registration status. The core functionality layer 1020 may interface with the blockchain bridges 332 to submit verification requests and retrieve traceability data from the master blockchain 114.

A scanning module 1022 is included within the core functionality layer 1020 and enables users to scan tags using the device camera. The scanning module 1022 may activate the device camera when consumers initiate a scan operation, displaying a viewfinder interface that guides consumers to position tags within the camera frame. The scanning module 1022 may implement image processing algorithms that detect tag boundaries within captured images, enabling automatic tag recognition without requiring consumers to manually trigger image capture. The scanning module 1022 may support continuous scanning mode where multiple tags can be scanned in sequence without returning to a menu between scans, enabling efficient scanning of multiple products during shopping. The scanning module 1022 may provide visual feedback indicating when a tag has been successfully detected and decoded, such as highlighting the detected tag boundary or displaying a confirmation indicator.

A tag decoder 1024 is included within the core functionality layer 1020 and interprets QR codes, RFID signals, or NFC signals captured by the scanning module 1022. The tag decoder 1024 may implement decoding algorithms for multiple tag formats, enabling the consumer application to work with different tag technologies that may be deployed by different stakeholders within the supply chain. The tag decoder 1024 may extract unique identifiers from decoded tags, parsing the encoded data to identify the tag identifier that links the physical tag to its blockchain record. The tag decoder 1024 may validate tag format and checksum data to detect corrupted or malformed tags, displaying error messages when tags cannot be successfully decoded. The tag decoder 1024 may support QR code decoding for visual tags that can be scanned using the device camera, RFID signal decoding for tags that can be read using device RFID capabilities, and NFC signal decoding for tags that can be read by touching the device to the tag. The tag decoder 1024 may determine the appropriate decoding method based on the tag type detected by the scanning module 1022.

A verification engine 1026 is included within the core functionality layer 1020 and communicates with the blockchain to verify product authenticity and retrieve traceability data. The verification engine 1026 may receive decoded tag identifiers from the tag decoder 1024 and submit verification requests to the distributed ledger network 110 through the blockchain bridges 332. The verification engine 1026 may invoke the smart contract daisy-chaining 900 described with reference to FIG. 9 to execute verification steps including cold chain verification, FSMA compliance verification, and sustainability verification as applicable to the scanned product. The verification engine 1026 may retrieve the consolidated verification status 952 generated by the verification aggregator 950, determining whether the scanned product passed all applicable verification steps. The verification engine 1026 may retrieve traceability records from the master blockchain 114, including the first blockchain record 520, the second blockchain record 538, the third blockchain record 548, the fourth blockchain record 558, and the fifth blockchain record 568 that document the product journey from farm origin through retail placement. The verification engine 1026 may query the state storage 464 to determine the current tag state, verifying that the scanned tag is in the active state 620 or the reactivated state 640 and has not been transitioned to the deactivated state 630 or the invalid state 650.

An audio feedback module 1028 is included within the core functionality layer 1020 and provides auditory confirmation of successful verification through a distinctive tone. The audio feedback module 1028 may play a confirmation sound when the verification engine 1026 determines that a scanned product is authentic and has passed all applicable verification steps, providing immediate feedback to consumers without requiring them to read verification results on the display. The audio feedback module 1028 may play a different sound when verification fails or when the scanned tag is in an invalid state, alerting consumers to potential authenticity concerns through an auditory warning. The audio feedback module 1028 may be configurable by consumers, enabling adjustment of volume levels, selection of different sound effects, or disabling of audio feedback for consumers who prefer silent operation. The audio feedback module 1028 may provide haptic feedback in addition to or instead of audio feedback on devices that support vibration, enabling consumers to receive confirmation through tactile sensation.

A product information display 1030 is included within the core functionality layer 1020 and presents traceability data to the user following successful tag scanning and verification. The product information display 1030 may format traceability data retrieved by the verification engine 1026 into a visual presentation that enables consumers to understand the product journey and verify product attributes. The product information display 1030 may present information in a hierarchical structure that provides summary information at the top level with the ability to access detailed information through navigation. The product information display 1030 may include visual elements such as maps showing product origin locations, timelines showing the sequence of supply chain events, and icons indicating compliance status and sustainability credentials. The product information display 1030 may adapt the presentation based on product type and available data, displaying relevant information for each product category while omitting fields that are not applicable.

Origin information 1032 is included within the product information display 1030 and presents data regarding the source of the scanned product. The origin information 1032 may display the farm name, farm location, and geographic region where the product was grown or produced, enabling consumers to verify provenance claims and support local or regional producers. The origin information 1032 may display the harvest date and growing season, enabling consumers to assess product freshness and seasonality. The origin information 1032 may display agricultural practices including organic certification status, sustainability credentials, and carbon intensity scores retrieved from the first blockchain record 520 and associated certification records. The origin information 1032 may include photographs of the farm or production facility when available, providing visual context that enhances consumer connection to product sources.

A distribution path 1034 is included within the product information display 1030 and presents data regarding the journey of the scanned product through the supply chain. The distribution path 1034 may display a visual representation of the supply chain stages through which the product passed, including the processing stage 530, the manufacturing stage 540, the distribution stage 550, and the retail stage 560. The distribution path 1034 may display timestamps indicating when the product arrived at and departed from each stage, enabling consumers to assess the time elapsed since harvest and the efficiency of the distribution process. The distribution path 1034 may display geographic locations for each stage, enabling consumers to understand the transportation distances involved in bringing the product to market. The distribution path 1034 may display the identities of stakeholders at each stage when stakeholders have opted to share their information with consumers, enabling consumers to learn about the companies involved in producing and distributing the product.

A compliance status 1036 is included within the product information display 1030 and presents data regarding regulatory compliance for the scanned product. The compliance status 1036 may display FSMA compliance indicators showing whether the product has complete traceability records that satisfy Food Safety Modernization Act requirements for products on the Food Traceability List. The compliance status 1036 may display the second verification result 938 generated by the FSMA compliance contract 932, indicating whether all required Critical Tracking Events and Key Data Elements have been recorded. The compliance status 1036 may display cold chain compliance indicators showing whether temperature conditions remained within acceptable ranges throughout transportation, based on the first verification result 928 generated by the cold chain verification contract 922. The compliance status 1036 may display certification status for organic, non-GMO, kosher, halal, and other certifications that apply to the scanned product, enabling consumers to verify that certification claims are supported by valid documentation.

A drill-down interface 1038 is included within the product information display 1030 and enables users to access deeper insights at each stage of the product's journey through the supply chain. The drill-down interface 1038 may provide navigation controls that enable consumers to select individual supply chain stages and view detailed information recorded at each stage. The drill-down interface 1038 may display detailed Critical Tracking Event data including receiving events, shipping events, and transformation events recorded at each stage, enabling consumers to examine the complete documentary chain. The drill-down interface 1038 may display Key Data Element data including lot codes, quantities, timestamps, and party identifiers associated with each Critical Tracking Event. The drill-down interface 1038 may display quality control results, inspection records, and certification documentation when such information has been recorded on the distributed ledger network 110. The drill-down interface 1038 may enable consumers to navigate through the hierarchical linking structure 762 described with reference to FIG. 7, tracing transformed products back to all source ingredients and their respective farm origins.

As further shown in FIG. 10, a personalization layer 1040 is included within the consumer application architecture and workflow 1000 and enables consumers to configure alerts for dietary restrictions, allergens, and preferences. The personalization layer 1040 may store consumer-specific settings that customize the behavior of the consumer application based on individual dietary needs and preferences. The personalization layer 1040 may require consumer registration through the registration module 1012, as personalization features depend on persistent storage of consumer preferences that cannot be maintained in the guest mode 1019. The personalization layer 1040 may synchronize consumer preferences across multiple devices, enabling consumers to access their personalized settings when using the consumer application on different smartphones or tablets.

An alert configuration module 1042 is included within the personalization layer 1040 and enables users to configure alerts for dietary restrictions and allergens. The alert configuration module 1042 may provide an interface for consumers to specify allergens that should trigger warnings when detected in scanned products, enabling consumers with food allergies to identify potentially dangerous products before consumption. The alert configuration module 1042 may provide an interface for consumers to specify dietary preferences that should be flagged when scanned products do not conform, enabling consumers following specific diets to identify products that meet their requirements. The alert configuration module 1042 may enable consumers to configure alert severity levels, distinguishing between allergens that pose serious health risks and preferences that are less critical. The alert configuration module 1042 may enable consumers to configure alert presentation, selecting whether alerts should be displayed as prominent warnings, subtle indicators, or audio notifications.

An allergen database 1044 is included within the personalization layer 1040 and stores user-specified allergens such as peanuts, gluten, or MSG. The allergen database 1044 may maintain a list of allergens that the consumer has identified as requiring alerts, with each allergen associated with configuration settings specified through the alert configuration module 1042. The allergen database 1044 may include common allergens such as peanuts, tree nuts, milk, eggs, wheat, soy, fish, and shellfish that are recognized as major food allergens under regulatory frameworks. The allergen database 1044 may include additional allergens and sensitivities such as gluten, MSG, sulfites, and artificial colors that some consumers prefer to avoid. The allergen database 1044 may be queried when products are scanned, comparing product ingredient data retrieved from the distributed ledger network 110 against the consumer's allergen list to determine whether alerts should be displayed.

A dietary preference database 1046 is included within the personalization layer 1040 and stores user-specified dietary preferences such as kosher, organic, or non-GMO. The dietary preference database 1046 may maintain a list of dietary requirements and preferences that the consumer has identified as relevant to their purchasing decisions. The dietary preference database 1046 may include religious dietary requirements such as kosher and halal that require specific production and certification practices. The dietary preference database 1046 may include lifestyle dietary preferences such as vegetarian, vegan, and pescatarian that restrict consumption of certain animal products. The dietary preference database 1046 may include production method preferences such as organic, non-GMO, and sustainably sourced that reflect consumer values regarding agricultural and manufacturing practices. The dietary preference database 1046 may be queried when products are scanned, comparing product certification data and ingredient information against the consumer's preference list to determine whether the product conforms to stated preferences.

A warning display module 1048 is included within the personalization layer 1040 and prominently displays warnings when scanned products contain flagged ingredients. The warning display module 1048 may generate visual alerts that overlay the product information display 1030 when allergens from the allergen database 1044 are detected in scanned product ingredients. The warning display module 1048 may display the specific allergen or allergens detected, enabling consumers to understand which ingredients triggered the alert. The warning display module 1048 may use prominent visual styling such as red backgrounds, warning icons, and large text to ensure that allergen warnings are immediately noticeable. The warning display module 1048 may generate alerts when scanned products do not conform to preferences stored in the dietary preference database 1046, using less prominent styling to distinguish preference alerts from allergen warnings. The warning display module 1048 may interface with the audio feedback module 1028 to provide auditory warnings in addition to visual alerts, ensuring that consumers are alerted even when not looking directly at the device display.

The store locator module 1050 is included within the consumer application architecture and workflow 1000 and enables users to search for products and identify participating stores. The store locator module 1050 may utilize the location access 1018 granted through the permission manager 1014 to identify the consumer's current location and display nearby retail locations that participate in the traceability platform. The store locator module 1050 may enable consumers to search for specific products and identify stores that carry those products, displaying store locations on a map interface with distance and direction information. The store locator module 1050 may display store details including address, hours of operation, and contact information, enabling consumers to plan shopping trips to stores that carry desired products. The store locator module 1050 may integrate with mapping and navigation applications on the consumer device, enabling consumers to obtain directions to selected stores.

An inventory tracker 1052 is included within the consumer application architecture and workflow 1000 and displays real-time inventory levels and identifies products that have been scanned but not yet purchased. The inventory tracker 1052 may query inventory data 566 recorded at the retail stage 560 to determine current stock levels for products at nearby stores, enabling consumers to verify product availability before traveling to a store. The inventory tracker 1052 may display inventory status indicators showing whether products are in stock, low stock, or out of stock at selected retail locations. The inventory tracker 1052 may track products that the consumer has scanned during a shopping session, maintaining a list of scanned items that can be used during checkout as described with reference to the consumer scanning and purchase association flow 1100. The inventory tracker 1052 may display notifications when previously scanned products become available at nearby stores, enabling consumers to be alerted when desired products are restocked.

With continued reference to FIG. 10, a rewards layer 1060 is included within the consumer application architecture and workflow 1000 and manages consumer incentive programs including loyalty points, promotional offers, and token-based rewards. The rewards layer 1060 may interface with the rewards dApp 316 described with reference to FIG. 3 and the rewards contract 446 described with reference to FIG. 4 to track and distribute rewards based on consumer activities within the platform. The rewards layer 1060 may require consumer registration through the registration module 1012, as rewards features depend on association between consumer identities and reward balances that cannot be maintained in the guest mode 1019. The rewards layer 1060 may provide incentives that encourage consumer participation in traceability verification activities, creating value for consumers while generating engagement data that benefits the platform ecosystem.

A loyalty points module 1062 is included within the rewards layer 1060 and tracks accumulated points earned by consumers through scanning and purchasing activities. The loyalty points module 1062 may award points when consumers scan ZPTAG authentication tags, encouraging consumers to verify product authenticity and engage with traceability data. The loyalty points module 1062 may award points when consumers complete purchases of products that have been scanned, creating associations between consumers and purchased products that enable recall notifications. The loyalty points module 1062 may display current point balances and point earning history, enabling consumers to track their accumulation of rewards over time. The loyalty points module 1062 may display available redemption options showing how accumulated points can be exchanged for discounts, products, or other benefits within the platform ecosystem.

A coupon manager 1064 is included within the rewards layer 1060 and stores and automatically applies personalized promotions at checkout. The coupon manager 1064 may receive promotional offers from brands and retailers that are targeted to specific consumers based on purchase history, preferences, and engagement patterns. The coupon manager 1064 may store received coupons in a digital coupon wallet, displaying available coupons and their terms including discount amounts, applicable products, and expiration dates. The coupon manager 1064 may automatically identify applicable coupons when products are scanned, alerting consumers to available discounts before purchase decisions are finalized. The coupon manager 1064 may interface with point-of-sale systems at participating retailers to automatically apply coupons during checkout, reducing friction in the redemption process and ensuring that consumers receive entitled discounts.

A token wallet 1066 is included within the rewards layer 1060 and stores GMGZP tokens 364 earned through scanning and purchasing activities within the platform. The token wallet 1066 may correspond to the digital wallet 134 described with reference to FIG. 1, providing a specialized interface for managing tokens earned through consumer engagement. The token wallet 1066 may display current token balances and transaction history, enabling consumers to track their token holdings and the activities that generated token rewards. The token wallet 1066 may enable consumers to transfer tokens to other wallet addresses, trade tokens on supported exchanges through the token trading module 1560, or redeem tokens for discounts and services within the platform. The token wallet 1066 may interface with the token management layer 370 described with reference to FIG. 3 to record token transactions on the distributed ledger network 110, ensuring that token balances are accurately maintained and verifiable.

A feedback module 1068 is included within the rewards layer 1060 and enables users to communicate directly with brands regarding product experiences. The feedback module 1068 may provide an interface for consumers to submit ratings, reviews, and comments about scanned products, creating a channel for consumer feedback that reaches product manufacturers. The feedback module 1068 may enable consumers to report quality issues, suggest improvements, or express satisfaction with products, providing valuable market research data to brands. The feedback module 1068 may associate feedback with specific product lots and batches through the traceability records retrieved by the verification engine 1026, enabling brands to correlate consumer feedback with production data. The feedback module 1068 may award loyalty points or tokens for submitted feedback, incentivizing consumer participation in feedback programs.

A recall notification module 1070 is included within the consumer application architecture and workflow 1000 and monitors for recall events and pushes targeted notifications to users who have purchased affected products. The recall notification module 1070 may correspond to the real-time recall notification system 1300, implementing the consumer-facing components that receive and display recall notifications. The recall notification module 1070 may monitor for recall events by querying the distributed ledger network 110 for recall notices that affect products associated with the consumer's purchase history. The recall notification module 1070 may receive push notifications from the push notification service 1344 when recall events are initiated that affect products the consumer has purchased. The recall notification module 1070 may display recall notifications prominently within the consumer application, presenting recall reason information 1352, recommended actions 1354, and compensation offers 1356 as described with reference to FIG. 13. The recall notification module 1070 may enable consumers to acknowledge receipt of recall notifications and to indicate actions taken in response, supporting recall tracking and completion monitoring by manufacturers and regulators.

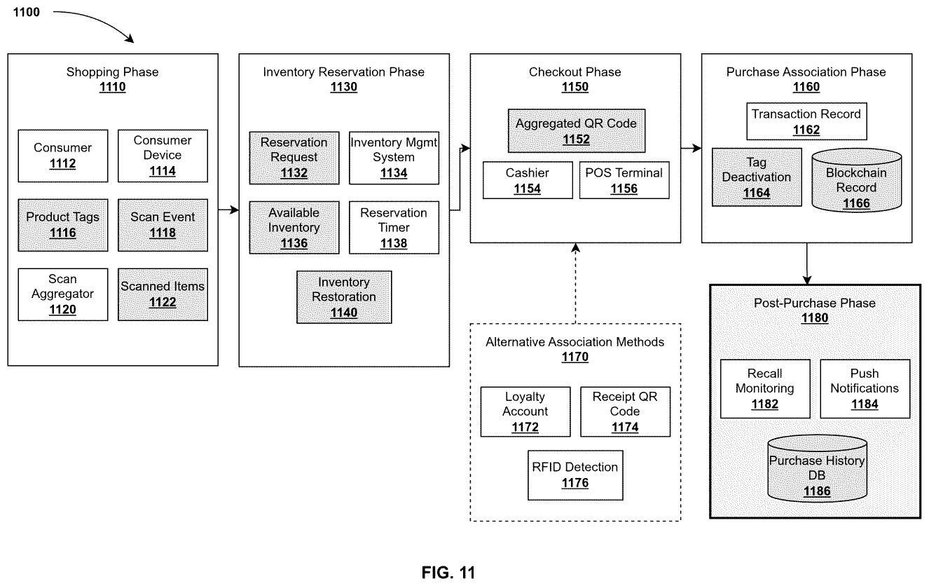

Referring to FIG. 11, a consumer scanning and purchase association 1100 is illustrated in accordance with some embodiments of the present disclosure. The consumer scanning and purchase association 1100 depicts how consumers are immutably associated with purchased products to enable real-time recall notifications and other post-purchase features within the traceability platform. The consumer scanning and purchase association 1100 may address the technical challenge of creating persistent links between consumer identities and specific product lots, enabling the real-time recall notification system 1300 to identify and notify consumers who have purchased products affected by recall events. The consumer scanning and purchase association 1100 may leverage the distributed ledger network 110 to create immutable purchase records that associate consumers with products through blockchain transactions that cannot be modified after recording.

A shopping phase 1110 represents the initial stage of the consumer scanning and purchase association 1100 where consumers interact with products during a shopping session. During the shopping phase 1110, a consumer 1112 uses a consumer device 1114 to scan individual product tags 1116 while shopping at a retail location. The consumer device 1114 may correspond to the consumer devices 130 described with reference to FIG. 1, executing the consumer application 132 that provides scanning functionality through the scanning module 1022 described with reference to FIG. 10. The product tags 1116 may be implemented as ZPTAG authentication tags including QR codes, RFID tags, or NFC chips that encode unique identifiers linking physical products to their blockchain records on the master blockchain 114. The consumer 1112 may scan the product tags 1116 to verify product authenticity, view traceability information through the product information display 1030, and check for allergen warnings through the warning display module 1048 before making purchase decisions.

Each scan of a product tag during the shopping phase 1110 generates a scan event 1118 that is recorded within the consumer application 132. The scan event 1118 may capture the tag identifier decoded by the tag decoder 1024, the timestamp when the scan occurred, and the location where the scan occurred if the location access 1018 has been granted through the permission manager 1014. The scan event 1118 may trigger verification through the verification engine 1026, which communicates with the distributed ledger network 110 to retrieve traceability data and verify product authenticity. The scan event 1118 may be associated with the consumer's authenticated session when the consumer 1112 has registered through the registration module 1012, enabling association between the consumer identity and the scanned products.

A scan aggregator 1120 is included within the consumer scanning and purchase association 1100 and maintains a collection of scan events generated during the shopping session. The scan aggregator 1120 may receive each scan event 1118 generated by the scanning module 1022 and add the scanned product to a running list associated with the current shopping session. The scan aggregator 1120 may maintain a list of scanned items 1122 that represents all products the consumer 1112 has scanned during the shopping session, enabling the consumer to review scanned products and proceed to checkout with a consolidated record of intended purchases. The list of scanned items 1122 may display product names, quantities, prices, and traceability summaries for each scanned product, providing the consumer 1112 with visibility into the products they have selected. The scan aggregator 1120 may enable the consumer 1112 to remove items from the list of scanned items 1122 if the consumer decides not to purchase a previously scanned product, maintaining an accurate record of intended purchases.

With continued reference to FIG. 11, an inventory reservation phase 1130 occurs concurrently with the shopping phase 1110 and manages temporary inventory holds for scanned products. The inventory reservation phase 1130 may address the technical challenge of maintaining accurate inventory information when multiple consumers are simultaneously shopping and scanning products, preventing situations where inventory displays indicate product availability but the products have already been claimed by other shoppers. The inventory reservation phase 1130 may interface with retail inventory systems to temporarily reserve scanned products, ensuring that inventory counts reflect products that are in the process of being purchased.

When a product is scanned during the shopping phase 1110, an inventory reservation request 1132 is sent to an inventory management system 1134 operated by the retailer. The inventory reservation request 1132 may include the product identifier extracted from the scanned tag, the quantity being reserved, and a session identifier that associates the reservation with the consumer's shopping session. The inventory management system 1134 may correspond to the supply chain platforms 156 described with reference to FIG. 1, representing existing retail inventory systems that track product availability at store locations. The inventory management system 1134 may process the inventory reservation request 1132 by temporarily removing the scanned item from available inventory 1136, preventing the reserved item from being displayed as available to other consumers or from being reserved by concurrent shopping sessions.

A reservation timer 1138 tracks the duration of each inventory reservation created during the inventory reservation phase 1130. The reservation timer 1138 may be initialized when the inventory reservation request 1132 is processed by the inventory management system 1134, starting a countdown that limits the duration of the temporary reservation. The reservation timer 1138 may be configured with a timeout period that balances the need to hold inventory for consumers who are actively shopping against the need to release inventory that is not being purchased. The reservation timer 1138 may be reset when the consumer 1112 interacts with the consumer application 132, extending the reservation period for consumers who remain actively engaged in the shopping session. The reservation timer 1138 may provide visibility to the consumer 1112 through the user interface 136, displaying remaining reservation time and alerting the consumer when reservations are approaching expiration.

If the reservation timer 1138 expires without a purchase being completed, an inventory restoration event 1140 returns the reserved item to the available inventory 1136. The inventory restoration event 1140 may be triggered automatically when the reservation timer 1138 reaches zero, releasing the temporary hold on the reserved product. The inventory restoration event 1140 may update the inventory management system 1134 to restore the reserved quantity to the available inventory 1136, making the product available for reservation by other consumers or for display as available inventory. The inventory restoration event 1140 may remove the expired item from the list of scanned items 1122 maintained by the scan aggregator 1120, or may flag the item as no longer reserved while allowing the consumer 1112 to re-scan the product to create a new reservation. The inventory restoration event 1140 may generate a notification to the consumer 1112 indicating that the reservation has expired, prompting the consumer to complete the purchase or re-scan the product if still interested.

A checkout phase 1150 occurs when the consumer 1112 proceeds to purchase the products accumulated in the list of scanned items 1122. The checkout phase 1150 may be initiated when the consumer 1112 navigates to a checkout interface within the consumer application 132 or when the consumer approaches a checkout station at the retail location. The checkout phase 1150 may consolidate the individual scan events 1118 recorded during the shopping phase 1110 into a unified transaction that can be processed by retail point-of-sale systems. The checkout phase 1150 may interface with the coupon manager 1064 described with reference to FIG. 10 to automatically apply available discounts and promotional offers to the transaction.

During the checkout phase 1150, the scan aggregator 1120 generates an aggregated QR code 1152 representing all products in the list of scanned items 1122. The aggregated QR code 1152 may encode identifiers for all scanned products, quantities, and session information that enables the point-of-sale system to retrieve the complete list of items being purchased. The aggregated QR code 1152 may be displayed on the consumer device 1114 screen, enabling the code to be scanned by retail checkout equipment. The aggregated QR code 1152 may include a cryptographic signature generated using the consumer's private key stored in the digital wallet 134, authenticating that the aggregated code was generated by the consumer's device and has not been modified. The aggregated QR code 1152 may consolidate multiple individual product scans into a single scannable code, streamlining the checkout process compared to scanning each product individually at the point of sale.

A cashier 1154 at the retail location scans the aggregated QR code 1152 using a point-of-sale terminal 1156 to process the purchase transaction. The cashier 1154 may use a barcode scanner or camera integrated with the point-of-sale terminal 1156 to capture the aggregated QR code 1152 displayed on the consumer device 1114. The point-of-sale terminal 1156 may decode the aggregated QR code 1152 to retrieve the list of products being purchased, displaying the products and prices for verification by the cashier 1154 and the consumer 1112. The point-of-sale terminal 1156 may verify the cryptographic signature included in the aggregated QR code 1152, confirming that the code was generated by an authenticated consumer device and has not been tampered with. The point-of-sale terminal 1156 may process payment through standard retail payment methods including credit cards, debit cards, mobile payments, or cash, completing the financial transaction for the purchase. In some embodiments, the point-of-sale terminal 1156 may integrate directly with the consumer application 132 through wireless communication protocols, retrieving the list of scanned items 1122 without requiring the consumer to display the aggregated QR code 1152.

As further shown in FIG. 11, a purchase association phase 1160 occurs upon completion of the transaction at the point-of-sale terminal 1156. The purchase association phase 1160 creates the immutable links between the consumer 1112 and the purchased products that enable future recall notifications and purchase history tracking. The purchase association phase 1160 may interface with the distributed ledger network 110 through the blockchain bridges 332 to record purchase associations on the master blockchain 114, creating tamper-evident records that document which consumers purchased which products.

A transaction record 1162 is created during the purchase association phase 1160 and links the consumer 1112 to all purchased products included in the transaction. The transaction record 1162 may include the consumer's wallet address derived from the public key stored in the digital wallet 134, enabling association between the blockchain record and the consumer's account within the platform. The transaction record 1162 may include identifiers for each product tag 1116 that was included in the purchase, enabling identification of the specific product lots and batches acquired by the consumer. The transaction record 1162 may include the transaction timestamp, the retail location identifier, and the transaction amount, providing context for the purchase event. The transaction record 1162 may be signed using the consumer's private key, authenticating that the consumer authorized the purchase association.

A tag deactivation event 1164 deactivates all product tags 1116 associated with the purchase during the purchase association phase 1160. The tag deactivation event 1164 may transition each purchased product tag from the active state 620 to the deactivated state 630 as described with reference to FIG. 6, indicating that the products have been sold and are no longer available for purchase by other consumers. The tag deactivation event 1164 may correspond to the point-of-sale event 628 described with reference to FIG. 6, triggering the second transition 624 that moves tags from active to deactivated states. The tag deactivation event 1164 may update the state storage 464 within the master blockchain 114 to reflect the new tag states, ensuring that subsequent scans of the deactivated tags return appropriate status information indicating that the products have been purchased.

A blockchain purchase record 1166 is created on the master blockchain 114 during the purchase association phase 1160 and immutably associates the consumer 1112 with the purchased products. The blockchain purchase record 1166 may correspond to the sixth blockchain record 576 described with reference to FIG. 5, completing the chain of custody documentation from farm origin through consumer purchase. The blockchain purchase record 1166 may include the transaction record 1162 data, the tag deactivation event 1164 data, and links to the prior blockchain records associated with each purchased product. The blockchain purchase record 1166 may be recorded through the tracking contract 444 within the smart contract execution layer 440, ensuring that the purchase association is validated and stored according to the platform's smart contract logic. The blockchain purchase record 1166 may be stored immutably on the distributed ledger network 110, preventing modification of the purchase association after recording and providing an auditable record of consumer purchases for recall notification and compliance purposes.

Alternative association methods 1170 are available within the consumer scanning and purchase association 1100 for consumers who do not scan items manually during shopping. The alternative association methods 1170 may address scenarios where consumers prefer not to scan products individually, where consumers are using the guest mode 1019 without full application functionality, or where retail environments support automated product detection without manual scanning. The alternative association methods 1170 may provide multiple pathways for creating purchase associations, ensuring that consumers can be linked to purchased products regardless of their preferred shopping workflow.

A loyalty account integration 1172 represents one of the alternative association methods 1170 and automatically associates scanned tags with a consumer's membership account at the point of sale. The loyalty account integration 1172 may leverage existing retail loyalty programs that identify consumers through membership cards, phone numbers, or mobile applications. When the consumer 1112 provides loyalty account credentials during checkout, the point-of-sale terminal 1156 may query the platform to identify any product tags 1116 that were scanned by devices associated with that loyalty account during the shopping session. The loyalty account integration 1172 may create purchase associations for products that were scanned by the consumer even if the consumer did not use the aggregated QR code 1152 during checkout. The loyalty account integration 1172 may also create purchase associations for products that were not scanned by the consumer but were purchased in the same transaction, using the loyalty account as the link between the consumer identity and the purchased products.

A receipt QR code method 1174 represents another of the alternative association methods 1170 and prints an aggregate QR code on the receipt that the consumer can scan post-purchase. The receipt QR code method 1174 may be used when consumers do not scan products during shopping and do not have loyalty accounts linked to the platform. The point-of-sale terminal 1156 may generate a QR code that encodes identifiers for all products included in the transaction and print the QR code on the purchase receipt. The consumer 1112 may scan the receipt QR code using the consumer application 132 after leaving the store, triggering creation of purchase associations for all products included in the transaction. The receipt QR code method 1174 may prompt the consumer to authenticate through the registration module 1012 before creating purchase associations, ensuring that the associations are linked to a verified consumer account. The receipt QR code method 1174 may include a time limit after which the receipt QR code expires, preventing delayed associations that could complicate recall notification timing.

An RFID detection method 1176 represents another of the alternative association methods 1170 and uses passive RFID technology to automatically detect tagged items at checkout. The RFID detection method 1176 may be used in retail environments equipped with RFID readers at checkout stations that can detect product tags 1116 implemented as RFID tags without requiring manual scanning. The RFID detection method 1176 may automatically identify all RFID-tagged products as they pass through the checkout area, creating a list of products being purchased without requiring the consumer 1112 to scan each product individually. The RFID detection method 1176 may associate detected products with the consumer's payment method, using credit card or mobile payment identifiers to link the consumer to the purchased products. The RFID detection method 1176 may interface with the consumer application 132 through wireless communication to associate detected products with the consumer's authenticated account when the consumer device 1114 is present at checkout.

With continued reference to FIG. 11, a post-purchase phase 1180 enables ongoing consumer engagement and recall notification capabilities following completion of the purchase transaction. The post-purchase phase 1180 may leverage the purchase associations created during the purchase association phase 1160 to provide value to consumers through recall monitoring, purchase history access, and targeted communications. The post-purchase phase 1180 may continue indefinitely after purchase, enabling recall notifications to reach consumers even when significant time has elapsed since the purchase event.

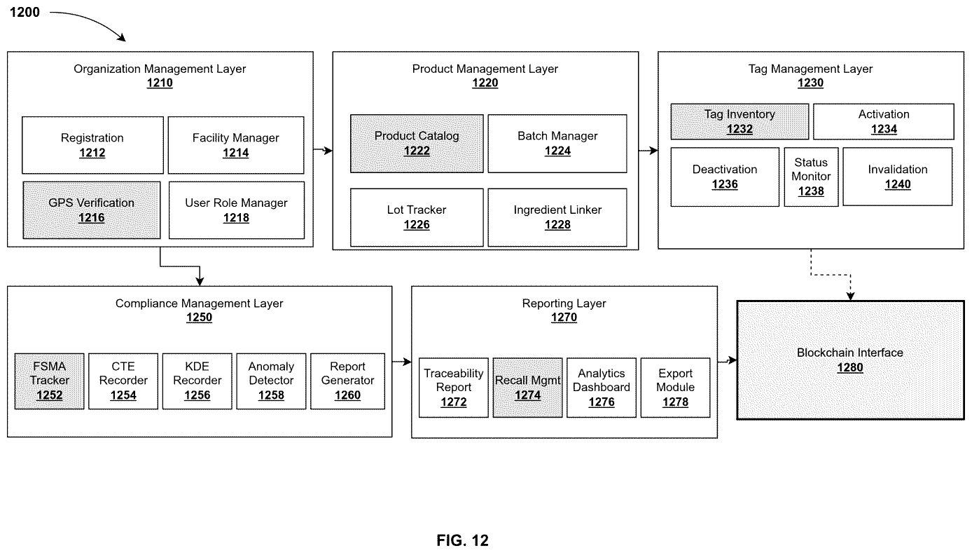

A recall monitoring service 1182 continuously monitors for recall events affecting products that have been purchased by consumers within the platform. The recall monitoring service 1182 may query the distributed ledger network 110 for recall notices submitted by manufacturers through the recall management module 1274 described with reference to FIG. 12. The recall monitoring service 1182 may compare affected lot numbers specified in recall notices against the product identifiers recorded in the blockchain purchase record 1166 for each consumer, identifying consumers who have purchased products from affected lots. The recall monitoring service 1182 may operate continuously in the background, checking for new recall events at regular intervals and immediately processing recall notices when they are submitted to the platform. The recall monitoring service 1182 may correspond to components of the real-time recall notification system 1300, implementing the consumer matching and notification triggering functions that enable targeted recall communications.

A push notification service 1184 delivers targeted recall notifications to consumer devices 1346 when the recall monitoring service 1182 identifies that a consumer has purchased an affected product. The push notification service 1184 may correspond to the push notification service 1344 described with reference to FIG. 13, implementing the notification delivery mechanisms that reach consumers through their mobile devices. The push notification service 1184 may deliver notifications even when the consumer application 132 is not actively running on the consumer device 1114, using platform notification services to alert consumers to recall events. The push notification service 1184 may include recall details in the notification content, presenting the recall reason information 1352, the recommended actions 1354, and the compensation offers 1356 described with reference to FIG. 13. The push notification service 1184 may track notification delivery status, confirming that notifications have been successfully delivered to consumer devices and recording delivery timestamps for audit purposes.

A purchase history database 1186 maintains a record of all consumer purchases for future reference within the post-purchase phase 1180. The purchase history database 1186 may store the transaction record 1162 data, the product identifiers from the blockchain purchase record 1166, and associated traceability information for each purchase made by the consumer 1112. The purchase history database 1186 may enable consumers to view their purchase history through the consumer application 132, displaying previously purchased products with their traceability information and recall status. The purchase history database 1186 may support the recall monitoring service 1182 by providing efficient access to consumer purchase records without requiring queries to the distributed ledger network 110 for each recall check. The purchase history database 1186 may be synchronized with the blockchain purchase record 1166 data stored on the master blockchain 114, ensuring consistency between the local database and the immutable blockchain records. The purchase history database 1186 may retain purchase records for extended periods, enabling recall notifications to reach consumers for products purchased months or years in the past when delayed safety concerns are identified.

Referring to FIG. 12, a stakeholder application architecture 1200 is illustrated in accordance with some embodiments of the present disclosure. The stakeholder application architecture 1200 depicts the functional components of the application used by supply chain participants including farmers, processors, manufacturers, distributors, and retailers to interact with the traceability platform. The stakeholder application architecture 1200 may correspond to the stakeholder application 142 described with reference to FIG. 1, providing a detailed view of the layered architecture that enables stakeholders to record Critical Tracking Events, manage tag inventories, track compliance status, and generate reports for regulatory submission. The stakeholder application architecture 1200 may be implemented as a web application, a mobile application, or a desktop application executing on the stakeholder devices 140, providing access to blockchain-based traceability data through the distributed ledger network 110.

An organization management layer 1210 is included within the stakeholder application architecture 1200 and manages organizational profiles, facility definitions, and user access controls for supply chain participants. The organization management layer 1210 may provide the foundation for stakeholder participation in the traceability platform by establishing organizational identities, defining facility locations, and configuring user permissions that control access to platform functionality. The organization management layer 1210 may support hierarchical relationships where a co-op organization may include multiple farm organizations, and each farm organization may have relationships to other organizations in distinct supply chains. The organization management layer 1210 may enable complex organizational structures that reflect real-world supply chain relationships, including parent-subsidiary relationships, supplier-customer relationships, and cooperative membership relationships.

A registration module 1212 is included within the organization management layer 1210 and enables stakeholders to create organization profiles within the traceability platform. The registration module 1212 may capture organization information including organization name, organization type, contact information, and business identifiers such as tax identification numbers or industry registration codes. The registration module 1212 may validate organization information against external databases to confirm organizational identity and prevent fraudulent registrations. The registration module 1212 may generate cryptographic key pairs that enable organizations to sign transactions and authenticate their activities within the distributed ledger network 110. The registration module 1212 may create wallet addresses derived from public keys that serve as identifiers for organizations within the master blockchain 114, enabling supply chain transactions to be associated with verified organizational identities. The registration module 1212 may support registration of different organization types including farmers, processors, manufacturers, distributors, and retailers, with each organization type having access to functionality appropriate to their role within the supply chain.

A facility manager 1214 is included within the organization management layer 1210 and enables organizations to define and manage multiple facility locations including processing plants, distribution centers, and retail locations. The facility manager 1214 may serve as a universal abstraction that represents different types of facilities depending on the organization type, where farmer facilities are farms, processor facilities are processing plants, and manufacturer facilities are manufacturing plants. The facility manager 1214 may capture facility information including facility name, facility type, physical address, geographic coordinates, and operational characteristics such as storage capacity, processing capabilities, and operating hours. The facility manager 1214 may enable organizations to define multiple facilities under a single organizational profile, supporting stakeholders who operate multiple farms, multiple processing plants, or multiple retail locations. The facility manager 1214 may maintain relationships between facilities and the products, batches, and tags associated with each facility, enabling traceability queries to identify the specific facility where events occurred.

Facilities defined through the facility manager 1214 may contain sub-facility operational units such as production lines, washing stations, packaging lines, or other discrete processing areas. Each sub-facility operational unit may be independently tracked for compliance purposes, enabling granular association of Critical Tracking Events with specific operational areas within a facility. The facility manager 1214 may maintain records of sub-facility operational units and their relationships to parent facilities, enabling traceability records to identify not only the facility where an event occurred but also the specific production line, washing station, or other operational unit involved in the event.

A GPS verification module 1216 is included within the organization management layer 1210 and ensures precise tracking of where scan events occur by verifying facility coordinates. The GPS verification module 1216 may capture GPS coordinates from devices performing scan operations and compare the captured coordinates against the registered coordinates for facilities defined through the facility manager 1214. The GPS verification module 1216 may verify that scan events occur at expected facility locations, detecting potential fraud when scans are performed at locations inconsistent with registered facilities. The GPS verification module 1216 may record verified location data as part of scan event records stored on the master blockchain 114, providing geographic provenance that supports traceability and compliance verification. The GPS verification module 1216 may configure acceptable location tolerances that account for GPS accuracy limitations and facility boundary sizes, allowing scans within a defined radius of registered facility coordinates while flagging scans that occur outside acceptable boundaries. The GPS verification module 1216 may correspond to the geolocation verification 616 described with reference to FIG. 6, implementing the location verification functionality within the stakeholder application context.

A user role manager 1218 is included within the organization management layer 1210 and enables organizations to define user roles and permissions for employees accessing the system. The user role manager 1218 may support role-based access controls that restrict functionality based on user responsibilities within the organization, ensuring that users can access features appropriate to their job functions while preventing unauthorized access to sensitive operations. The user role manager 1218 may define standard roles such as administrator, manager, operator, and viewer, with each role having predefined permissions that control access to organization management, product management, tag management, compliance management, and reporting functions. The user role manager 1218 may enable organizations to create custom roles with specific permission combinations that reflect their organizational structures and operational requirements. The user role manager 1218 may track user activities within the platform, creating audit logs that document which users performed which operations and when, supporting accountability and compliance requirements.

Organizations registered within the platform may include third-party entities that provide certification, testing, or documentation services to supply chain participants. Third-party organizations may include accredited certification entities that issue organic certifications or carbon intensity certifications, laboratory organizations that perform testing and issue certificates of analysis for products such as cannabis or specialty foods, religious certification bodies that issue kosher or halal certifications, and other entities that generate Key Data Elements or compliance documentation required by supply chain participants. Third-party organizations may be granted permissions to record certification results, test outcomes, and attestations on the master blockchain 114 in association with specific products, lots, or batches, enabling supply chain participants to retrieve and verify third-party documentation through the platform.

The platform includes a supply chain pool function that enables organizations to discover and connect with other registered organizations to form supply chain relationships. Organizations may browse a pool of registered organizations to identify potential supply chain partners based on organization type, geographic location, product categories, and certification credentials. Organizations may also invite existing supply chain partners who are not yet registered on the platform to join and establish digital supply chain relationships. An organization may participate in multiple active supply chains simultaneously. For example, a tomato farmer may be a member of supply chains serving multiple distinct manufacturers, with each supply chain maintaining independent traceability records and compliance tracking while sharing the farmer's canonical agricultural operation data from the universal data store 1620.

With continued reference to FIG. 12, a product management layer 1220 is included within the stakeholder application architecture 1200 and manages product definitions, batch creation, lot tracking, and ingredient associations for supply chain participants. The product management layer 1220 may provide the data structures and workflows that enable stakeholders to define the products they handle, organize products into batches and lots, and maintain traceability links between finished products and source ingredients. The product management layer 1220 may interface with the tracking dApp 414 and the tracking contract 444 to record product-related data on the distributed ledger network 110, ensuring that product definitions and associations are stored immutably for traceability purposes.

A product catalog 1222 is included within the product management layer 1220 and stores product definitions including category, FSMA compliance status, and ingredient information. The product catalog 1222 may maintain a registry of all products handled by the organization, with each product definition including product name, product description, product category, unit of measure, and regulatory classifications. The product catalog 1222 may indicate whether each product is on the Food Traceability List and therefore subject to enhanced FSMA traceability requirements, enabling the platform to apply appropriate compliance rules based on product classification. The product catalog 1222 may store ingredient lists for manufactured products, identifying the component ingredients that are combined during production and enabling allergen identification and dietary preference matching through the personalization layer 1040 described with reference to FIG. 10. The product catalog 1222 may store product images, nutritional information, and certification credentials that are displayed to consumers through the product information display 1030 when products are scanned.

A batch manager 1224 is included within the product management layer 1220 and enables stakeholders to create and manage batches consisting of aggregated lots. The batch manager 1224 may support the aggregation workflows described with reference to the aggregation event 544 in FIG. 5 and the aggregation point 740 in FIG. 7, enabling manufacturers to combine ingredients from multiple sources into unified product batches. The batch manager 1224 may assign batch identifiers that uniquely identify each production batch, enabling traceability queries to identify all products produced within a specific batch. The batch manager 1224 may capture batch attributes including production date, production facility, production line, and quality control results that characterize the batch. The batch manager 1224 may maintain associations between batches and the source lots that contributed ingredients to each batch, supporting the hierarchical linking structure 762 that enables traceability through product transformation.

A lot tracker 1226 is included within the product management layer 1220 and tracks individual lots and their association with batches. The lot tracker 1226 may assign lot codes that uniquely identify each lot of product received, produced, or shipped by the organization, enabling granular traceability at the lot level. The lot tracker 1226 may capture lot attributes including lot quantity, lot origin, receiving date, and quality assessments that characterize each lot. The lot tracker 1226 may track lot status throughout the supply chain, indicating whether lots are in inventory, in transit, sold, or recalled. The lot tracker 1226 may maintain associations between lots and the batches into which lots are aggregated, enabling forward tracing from source lots to finished product batches and backward tracing from finished product batches to source lots. The lot tracker 1226 may interface with the inventory management system 1134 described with reference to FIG. 11 to maintain accurate inventory counts at the lot level.

An ingredient linker 1228 is included within the product management layer 1220 and associates batches with source ingredients and their traceability records. The ingredient linker 1228 may create the links between transformed products and source ingredients that enable end-to-end traceability through manufacturing processes where multiple ingredient streams are combined. The ingredient linker 1228 may capture the specific lots of each ingredient used in a batch, recording lot codes, quantities, and supplier information for each ingredient contribution. The ingredient linker 1228 may retrieve traceability records for source ingredients from the distributed ledger network 110, enabling manufacturers to verify the origin and compliance status of ingredients before incorporating them into finished products. The ingredient linker 1228 may create the aggregation record 744 described with reference to FIG. 7, recording the many-to-one relationships between source ingredients and transformed products on the master blockchain 114.

As further shown in FIG. 12, a tag management layer 1230 is included within the stakeholder application architecture 1200 and manages the lifecycle of ZPTAG authentication tags assigned to the organization. The tag management layer 1230 may provide the workflows and controls that enable stakeholders to track tag inventories, activate tags and associate them with products, deactivate tags upon custody transfers, monitor tag status, and invalidate compromised tags. The tag management layer 1230 may interface with the tracking contract 444 to record tag lifecycle events on the distributed ledger network 110, ensuring that tag states are maintained consistently across the platform.

A tag inventory 1232 is included within the tag management layer 1230 and tracks all tags assigned to the organization. The tag inventory 1232 may maintain a registry of all ZPTAG authentication tags that have been allocated to the organization, including tags in the inactive state 610 awaiting activation, tags in the active state 620 currently tracking products, and tags in the deactivated state 630 that have completed their tracking lifecycle. The tag inventory 1232 may display tag counts by state, enabling stakeholders to monitor their available tag supply and plan tag orders based on anticipated needs. The tag inventory 1232 may track tag batches that group tags ordered or manufactured together, enabling bulk operations on tag batches such as activation, assignment, or invalidation. The tag inventory 1232 may record tag acquisition dates, tag costs, and tag assignments to specific facilities, supporting inventory management and cost allocation.

A tag activation module 1234 is included within the tag management layer 1230 and enables stakeholders to activate tags and associate them with products or batches. The tag activation module 1234 may implement the first transition 612 described with reference to FIG. 6, transitioning tags from the inactive state 610 to the active state 620 when tags are assigned to products. The tag activation module 1234 may capture the product or batch identifier being associated with the tag, the facility where activation occurs, and the user performing the activation. The tag activation module 1234 may invoke the GPS verification module 1216 to verify that activation occurs at an expected facility location, recording verified location data as part of the blockchain activation record 622. The tag activation module 1234 may validate that the tag being activated is in the inactive state 610 and belongs to the organization's tag inventory 1232, preventing activation of tags that have already been activated or that belong to other organizations.

A tag deactivation module 1236 is included within the tag management layer 1230 and enables stakeholders to deactivate tags upon chain-of-custody handoff. The tag deactivation module 1236 may implement the second transition 624 described with reference to FIG. 6, transitioning tags from the active state 620 to the deactivated state 630 when products are transferred to downstream supply chain participants. The tag deactivation module 1236 may be invoked when stakeholders receive products from upstream suppliers, scanning incoming tags to retrieve traceability data and triggering deactivation of the incoming tags as part of the chain-of-custody handoff 626. The tag deactivation module 1236 may capture the receiving facility, the receiving timestamp, and the user performing the deactivation, recording this information as part of the blockchain deactivation record 632. The tag deactivation module 1236 may create links between deactivated incoming tags and newly activated outgoing tags, maintaining the hierarchical linking structure that enables end-to-end traceability through custody transfers.

A tag status monitor 1238 is included within the tag management layer 1230 and displays real-time status of all active and decommissioned tags. The tag status monitor 1238 may query the state storage 464 within the master blockchain 114 to retrieve current tag states, displaying the status of each tag in the organization's tag inventory 1232. The tag status monitor 1238 may display tag status indicators showing whether tags are inactive, active, deactivated, reactivated, or invalid, enabling stakeholders to quickly assess the state of their tag population. The tag status monitor 1238 may display tag location information based on the most recent scan events, showing where active tags are currently located within the supply chain. The tag status monitor 1238 may display tag history showing the sequence of state transitions and scan events for each tag, enabling stakeholders to review the complete lifecycle of individual tags. The tag status monitor 1238 may generate alerts when tag status changes occur, notifying stakeholders when tags are activated, deactivated, or invalidated.

A tag invalidation module 1240 is included within the tag management layer 1230 and enables immediate invalidation of lost or stolen tag batches to prevent fraudulent use. The tag invalidation module 1240 may transition tags to the invalid state 650 described with reference to FIG. 6, permanently removing tags from legitimate use within the platform. The tag invalidation module 1240 may support bulk invalidation of tag batches, enabling stakeholders to invalidate all tags within a batch when the batch is reported as lost, stolen, or compromised. The tag invalidation module 1240 may require authorization from users with appropriate permissions defined through the user role manager 1218, preventing unauthorized invalidation of tags. The tag invalidation module 1240 may record the reason for invalidation, the user authorizing invalidation, and the invalidation timestamp on the master blockchain 114, creating an auditable record of why tags were removed from legitimate use. The tag invalidation module 1240 may trigger alerts to downstream supply chain participants when tags are invalidated, enabling detection of fraudulent products bearing invalidated tags.

With continued reference to FIG. 12, a compliance management layer 1250 is included within the stakeholder application architecture 1200 and manages regulatory compliance requirements including FSMA traceability rules. The compliance management layer 1250 may provide the workflows and controls that enable stakeholders to record Critical Tracking Events, capture Key Data Elements, monitor compliance status, and generate reports for regulatory submission. The compliance management layer 1250 may interface with the compliance dApp 412 and the compliance contract 442 to validate compliance data and record compliance events on the distributed ledger network 110.

An FSMA compliance tracker 1252 is included within the compliance management layer 1250 and monitors compliance with Food Safety Modernization Act requirements. The FSMA compliance tracker 1252 may track compliance status for products on the Food Traceability List, monitoring whether required Critical Tracking Events have been recorded and whether required Key Data Elements have been captured at each event. The FSMA compliance tracker 1252 may display compliance dashboards showing overall compliance status across the organization's products, facilities, and supply chain relationships. The FSMA compliance tracker 1252 may identify compliance gaps where required data is missing or incomplete, enabling stakeholders to address deficiencies before regulatory inspections or audits. The FSMA compliance tracker 1252 may track compliance deadlines and regulatory requirements, alerting stakeholders to upcoming compliance obligations and changes in regulatory requirements.

A CTE recorder 1254 is included within the compliance management layer 1250 and enables stakeholders to record Critical Tracking Events at custody transfers and transformation events. The CTE recorder 1254 may provide interfaces for recording the Critical Tracking Events defined under FSMA, including growing events, receiving events, transformation events, and shipping events. The CTE recorder 1254 may capture event type, event timestamp, event location, and party identifiers for each Critical Tracking Event, ensuring that required data elements are recorded. The CTE recorder 1254 may validate that recorded events include all required data elements before submission, preventing incomplete event records from being stored on the distributed ledger network 110. The CTE recorder 1254 may interface with the tracking contract 444 to record Critical Tracking Events on the master blockchain 114, creating immutable records that support regulatory compliance and traceability verification.

A KDE recorder 1256 is included within the compliance management layer 1250 and enables stakeholders to record Key Data Elements associated with Critical Tracking Events. The KDE recorder 1256 may capture the specific data points required at each Critical Tracking Event, including lot codes, product descriptions, quantities, dates, times, locations, and identifiers of parties involved in the event. The KDE recorder 1256 may provide data entry interfaces that guide users through the required Key Data Elements for each event type, ensuring that all required data is captured. The KDE recorder 1256 may validate data formats and values, checking that lot codes conform to expected patterns, that quantities are within reasonable ranges, and that dates and times are properly formatted. The KDE recorder 1256 may support data import from external systems through the API integration layer 150, enabling automated capture of Key Data Elements from existing stakeholder systems without manual re-entry.

An anomaly detector 1258 is included within the compliance management layer 1250 and generates automatic alerts if compliance documentation is incomplete. The anomaly detector 1258 may monitor recorded Critical Tracking Events and Key Data Elements, identifying situations where required data is missing, where data values are inconsistent, or where expected events have not been recorded. The anomaly detector 1258 may compare recorded data against compliance rules retrieved from the regulatory database connector 454, ensuring that validation reflects current regulatory requirements. The anomaly detector 1258 may generate alerts when anomalies are detected, notifying stakeholders through the stakeholder application 142 and enabling prompt remediation of compliance gaps. The anomaly detector 1258 may track anomaly resolution, recording when identified issues have been addressed and maintaining audit trails of compliance remediation activities.

A compliance report generator 1260 is included within the compliance management layer 1250 and generates compliance reports for regulatory submission. The compliance report generator 1260 may compile Critical Tracking Events and Key Data Elements into report formats specified by regulatory requirements, enabling stakeholders to demonstrate compliance during inspections or audits. The compliance report generator 1260 may generate reports for specific products, lots, batches, or time periods, enabling targeted reporting based on regulatory inquiries. The compliance report generator 1260 may generate reports in electronically sortable formats as required by FDA regulations, enabling regulators to efficiently analyze submitted data. The compliance report generator 1260 may support scheduled report generation, automatically producing compliance reports at defined intervals for management review or regulatory submission.

As further shown in FIG. 12, a reporting layer 1270 is included within the stakeholder application architecture 1200 and provides reporting and analytics capabilities for supply chain operations. The reporting layer 1270 may enable stakeholders to generate traceability reports, manage recall operations, analyze operational metrics, and export data for external use. The reporting layer 1270 may retrieve data from the distributed ledger network 110 and from local databases maintained by the stakeholder application 142, combining blockchain-verified data with operational data for comprehensive reporting.

A traceability report generator 1272 is included within the reporting layer 1270 and generates end-to-end traceability reports for products handled by the organization. The traceability report generator 1272 may compile the complete chain of custody for specified products, retrieving blockchain records from the farm stage 510 through the consumer stage 570 as described with reference to FIG. 5. The traceability report generator 1272 may generate forward trace reports that identify all downstream recipients of products from a specified source lot, supporting recall investigations that need to identify affected products and consumers. The traceability report generator 1272 may generate backward trace reports that identify all upstream sources that contributed to a specified product, supporting contamination investigations that need to identify the origin of safety concerns. The traceability report generator 1272 may include the hierarchical linking structure 762 in reports for transformed products, showing all source ingredients and their respective origins.

The recall management module 1274 is included within the reporting layer 1270 and enables stakeholders to initiate and manage product recalls. The recall management module 1274 may provide workflows for creating recall notices that specify affected lot numbers, recall reasons, and recommended consumer actions. The recall management module 1274 may interface with the real-time recall notification system 1300 to distribute recall notifications to affected consumers and retailers. The recall management module 1274 may track recall progress, monitoring consumer responses, product returns, and recall completion status. The recall management module 1274 may generate recall reports for regulatory submission, documenting recall activities and outcomes as required by regulatory agencies.

An analytics dashboard 1276 is included within the reporting layer 1270 and displays operational metrics and trends for supply chain operations. The analytics dashboard 1276 may display key performance indicators including product volumes, compliance rates, tag utilization, and supply chain cycle times. The analytics dashboard 1276 may display trend charts showing how metrics change over time, enabling stakeholders to identify patterns and assess the impact of operational changes. The analytics dashboard 1276 may display comparative metrics showing performance across facilities, products, or supply chain partners, enabling benchmarking and identification of improvement opportunities. The analytics dashboard 1276 may support drill-down navigation that enables stakeholders to explore underlying data behind summary metrics.

An export module 1278 is included within the reporting layer 1270 and enables export of data in electronically sortable formats for regulatory submission. The export module 1278 may generate data exports in formats specified by FDA regulations, enabling stakeholders to respond to regulatory requests for traceability data within required timeframes. The export module 1278 may support export of Critical Tracking Events, Key Data Elements, and traceability records in spreadsheet formats, database formats, and structured data formats such as XML and JSON. The export module 1278 may enable selective export of data based on date ranges, products, lots, facilities, or other criteria, enabling stakeholders to provide targeted data in response to specific regulatory inquiries. The export module 1278 may include data validation that ensures exported data is complete and properly formatted before submission.

A blockchain interface 1280 is included within the stakeholder application architecture 1200 and connects the stakeholder application to the distributed ledger network 110 for immutable storage of supply chain data. The blockchain interface 1280 may correspond to the blockchain bridges 332 described with reference to FIG. 3, providing the communication mechanisms that enable the stakeholder application 142 to submit transactions to and retrieve data from the master blockchain 114. The blockchain interface 1280 may manage transaction signing using cryptographic keys associated with the organization, ensuring that transactions are properly authenticated before submission. The blockchain interface 1280 may monitor transaction confirmation status, tracking submitted transactions until they are confirmed by the distributed ledger network 110 and recorded on the master blockchain 114. The blockchain interface 1280 may cache frequently accessed blockchain data locally, reducing query latency and network traffic while maintaining consistency with the authoritative blockchain state. The blockchain interface 1280 may handle network connectivity issues gracefully, queuing transactions for submission when connectivity is restored and providing offline access to cached data when the distributed ledger network 110 is temporarily unavailable.

Referring to FIG. 13, the real-time recall notification system 1300 is illustrated in accordance with some embodiments of the present disclosure. The real-time recall notification system 1300 provides consumers with immediate alerts if a purchased product is subject to recall, eliminating the need for manual lot number verification by consumers who would otherwise need to compare lot codes printed on product packaging against published recall notices. The real-time recall notification system 1300 may leverage the purchase associations created through the consumer scanning and purchase association flow 1100 described with reference to FIG. 11, using the blockchain purchase record 1166 to identify consumers who have purchased products from specific lots when recall events occur. The real-time recall notification system 1300 may reduce waste by preventing unnecessary recalls of unaffected products and may improve consumer safety by ensuring rapid notification of affected consumers through targeted communications that reach only those consumers who have purchased products from recalled lots.

A recall initiation phase 1310 represents the initial stage of the real-time recall notification system 1300 where a safety concern is identified and a recall is formally initiated. During the recall initiation phase 1310, a manufacturer 1312 identifies a safety concern affecting one or more product lots, such as contamination, mislabeling, undeclared allergens, or other conditions that warrant removal of products from commerce and notification of consumers who have purchased affected products. The manufacturer 1312 may correspond to a manufacturer organization registered within the platform through the registration module 1212 described with reference to FIG. 12, operating the manufacturer node 818 described with reference to FIG. 8A or maintaining records on the manufacturer chain 838 described with reference to FIG. 8B. The manufacturer 1312 may identify safety concerns through internal quality control processes, consumer complaints, regulatory notifications, or supplier alerts that indicate potential problems with distributed products.

The manufacturer 1312 submits a recall request 1314 to the platform to initiate the recall process within the real-time recall notification system 1300. The recall request 1314 may be submitted through the recall management module 1274 described with reference to FIG. 12, providing a structured interface for entering recall information and triggering the recall notification workflow. The recall request 1314 may include authentication credentials that verify the manufacturer 1312 is authorized to initiate recalls for the affected products, preventing unauthorized parties from submitting fraudulent recall notices. The recall request 1314 may be recorded on the master blockchain 114 through the tracking contract 444, creating an immutable record of the recall initiation that supports regulatory compliance and audit requirements.

The recall request 1314 specifies affected lot numbers 1316 that identify the specific product lots subject to the recall. The affected lot numbers 1316 may correspond to lot codes assigned through the lot tracker 1226 described with reference to FIG. 12, enabling precise identification of products that should be recalled while excluding products from unaffected lots. The affected lot numbers 1316 may include multiple lot codes when the safety concern affects products from multiple production batches, enabling comprehensive recall coverage across all affected production runs. The affected lot numbers 1316 may be validated against lot records stored on the distributed ledger network 110, confirming that the specified lots exist and are associated with products manufactured by the manufacturer 1312.

The recall request 1314 also includes recall details 1318 that describe the nature of the safety concern and provide guidance for consumers and retailers responding to the recall. The recall details 1318 may include a description of the safety concern, such as potential contamination with pathogens, presence of undeclared allergens, or physical hazards that could cause injury. The recall details 1318 may include the severity classification of the recall, indicating whether the concern poses a risk of serious adverse health consequences, a remote probability of adverse health consequences, or a situation where use of the product would not cause adverse health consequences. The recall details 1318 may include recommended actions for consumers who have purchased affected products, such as disposal instructions, return procedures, or guidance for seeking medical attention if symptoms occur. The recall details 1318 may include contact information for the manufacturer 1312, enabling consumers to obtain additional information or report adverse events.

With continued reference to FIG. 13, a lot identification phase 1320 processes the recall request 1314 to identify all products associated with the affected lot numbers 1316. The lot identification phase 1320 may query the distributed ledger network 110 to retrieve product records that match the specified lot codes, building a comprehensive list of affected products that enables targeted notification of consumers and retailers. The lot identification phase 1320 may leverage the traceability records stored on the master blockchain 114, including the first blockchain record 520, the second blockchain record 538, the third blockchain record 548, the fourth blockchain record 558, and the fifth blockchain record 568 that document the product journey from farm origin through retail placement.

A lot lookup service 1322 is included within the lot identification phase 1320 and queries a blockchain 1324 to identify all products associated with the affected lot numbers 1316. The lot lookup service 1322 may correspond to the lot lookup 1322 referenced in the real-time recall notification system 1300, implementing the query logic that retrieves product records from the distributed ledger. The blockchain 1324 may correspond to the master blockchain 114 described with reference to FIG. 1 and FIG. 2, serving as the authoritative repository for product traceability records that enable lot-level identification. The lot lookup service 1322 may query the state storage 464 within the blockchain 1324 to retrieve current product states and associations, identifying all product tags that have been associated with the affected lot numbers 1316 throughout the supply chain.

The lot lookup service 1322 generates a product list 1326 containing all affected product identifiers that correspond to the affected lot numbers 1316. The product list 1326 may include tag identifiers for all ZPTAG authentication tags that have been associated with products from the affected lots, enabling identification of specific product units that should be recalled. The product list 1326 may include product identifiers at multiple levels of the supply chain, including initial tags 518 assigned at the farm stage 510, processor tags 534 assigned at the processing stage 530, manufacturer tags 546 assigned at the manufacturing stage 540, and retail tags 564 assigned at the retail stage 560. The product list 1326 may include products that have been transformed through the aggregation point 740 described with reference to FIG. 7, identifying transformed products that incorporated ingredients from affected source lots through the hierarchical linking structure 762. The product list 1326 may be stored temporarily within the real-time recall notification system 1300 for use in subsequent phases of the recall process.

A consumer matching phase 1330 identifies consumers who have purchased products from the product list 1326, enabling targeted notification of affected consumers while excluding consumers who have not purchased affected products. The consumer matching phase 1330 may leverage the purchase associations created through the purchase association phase 1160 described with reference to FIG. 11, using the blockchain purchase record 1166 to identify consumers linked to specific product tags. The consumer matching phase 1330 may address the technical challenge of efficiently matching potentially large numbers of affected products against potentially large numbers of consumer purchase records, implementing query optimization techniques that enable rapid identification of affected consumers.

A purchase history database 1332 is included within the consumer matching phase 1330 and stores records of consumer purchases linked through tag deactivation events. The purchase history database 1332 may correspond to the purchase history database 1186 described with reference to FIG. 11, maintaining a queryable index of consumer purchase associations that enables efficient matching against affected product lists. The purchase history database 1332 may store the transaction record 1162 data, the product identifiers from the blockchain purchase record 1166, and consumer identifiers that enable notification delivery. The purchase history database 1332 may be synchronized with the blockchain purchase record 1166 data stored on the master blockchain 114, ensuring consistency between the local database and the immutable blockchain records while providing query performance that supports real-time recall processing.

A consumer matcher 1334 is included within the consumer matching phase 1330 and identifies consumers 1336 who have purchased products from the product list 1326. The consumer matcher 1334 may query the purchase history database 1332 using the product identifiers from the product list 1326, retrieving consumer records for all consumers who have purchase associations with affected products. The consumers 1336 identified by the consumer matcher 1334 may include consumers who purchased products directly from retail locations, consumers who received products as gifts and subsequently registered the products through the consumer application 132, and consumers who acquired products through secondary market channels and registered ownership through the third-party reactivation 642 described with reference to FIG. 6. The consumer matcher 1334 may retrieve contact information for the consumers 1336, including device identifiers that enable push notification delivery and account identifiers that enable in-app notification display.

An unaffected consumer filter 1338 is included within the consumer matching phase 1330 and excludes consumers who have not purchased affected products, preventing unnecessary notifications and reducing waste. The unaffected consumer filter 1338 may compare the consumers 1336 identified by the consumer matcher 1334 against the complete consumer population within the platform, ensuring that only consumers with verified purchase associations to affected products receive recall notifications. The unaffected consumer filter 1338 may prevent notification of consumers who purchased products from the same manufacturer 1312 but from different lots that are not subject to the recall, avoiding consumer confusion and unnecessary product disposal. The unaffected consumer filter 1338 may reduce the volume of recall notifications sent by the platform, conserving notification resources and maintaining consumer trust by ensuring that notifications are relevant and actionable. The unaffected consumer filter 1338 may support waste reduction by preventing consumers from discarding products that are not affected by the recall, as consumers who receive recall notifications for products they did not purchase may incorrectly assume that similar products in their possession are affected.

As further shown in FIG. 13, a notification delivery phase 1340 delivers targeted notifications to the consumers 1336 identified during the consumer matching phase 1330. The notification delivery phase 1340 may utilize multiple notification channels to ensure that recall information reaches affected consumers through their preferred communication methods. The notification delivery phase 1340 may prioritize notification speed to minimize the time between recall initiation and consumer awareness, reducing the risk that consumers will consume or use affected products before receiving recall information.

A notification generator 1342 is included within the notification delivery phase 1340 and creates personalized recall notifications for each of the consumers 1336 identified as having purchased affected products. The notification generator 1342 may generate notification content that includes specific product information for each affected consumer, identifying the particular products purchased by that consumer that are subject to the recall. The notification generator 1342 may personalize notification content based on consumer preferences stored in the personalization layer 1040 described with reference to FIG. 10, adapting language, format, and detail level to consumer settings. The notification generator 1342 may generate notifications in multiple formats optimized for different delivery channels, including concise push notifications suitable for mobile device lock screens and detailed in-app notifications that provide comprehensive recall information.

A push notification service 1344 is included within the notification delivery phase 1340 and delivers notifications to consumer devices 1346 through platform notification services. The push notification service 1344 may correspond to the push notification service 1184 described with reference to FIG. 11, implementing the notification delivery mechanisms that reach consumers through their mobile devices. The consumer devices 1346 may correspond to the consumer devices 130 described with reference to FIG. 1, executing the consumer application 132 that receives and displays recall notifications. The push notification service 1344 may deliver notifications even when the consumer application 132 is not actively running on the consumer devices 1346, using platform notification services provided by mobile operating systems to alert consumers to recall events. The push notification service 1344 may track notification delivery status, confirming that notifications have been successfully delivered to the consumer devices 1346 and recording delivery timestamps for audit purposes.

An in-app alert service 1348 is included within the notification delivery phase 1340 and displays recall information within the consumer application 132 when consumers access the application. The in-app alert service 1348 may display prominent alerts when consumers open the consumer application 132, ensuring that recall information is visible even if push notifications were not received or were dismissed without reading. The in-app alert service 1348 may display recall information in the recall notification module 1070 described with reference to FIG. 10, providing a dedicated interface for viewing recall details and taking recommended actions. The in-app alert service 1348 may persist recall alerts until consumers acknowledge receipt, ensuring that consumers are aware of recalls affecting their purchased products. The in-app alert service 1348 may enable consumers to view detailed recall information, access recommended actions, and initiate return or refund processes directly within the consumer application 132.

A notification content module 1350 is included within the notification delivery phase 1340 and structures the content included in recall notifications delivered to the consumers 1336. The notification content module 1350 may format the recall details 1318 provided by the manufacturer 1312 into consumer-friendly presentations that clearly communicate the nature of the concern and the actions consumers should take. The notification content module 1350 may include recall reason information 1352 that explains why the recall was initiated, describing the safety concern in terms that consumers can understand without technical or regulatory jargon. The recall reason information 1352 may include information about potential health effects, enabling consumers to assess the urgency of the recall and to seek medical attention if they have already consumed affected products and are experiencing symptoms.

The notification content module 1350 may include recommended actions 1354 that provide guidance for consumers responding to the recall. The recommended actions 1354 may include disposal instructions for products that should not be consumed or used, specifying safe disposal methods that prevent accidental consumption by other household members or pets. The recommended actions 1354 may include return instructions for products that should be returned to the point of purchase, specifying return procedures and documentation requirements. The recommended actions 1354 may include guidance for consumers who have already consumed affected products, such as monitoring for symptoms, contacting healthcare providers, or reporting adverse events to regulatory agencies. The recommended actions 1354 may include contact information for the manufacturer 1312 and for regulatory agencies, enabling consumers to obtain additional information or report concerns.

The notification content module 1350 may include compensation offers 1356 that describe refunds, replacements, or other compensation available to consumers who have purchased affected products. The compensation offers 1356 may include refund information specifying how consumers can obtain refunds for affected products, including refund amounts, refund methods, and documentation requirements. The compensation offers 1356 may include discount coupons or promotional offers provided by the manufacturer 1312 as goodwill gestures to affected consumers, encouraging continued brand loyalty despite the recall event. The compensation offers 1356 may include replacement product offers for consumers who wish to receive replacement products from unaffected lots. The compensation offers 1356 may be redeemable through the coupon manager 1064 described with reference to FIG. 10, enabling automated application of compensation offers during future purchases.

With continued reference to FIG. 13, a retailer notification phase 1360 notifies retailers who have received affected products, enabling removal of affected products from retail shelves and updating of inventory systems. The retailer notification phase 1360 may operate in parallel with the notification delivery phase 1340, ensuring that retailers receive recall information promptly and can take action to prevent additional sales of affected products. The retailer notification phase 1360 may leverage the traceability records stored on the distributed ledger network 110 to identify retailers who received products from affected lots through the distribution stage 550 and the retail stage 560 described with reference to FIG. 5.

A retailer matcher 1362 is included within the retailer notification phase 1360 and identifies retailers 1364 who have received products from the affected lot numbers 1316. The retailer matcher 1362 may query the blockchain 1324 to retrieve receiving events recorded at the retail stage 560, identifying retail locations that received shipments containing products from affected lots. The retailers 1364 identified by the retailer matcher 1362 may include retail organizations registered within the platform through the registration module 1212, operating the retailer node 822 described with reference to FIG. 8A or maintaining records on the retailer chain 842 described with reference to FIG. 8B. The retailer matcher 1362 may retrieve contact information for the retailers 1364, including notification endpoints that enable delivery of recall alerts to retail management systems.

A shelf removal alert 1366 is included within the retailer notification phase 1360 and notifies the retailers 1364 to remove affected products from retail shelves. The shelf removal alert 1366 may be delivered through the stakeholder application 142 described with reference to FIG. 1, displaying prominent alerts within the stakeholder interfaces 354 that notify retail staff of the recall. The shelf removal alert 1366 may include specific product identifiers and lot codes that enable retail staff to identify affected products on shelves and in storage areas. The shelf removal alert 1366 may include instructions for handling removed products, specifying whether products should be quarantined for return to the manufacturer 1312, disposed of at the retail location, or held pending further instructions. The shelf removal alert 1366 may include urgency indicators that communicate the severity of the recall and the timeframe within which products should be removed from sale.

An inventory update service 1368 is included within the retailer notification phase 1360 and updates inventory systems to reflect recalled products. The inventory update service 1368 may interface with the inventory management system 1134 described with reference to FIG. 11, updating inventory records to indicate that affected products are no longer available for sale. The inventory update service 1368 may remove affected products from the available inventory 1136, preventing additional sales of recalled products through point-of-sale systems. The inventory update service 1368 may update the inventory data 566 recorded at the retail stage 560, reflecting the removal of recalled products from retail inventory. The inventory update service 1368 may generate inventory adjustment records that document the quantity of recalled products removed from inventory, supporting financial reconciliation and regulatory reporting.

A recall tracking phase 1370 monitors the progress of the recall and generates reports for regulatory submission. The recall tracking phase 1370 may track consumer responses to recall notifications, product returns, and overall recall completion status, providing visibility into recall effectiveness and enabling the manufacturer 1312 to assess whether additional actions are needed. The recall tracking phase 1370 may support regulatory compliance by generating reports that document recall activities and outcomes as required by regulatory agencies.

A response tracker 1372 is included within the recall tracking phase 1370 and monitors consumer responses to recall notifications delivered during the notification delivery phase 1340. The response tracker 1372 may track notification acknowledgments from the consumers 1336, recording when consumers view recall notifications and indicating that consumers are aware of the recall. The response tracker 1372 may track consumer actions taken in response to recall notifications, such as initiating return requests, redeeming compensation offers 1356, or confirming product disposal. The response tracker 1372 may identify consumers who have not responded to recall notifications, enabling follow-up communications to ensure that all affected consumers are aware of the recall. The response tracker 1372 may generate response rate metrics that indicate the percentage of affected consumers who have acknowledged recall notifications and taken recommended actions.

A return tracker 1374 is included within the recall tracking phase 1370 and tracks products returned by consumers and retailers in response to the recall. The return tracker 1374 may record return events when affected products are returned to retail locations or directly to the manufacturer 1312, capturing return quantities, return dates, and return locations. The return tracker 1374 may update the tag lifecycle states 600 for returned products, transitioning tags to appropriate states that reflect the return and preventing returned products from re-entering commerce. The return tracker 1374 may calculate return rates that indicate the percentage of distributed products that have been recovered through the recall process, providing metrics for assessing recall effectiveness.

A recall completion monitor 1376 is included within the recall tracking phase 1370 and determines when the recall has been substantially completed. The recall completion monitor 1376 may evaluate recall progress metrics including notification delivery rates, consumer response rates, and product return rates, comparing actual metrics against completion thresholds defined by the manufacturer 1312 or regulatory requirements. The recall completion monitor 1376 may identify when recall activities have reached a steady state where additional notifications and recovery efforts are unlikely to yield significant additional returns, indicating that the recall may be considered substantially complete. The recall completion monitor 1376 may generate completion notifications to the manufacturer 1312 and to regulatory agencies, documenting that recall objectives have been achieved.

A recall report generator 1378 is included within the recall tracking phase 1370 and generates reports for regulatory submission documenting recall activities and outcomes. The recall report generator 1378 may compile recall data including the recall request 1314, the affected lot numbers 1316, the product list 1326, the consumers 1336 notified, the retailers 1364 notified, consumer response metrics, and product return metrics into comprehensive reports suitable for regulatory review. The recall report generator 1378 may generate reports in formats specified by regulatory requirements, enabling the manufacturer 1312 to demonstrate compliance with recall notification and tracking obligations. The recall report generator 1378 may generate interim reports during ongoing recalls and final reports upon recall completion, providing regulatory agencies with visibility into recall progress and outcomes. The recall report generator 1378 may store generated reports on the distributed ledger network 110, creating immutable records of recall documentation that support audit and compliance verification.

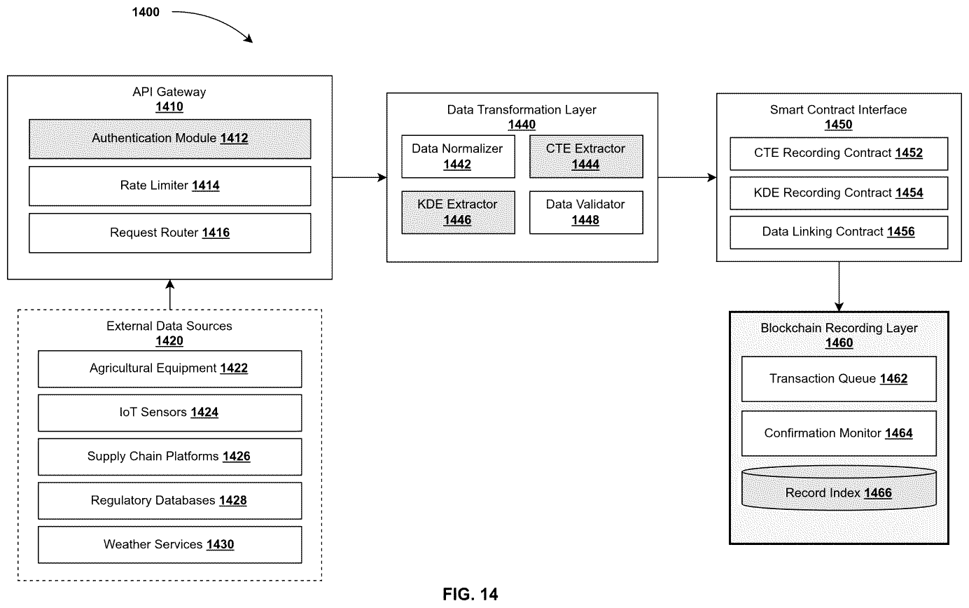

Referring to FIG. 14, an external data source integration via API 1400 is illustrated in accordance with some embodiments of the present disclosure. The external data source integration via API 1400 enables automated recording of Critical Tracking Events and Key Data Elements from external systems, reducing human error associated with manual data entry and increasing the accuracy of supply chain tracking throughout the traceability platform. The external data source integration via API 1400 may address the technical challenge of capturing data from heterogeneous systems operated by different stakeholders, normalizing data from various formats into a canonical dataset, and recording the normalized data on the distributed ledger network 110 with provenance metadata indicating the ingestion method. The external data source integration via API 1400 may correspond to the API integration layer 150 described with reference to FIG. 1, providing a detailed view of the components and data flows that enable integration with external systems.

An API gateway 1410 is included within the external data source integration via API 1400 and serves as a central interface for external data ingestion into the traceability platform. The API gateway 1410 may receive data from multiple external systems through standardized application programming interfaces, consolidating data ingestion through a single entry point that enables consistent authentication, rate control, and routing. The API gateway 1410 may support multiple API protocols including REST, GraphQL, and message queue protocols, enabling integration with external systems that implement different communication standards. The API gateway 1410 may provide a unified interface that abstracts the complexity of integrating with diverse external systems, enabling the platform to add new data sources without modifying core platform components. The API gateway 1410 may log all incoming data requests for audit purposes, creating records that document the source, timing, and content of data received from external systems.

An authentication module 1412 is included within the API gateway 1410 and verifies the identity of external data sources submitting data to the platform. The authentication module 1412 may implement multiple authentication mechanisms including API keys, OAuth tokens, and certificate-based authentication, enabling external systems to authenticate using methods appropriate to their security capabilities. The authentication module 1412 may validate credentials presented by external systems against a registry of authorized data sources, rejecting data submissions from unrecognized or unauthorized sources. The authentication module 1412 may associate authenticated data submissions with specific stakeholder organizations registered through the registration module 1212 described with reference to FIG. 12, enabling the platform to attribute ingested data to the appropriate organizational context. The authentication module 1412 may enforce access controls that restrict which data types each external source is authorized to submit, preventing unauthorized data submissions that could compromise data integrity. The authentication module 1412 may generate authentication tokens with limited validity periods, requiring external systems to periodically re-authenticate and reducing the risk of credential compromise.

A rate limiter 1414 is included within the API gateway 1410 and controls the volume of incoming data requests to prevent system overload and ensure fair resource allocation among data sources. The rate limiter 1414 may enforce request rate limits that specify the maximum number of requests each external source may submit within defined time windows, preventing individual sources from consuming excessive platform resources. The rate limiter 1414 may implement different rate limits for different data source types, allocating higher limits to high-volume sources such as agricultural equipment 1422 that generate continuous telemetry data and lower limits to sources that submit data less frequently. The rate limiter 1414 may queue requests that exceed rate limits for later processing rather than rejecting them outright, ensuring that data is not lost during temporary traffic spikes. The rate limiter 1414 may provide feedback to external systems indicating current rate limit status and remaining request capacity, enabling external systems to adapt their submission patterns to avoid rate limit violations. The rate limiter 1414 may implement burst allowances that permit temporary rate limit exceedances for time-sensitive data such as temperature alerts from the IoT sensors 1424, ensuring that urgent data is processed promptly.

A request router 1416 is included within the API gateway 1410 and directs incoming data to appropriate processing modules based on data type, source, and content. The request router 1416 may analyze incoming data requests to determine the appropriate processing pathway, routing agricultural operation data to modules that handle farm-level records, routing sensor data to modules that handle environmental monitoring, and routing compliance data to modules that handle regulatory requirements. The request router 1416 may implement routing rules that are configurable based on data source registrations, enabling the platform to adapt routing behavior as new data sources are added or existing sources are modified. The request router 1416 may support content-based routing that examines data payloads to determine appropriate processing, enabling intelligent routing even when data source metadata is insufficient to determine the correct pathway. The request router 1416 may distribute incoming requests across multiple processing instances for load balancing, ensuring that high data volumes are processed efficiently without creating bottlenecks. The request router 1416 may maintain routing metrics that track request volumes, processing times, and error rates for each routing pathway, enabling performance monitoring and optimization.

With continued reference to FIG. 14, external data sources 1420 are included within the external data source integration via API 1400 and represent the various systems and devices that provide data to the traceability platform through the API gateway 1410. The external data sources 1420 may correspond to the external data sources 152 described with reference to FIG. 1, providing a more detailed view of the specific source types that contribute data to the platform. The external data sources 1420 may include systems operated by stakeholders within the supply chain, third-party service providers that offer data relevant to traceability and compliance, and regulatory agencies that maintain databases of compliance requirements and recall notices. The external data sources 1420 may submit data through scheduled batch uploads, real-time streaming connections, or event-triggered submissions depending on the nature of the data and the capabilities of the source systems.

Agricultural equipment 1422 is included within the external data sources 1420 and represents farm machinery and systems that generate data on crop production activities. The agricultural equipment 1422 may include tractors equipped with telemetry systems that capture operational data during field activities such as tillage, planting, and fertilizer application. The agricultural equipment 1422 may include harvesters that capture yield data including crop quantities, moisture content, and quality assessments during harvest operations. The agricultural equipment 1422 may include irrigation systems that capture water application data including irrigation timing, duration, and volume. The agricultural equipment 1422 may include sprayers that capture chemical application data including pesticide and herbicide products, application rates, and coverage areas. The agricultural equipment 1422 may integrate with external machine telemetry and field operations platforms such as John Deere systems through API access, CSV export, or account-based sharing depending on vendor constraints and available integration methods. The agricultural equipment 1422 may generate continuous telemetry streams during field operations, providing high-resolution data that captures the details of agricultural practices affecting product quality and carbon intensity. The data generated by the agricultural equipment 1422 may be ingested through the ingestion layer 1640 described with reference to FIG. 16 and stored as operation records 1632 within the universal data store 1620.

IoT sensors 1424 are included within the external data sources 1420 and represent environmental monitoring devices deployed throughout the supply chain. The IoT sensors 1424 may include temperature sensors that monitor storage and transportation conditions for perishable products, capturing temperature readings at regular intervals to support cold chain verification through the cold chain verification contract 922 described with reference to FIG. 9. The IoT sensors 1424 may include humidity sensors that monitor moisture conditions in storage facilities, capturing data relevant to product quality and shelf life. The IoT sensors 1424 may include location trackers that monitor product positions during transportation, capturing GPS coordinates that enable verification of transportation routes and delivery timing. The IoT sensors 1424 may include soil sensors deployed in agricultural fields that monitor soil moisture, temperature, and nutrient levels, capturing data relevant to irrigation scheduling and fertilizer application decisions. The IoT sensors 1424 may transmit data through cellular networks, satellite connections, or local wireless networks depending on deployment locations and connectivity availability. The IoT sensors 1424 may generate the temperature log data 924 used by the cold chain verification contract 922 to validate that products were maintained within acceptable temperature thresholds 926 during transportation and storage.

Supply chain platforms 1426 are included within the external data sources 1420 and represent existing enterprise systems used by stakeholders for inventory management, warehouse management, and transportation management. The supply chain platforms 1426 may include inventory management systems that track product quantities, locations, and movements within stakeholder facilities. The supply chain platforms 1426 may include warehouse management systems that track receiving, storage, picking, and shipping activities within distribution centers. The supply chain platforms 1426 may include transportation management systems that track shipment scheduling, carrier assignments, and delivery confirmations. The supply chain platforms 1426 may include enterprise resource planning systems that integrate operational data across multiple business functions. The supply chain platforms 1426 may represent systems that stakeholders have deployed prior to adopting the traceability platform, enabling integration with existing operational infrastructure rather than requiring replacement of established systems. The supply chain platforms 1426 may submit data through scheduled batch exports, real-time event notifications, or API queries initiated by the platform, depending on the integration capabilities of each system. The ingestion layer normalizes and ingests data from the heterogeneous systems represented by the supply chain platforms 1426 and unifies those records into a canonical dataset with provenance of ingestion method, enabling consistent processing regardless of the source system format.

Regulatory databases 1428 are included within the external data sources 1420 and represent government compliance databases that store regulatory requirements, certification records, and recall notices. The regulatory databases 1428 may include FDA databases that contain current Food Traceability List requirements, specifying which products are subject to enhanced FSMA traceability requirements and which Critical Tracking Events and Key Data Elements are required for each product category. The regulatory databases 1428 may include organic certification databases maintained by the USDA that contain records of organic certifications issued by accredited certifying agents, enabling verification that products claiming organic status have valid certifications. The regulatory databases 1428 may include recall databases that contain current recall notices issued by manufacturers and regulatory agencies, enabling the real-time recall notification system 1300 to identify affected products and notify consumers. The regulatory databases 1428 may include import and export databases that contain requirements for products crossing international borders, enabling compliance verification for products in international supply chains. The regulatory databases 1428 may correspond to the regulatory database connector 454 described with reference to FIG. 4, providing the data sources that enable smart contracts to validate compliance with current regulatory requirements.

Weather services 1430 are included within the external data sources 1420 and provide environmental data relevant to agricultural production and transportation conditions. The weather services 1430 may include historical weather data services that provide records of temperature, precipitation, and other weather conditions during growing seasons, enabling correlation between weather patterns and crop yields or quality outcomes. The weather services 1430 may include current weather data services that provide real-time conditions at farm locations, distribution centers, and transportation routes, enabling monitoring of conditions that may affect product quality during handling and transportation. The weather services 1430 may include weather forecast services that provide predictions of future conditions, enabling stakeholders to plan agricultural operations and transportation schedules based on anticipated weather. The weather services 1430 may include severe weather alert services that provide notifications of storms, floods, freezes, and other conditions that may affect supply chain operations, enabling proactive response to weather-related disruptions. The weather services 1430 may provide data that supplements the agricultural operation data captured by the agricultural equipment 1422, enabling more complete characterization of growing conditions that affect product attributes and carbon intensity.

As further shown in FIG. 14, a data transformation layer 1440 is included within the external data source integration via API 1400 and processes incoming data for blockchain recording. The data transformation layer 1440 may receive raw data from the external data sources 1420 through the API gateway 1410 and transform the data into standardized formats compatible with the platform's canonical data schema. The data transformation layer 1440 may address the technical challenge of integrating data from heterogeneous sources that use different data formats, field naming conventions, units of measure, and data structures. The data transformation layer 1440 may apply transformation rules that are configurable based on data source registrations, enabling the platform to adapt transformation behavior as new data sources are added or existing sources modify their data formats. The data transformation layer 1440 may preserve provenance metadata that indicates the original data source, the ingestion method, and the transformations applied, enabling audit and verification of data lineage.

A data normalizer 1442 is included within the data transformation layer 1440 and converts data from various formats into a standardized format compatible with the platform's canonical schema. The data normalizer 1442 may parse incoming data from formats including JSON, XML, CSV, and proprietary binary formats used by specific equipment manufacturers, extracting data values and mapping them to canonical field definitions. The data normalizer 1442 may convert units of measure to standard units used within the platform, such as converting gallons to liters, pounds to kilograms, or acres to hectares based on configuration settings. The data normalizer 1442 may normalize date and time formats to standard representations, converting between time zones and handling variations in date formatting conventions used by different data sources. The data normalizer 1442 may normalize text values to standard vocabularies, mapping variations in terminology used by different sources to consistent terms used within the platform. The data normalizer 1442 may handle missing or null values according to configured rules, substituting default values, flagging incomplete records, or rejecting records that lack required fields depending on the data type and source.

A CTE extractor 1444 is included within the data transformation layer 1440 and identifies Critical Tracking Events from incoming data streams. The CTE extractor 1444 may analyze normalized data to detect events that constitute Critical Tracking Events under FSMA requirements, such as receiving events when products arrive at facilities, shipping events when products depart from facilities, and transformation events when products are processed or combined. The CTE extractor 1444 may apply event detection rules that identify CTEs based on data patterns, such as detecting a receiving event when inventory data shows a quantity increase at a facility or detecting a shipping event when transportation data shows a departure from a facility. The CTE extractor 1444 may extract event attributes including event type, event timestamp, event location, and party identifiers from the normalized data, structuring the extracted information for recording on the distributed ledger network 110. The CTE extractor 1444 may correlate events across multiple data sources, combining data from the supply chain platforms 1426 with data from the IoT sensors 1424 to create complete event records that include both operational data and environmental monitoring data. The CTE extractor 1444 may generate the critical tracking event data 934 used by the FSMA compliance contract 932 described with reference to FIG. 9 to validate compliance with traceability requirements.

A KDE extractor 1446 is included within the data transformation layer 1440 and identifies Key Data Elements from incoming data streams. The KDE extractor 1446 may analyze normalized data to extract the specific data points required at each Critical Tracking Event, including lot codes, product descriptions, quantities, dates, times, and party identifiers. The KDE extractor 1446 may apply extraction rules that are specific to each Critical Tracking Event type, identifying the Key Data Elements required for receiving events, shipping events, transformation events, and other CTE types defined under FSMA requirements. The KDE extractor 1446 may validate extracted Key Data Elements against format requirements, verifying that lot codes conform to expected patterns, that quantities are within reasonable ranges, and that dates and times are properly formatted. The KDE extractor 1446 may generate the key data element data 936 used by the FSMA compliance contract 932 described with reference to FIG. 9 to validate that all required data elements have been captured at each Critical Tracking Event.

A data validator 1448 is included within the data transformation layer 1440 and verifies data integrity and completeness before recording on the blockchain. The data validator 1448 may apply validation rules that check for required fields, valid value ranges, referential integrity between related records, and consistency with previously recorded data. The data validator 1448 may flag records that fail validation for manual review, enabling stakeholders to correct data quality issues before the data is permanently recorded. The data validator 1448 may generate validation reports that summarize data quality metrics, enabling stakeholders to monitor the quality of data received from external sources and identify sources that consistently produce problematic data. The data validator 1448 may enforce business rules that ensure data conforms to operational constraints, such as verifying that shipping quantities do not exceed available inventory or that receiving timestamps occur after corresponding shipping timestamps.

A smart contract interface 1450 is included within the external data source integration via API 1400 and connects the data transformation layer 1440 to the blockchain for recording validated data. The smart contract interface 1450 may invoke smart contracts within the smart contract execution layer 440 to record Critical Tracking Events, Key Data Elements, and other supply chain data on the master blockchain 114. A CTE recording contract 1452 is included within the smart contract interface 1450 and records Critical Tracking Events extracted by the CTE extractor 1444 on the blockchain. A KDE recording contract 1454 is included within the smart contract interface 1450 and records Key Data Elements extracted by the KDE extractor 1446 in association with corresponding Critical Tracking Events. A data linking contract 1456 is included within the smart contract interface 1450 and establishes links between newly recorded data and existing blockchain records, maintaining the hierarchical linking structure 762 that enables end-to-end traceability through product transformations and aggregations.

A blockchain recording layer 1460 is included within the external data source integration via API 1400 and manages the process of storing validated data on the distributed ledger network 110. A transaction queue 1462 is included within the blockchain recording layer 1460 and manages pending blockchain transactions, queuing transactions for submission and handling retries when network congestion or other conditions prevent immediate confirmation. A confirmation monitor 1464 is included within the blockchain recording layer 1460 and tracks transaction confirmations, verifying that submitted transactions have been successfully recorded on the master blockchain 114 and alerting operators when transactions fail to confirm within expected timeframes. A record index 1466 is included within the blockchain recording layer 1460 and maintains an index of all recorded data for efficient retrieval, enabling rapid queries against the blockchain data without requiring full blockchain scans for each query.

The external data source integration via API 1400 reduces human error by automating data capture from source systems and increases the accuracy of supply chain tracking by obtaining data directly from the systems where operational activities are recorded. The provenance metadata preserved throughout the data transformation layer 1440 enables audit and verification of data lineage, supporting regulatory compliance and dispute resolution when questions arise about the source or accuracy of recorded data.

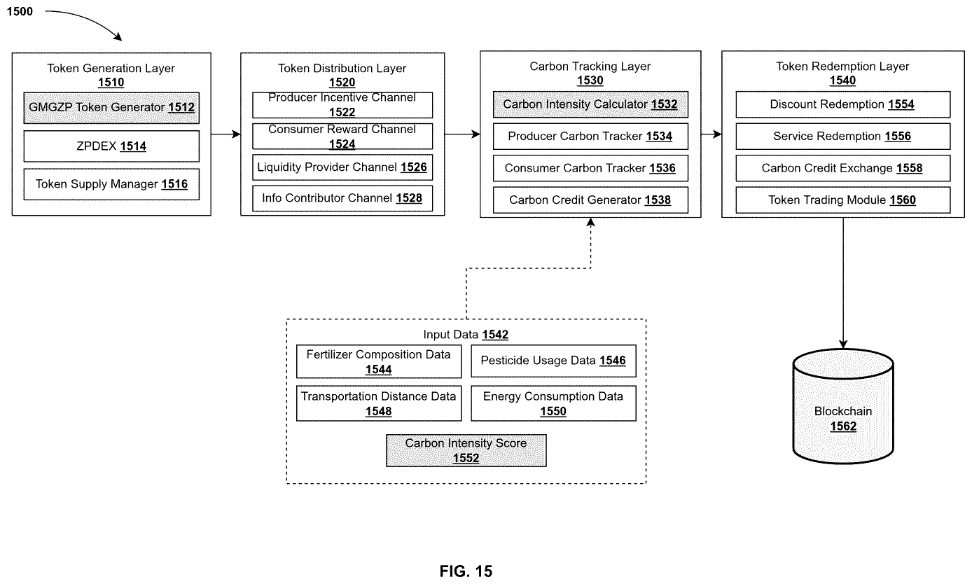

Referring to FIG. 15, a token economy and carbon credit flow 1500 is illustrated in accordance with some embodiments of the present disclosure. The token economy and carbon credit flow 1500 provide blockchain-based rewards and sustainability incentives within the traceability platform. The token economy and carbon credit flow 1500 may provide a technical framework for incentivizing participation in the traceability ecosystem, rewarding sustainable practices, and enabling monetization of carbon intensity improvements achieved by agricultural producers. The token economy and carbon credit flow 1500 may interface with the carbon dApp 318 described with reference to FIG. 3 and the carbon contract 448 described with reference to FIG. 4 to calculate carbon intensity scores and distribute token-based rewards based on sustainability performance. The token economy and carbon credit flow 1500 may may enable incentive values, premiums, or settlement amounts to be determined as a function of carbon intensity scores, thereby incentivizing adoption of lower-carbon agricultural practices.

A token generation layer 1510 is included within the token economy and carbon credit flow 1500 and manages the creation and supply of cryptographic tokens used within the platform ecosystem. The token generation layer 1510 may provide the foundational infrastructure for token-based incentives by controlling the generation of new tokens according to predefined rules and distribution schedules. The token generation layer 1510 may interface with the token management layer 370 described with reference to FIG. 3 to coordinate token operations across the platform. The token generation layer 1510 may ensure that token generation follows consistent rules that maintain token value and prevent inflationary pressures that could undermine the incentive structure.

A GMGZP token generator 1512 is included within the token generation layer 1510 and creates cryptographic tokens for use within the platform ecosystem. The GMGZP token generator 1512 may generate the GMGZP tokens 364 described with reference to FIG. 3, implementing the token creation logic that produces new tokens according to defined generation rules. The GMGZP token generator 1512 may create tokens in response to qualifying events such as data contributions, product scans, purchases, and sustainability achievements, distributing newly generated tokens to participants who satisfy defined criteria. The GMGZP token generator 1512 may implement token generation algorithms that control the rate and conditions under which new tokens are created, ensuring that token generation aligns with platform objectives and economic sustainability. The GMGZP token generator 1512 may record all token generation events on the distributed ledger network 110, creating an auditable record of token creation that supports transparency and verification.

A ZPDEX 1514 is included within the token generation layer 1510 and controls token operations within the platform. The ZPDEX 1514 may correspond to the ZPDEX core 302 described with reference to FIG. 3, serving as the controlling self-managed entity that coordinates token generation, distribution, and redemption activities. The ZPDEX 1514 may enforce rules governing token operations, ensuring that token transactions conform to platform policies and that token balances are accurately maintained across participant wallets. The ZPDEX 1514 may manage the relationship between the GMGZP token generator 1512 and the distribution channels that deliver tokens to participants, coordinating the flow of tokens from generation through distribution to redemption. The ZPDEX 1514 may operate autonomously based on smart contract logic encoded within the smart contract layer 106, reducing reliance on manual intervention or centralized administrative control for token operations.

A token supply manager 1516 is included within the token generation layer 1510 and controls the total supply and distribution rate of tokens within the ecosystem. The token supply manager 1516 may implement supply control mechanisms that limit the total number of tokens that can be generated, preventing unlimited token creation that could devalue existing token holdings. The token supply manager 1516 may implement distribution rate controls that govern how quickly tokens are released into circulation, smoothing token distribution over time to maintain stable token economics. The token supply manager 1516 may adjust distribution parameters based on ecosystem metrics such as participant counts, transaction volumes, and token velocity, adapting token economics to changing platform conditions. The token supply manager 1516 may implement reserve mechanisms that hold portions of generated tokens for future distribution, enabling the platform to fund ongoing incentive programs and respond to changing market conditions.

With continued reference to FIG. 15, a token distribution layer 1520 is included within the token economy and carbon credit flow 1500 and manages the allocation of tokens to participants through multiple distribution channels. The token distribution layer 1520 may receive tokens from the token generation layer 1510 and distribute tokens to participants based on their contributions and activities within the platform ecosystem. The token distribution layer 1520 may implement distribution logic that determines which participants receive tokens, how many tokens each participant receives, and when token distributions occur. The token distribution layer 1520 may support multiple distribution channels that target different participant types and reward different types of contributions, enabling comprehensive incentive coverage across the platform ecosystem.

A producer incentive channel 1522 is included within the token distribution layer 1520 and distributes tokens to producers who contribute data to the platform. The producer incentive channel 1522 may reward farmers, processors, manufacturers, and other supply chain participants who record Critical Tracking Events, capture Key Data Elements, and submit agricultural operation data that enables traceability and carbon intensity tracking. The producer incentive channel 1522 may calculate token rewards based on the quantity and quality of data contributed, providing larger rewards for more complete and accurate data submissions. The producer incentive channel 1522 may provide additional rewards for producers who achieve lower carbon intensity scores, incentivizing adoption of sustainable practices that reduce greenhouse gas emissions. The producer incentive channel 1522 may distribute tokens to producer wallets associated with stakeholder organizations registered through the registration module 1212 described with reference to FIG. 12, enabling producers to accumulate token holdings that can be redeemed or traded.

A consumer reward channel 1524 is included within the token distribution layer 1520 and distributes tokens to consumers who scan products and complete purchases within the platform ecosystem. The consumer reward channel 1524 may reward consumers for engaging with the traceability platform by scanning ZPTAG authentication tags, verifying product authenticity, and completing purchase associations that enable recall notifications. The consumer reward channel 1524 may interface with the rewards layer 1060 described with reference to FIG. 10, coordinating token distributions with the loyalty points module 1062 and the token wallet 1066 within the consumer application 132. The consumer reward channel 1524 may calculate token rewards based on scanning frequency, purchase volumes, and engagement patterns, providing incentives that encourage continued consumer participation in traceability verification activities. The consumer reward channel 1524 may provide bonus rewards for consumers who purchase products with lower carbon intensity scores, creating consumer demand for sustainably produced goods that supports the producer incentive channel 1522.

A liquidity provider channel 1526 is included within the token distribution layer 1520 and distributes tokens to participants who provide liquidity to the exchange. The liquidity provider channel 1526 may reward participants who contribute assets to liquidity pools that enable token trading within the ZPDEX 1514, compensating liquidity providers for the capital they commit to supporting exchange operations. The liquidity provider channel 1526 may calculate token rewards based on the amount of liquidity provided, the duration of liquidity commitment, and the trading volume facilitated by the liquidity, aligning rewards with the value contributed to exchange functionality. The liquidity provider channel 1526 may distribute tokens to liquidity provider wallets on a periodic basis, providing ongoing rewards that incentivize sustained liquidity provision.

An information contributor channel 1528 is included within the token distribution layer 1520 and distributes tokens to participants who contribute valuable information to the ecosystem. The information contributor channel 1528 may reward participants who provide data, insights, or services that enhance platform functionality beyond standard traceability data contributions. The information contributor channel 1528 may reward third-party data providers who contribute weather data, market data, or regulatory information through the external data sources 1420 described with reference to FIG. 14. The information contributor channel 1528 may reward participants who identify data quality issues, report fraudulent activities, or contribute to platform improvement through feedback and suggestions. The information contributor channel 1528 may calculate token rewards based on the value and impact of contributed information, providing larger rewards for contributions that enhance platform capabilities or data quality.

As further shown in FIG. 15, a carbon tracking layer 1530 is included within the token economy and carbon credit flow 1500 and manages the measurement and tracking of carbon intensity throughout the supply chain. The carbon tracking layer 1530 may provide the technical infrastructure for calculating carbon intensity scores, tracking carbon contributions at the producer and consumer levels, and converting carbon tracking data into tradeable carbon credits. The carbon tracking layer 1530 may interface with the carbon credit module 372 described with reference to FIG. 3 to measure carbon created or captured for both producers and consumers throughout the supply chain. The carbon tracking layer 1530 may support monetization of sustainable practices by enabling verification and certification of carbon intensity improvements that qualify for premium pricing or tax credit programs such as the 45Z program.

A carbon intensity calculator 1532 is included within the carbon tracking layer 1530 and calculates carbon scores based on supply chain data captured throughout the traceability platform. The carbon intensity calculator 1532 may implement calculation methodologies consistent with recognized standards for carbon intensity measurement, processing agricultural operation data to produce carbon intensity scores expressed as greenhouse gas emissions per unit of output. The carbon intensity calculator 1532 may receive input data 1542 from the universal data store 1620 described with reference to FIG. 16, accessing the operation records 1632 that capture tillage practices, irrigation usage, fertilizer application, chemical treatments, and harvest yields. The carbon intensity calculator 1532 may apply calculation factors that convert operational data into carbon equivalent values, accounting for emissions associated with each agricultural practice and input. The carbon intensity calculator 1532 may produce a carbon intensity score 1552 for each product, field, or harvest that quantifies the greenhouse gas emissions associated with production.

The input data 1542 processed by the carbon intensity calculator 1532 includes multiple data categories that affect carbon intensity calculations. Fertilizer composition data 1544 is included within the input data 1542 and captures information about fertilizer types, nitrogen content, and application rates that affect emissions associated with fertilizer production and application. The fertilizer composition data 1544 may include synthetic fertilizer usage that contributes to carbon intensity through manufacturing emissions and nitrous oxide releases from soil application. The fertilizer composition data 1544 may include organic fertilizer usage such as manure application that may have different carbon intensity implications than synthetic fertilizers. Pesticide usage data 1546 is included within the input data 1542 and captures information about pesticide and herbicide applications that contribute to carbon intensity through manufacturing and application emissions. Transportation distance data 1548 is included within the input data 1542 and captures information about distances traveled during product distribution that contribute to carbon intensity through fuel consumption and vehicle emissions. Energy consumption data 1550 is included within the input data 1542 and captures information about electricity and fuel usage during agricultural operations, processing, and manufacturing that contribute to carbon intensity based on energy source carbon factors.

A producer carbon tracker 1534 is included within the carbon tracking layer 1530 and measures carbon created or captured by producers throughout the production process. The producer carbon tracker 1534 may track emissions associated with agricultural operations at the farm level, calculating the carbon footprint of farming practices based on the input data 1542 captured through the ingestion layer 1640. The producer carbon tracker 1534 may track carbon sequestration achieved through practices such as cover cropping, no-till farming, and soil carbon management, crediting producers for carbon captured through sustainable practices. The producer carbon tracker 1534 may maintain carbon accounts for each producer organization, tracking cumulative emissions and sequestration over time to support carbon credit generation and sustainability reporting. The producer carbon tracker 1534 may enable farmers to demonstrate lower carbon intensity that qualifies for premium pricing from buyers such as ethanol plants that value lower carbon intensity feedstock for maximizing tax credit benefits under programs such as 45Z.

A consumer carbon tracker 1536 is included within the carbon tracking layer 1530 and measures carbon impact associated with consumer purchases within the platform ecosystem. The consumer carbon tracker 1536 may calculate the carbon footprint of products purchased by consumers based on the carbon intensity score 1552 associated with each product. The consumer carbon tracker 1536 may maintain carbon accounts for each consumer, tracking cumulative carbon impact of purchases over time to support consumer awareness and carbon offset programs. The consumer carbon tracker 1536 may enable consumers to understand the carbon implications of their purchasing decisions, displaying carbon intensity information through the product information display 1030 described with reference to FIG. 10. The consumer carbon tracker 1536 may support carbon offset programs where consumers can purchase carbon credits to offset the carbon impact of their purchases, creating additional demand for carbon credits generated through the platform.

A carbon credit generator 1538 is included within the carbon tracking layer 1530 and converts carbon tracking data into tradeable carbon credits. The carbon credit generator 1538 may process carbon sequestration data from the producer carbon tracker 1534 to generate carbon credits that represent verified carbon capture or emissions reductions. The carbon credit generator 1538 may apply verification rules that ensure carbon credits are generated only for legitimate carbon improvements that satisfy defined criteria, preventing fraudulent credit generation. The carbon credit generator 1538 may interface with accredited certifiers to obtain third-party verification of carbon claims before generating tradeable credits, ensuring that credits meet market standards for authenticity and additionality. The carbon credit generator 1538 may record generated carbon credits on the distributed ledger network 110, creating immutable records of credit generation that support trading and retirement tracking.

With continued reference to FIG. 15, a token redemption layer 1540 is included within the token economy and carbon credit flow 1500 and manages the conversion of tokens into value through multiple redemption options. The token redemption layer 1540 may enable participants to extract value from accumulated token holdings by redeeming tokens for discounts, services, carbon credits, or other assets. The token redemption layer 1540 may interface with the digital wallets 360 described with reference to FIG. 3 to process redemption requests and update token balances. The token redemption layer 1540 may support multiple redemption pathways that accommodate different participant preferences and use cases, enabling flexible value extraction from token holdings.

A discount redemption module 1554 is included within the token redemption layer 1540 and enables token holders to redeem tokens for product discounts within the platform ecosystem. The discount redemption module 1554 may interface with the coupon manager 1064 described with reference to FIG. 10 to apply token-based discounts during consumer purchases. The discount redemption module 1554 may calculate discount values based on token quantities redeemed and current token valuation, converting token holdings into monetary discounts applicable to product purchases. The discount redemption module 1554 may support redemption at participating retailers who accept token-based discounts, enabling consumers to apply accumulated tokens toward purchases of products tracked through the traceability platform.

A service redemption module 1556 is included within the token redemption layer 1540 and enables token holders to redeem tokens for services within the ecosystem. The service redemption module 1556 may enable producers to redeem tokens for platform services such as premium analytics, enhanced reporting, or priority support. The service redemption module 1556 may enable consumers to redeem tokens for premium features within the consumer application 132, such as advanced personalization, detailed carbon tracking, or exclusive content. The service redemption module 1556 may calculate service access based on token quantities redeemed, granting service access for defined periods or usage quantities based on redemption amounts.

A carbon credit exchange module 1558 is included within the token redemption layer 1540 and enables token holders to trade carbon credits with third parties outside the platform ecosystem. The carbon credit exchange module 1558 may interface with external carbon credit markets through the market data connector 456 described with reference to FIG. 4, enabling participants to sell carbon credits generated through the carbon credit generator 1538 to external buyers. The carbon credit exchange module 1558 may enable participants to purchase carbon credits from external markets for use in offsetting emissions or meeting sustainability commitments. The carbon credit exchange module 1558 may facilitate price discovery by providing access to market pricing data, enabling participants to make informed decisions about carbon credit transactions. The carbon credit exchange module 1558 may support the commercial value proposition where ethanol plants value lower carbon intensity feedstock, as carbon credits associated with low-carbon agricultural inputs may be traded or transferred to support fuel production tax credit claims.

The token trading module 1560 is included within the token redemption layer 1540 and enables token holders to trade tokens on supported exchanges. The token trading module 1560 may enable participants to buy and sell GMGZP tokens 364 and ZPETH tokens 362 through the ZPDEX 1514 or through external exchanges that support platform tokens. The token trading module 1560 may provide trading interfaces that display current token prices, order books, and trading history, enabling participants to execute trades based on market conditions. The token trading module 1560 may interface with the liquidity provider channel 1526 to access liquidity pools that support token trading, ensuring that participants can execute trades without excessive price impact. The token trading module 1560 may enable participants to convert token holdings into other cryptocurrencies or fiat currencies, providing liquidity for participants who wish to realize monetary value from accumulated tokens.

Throughout the token economy and carbon credit flow 1500, all token transactions are recorded on a blockchain 1562 to ensure transparency and immutability of token operations. The blockchain 1562 may correspond to the master blockchain 114 described with reference to FIG. 1 and FIG. 2, serving as the authoritative ledger for token generation, distribution, redemption, and trading activities. The blockchain 1562 may store token generation events recorded by the GMGZP token generator 1512, distribution events recorded by the token distribution layer 1520, redemption events recorded by the token redemption layer 1540, and trading events recorded by the token trading module 1560. The blockchain 1562 may maintain token balance records that track holdings for each participant wallet, enabling verification of token ownership and prevention of double-spending. The blockchain 1562 may store carbon credit records generated by the carbon credit generator 1538, enabling verification of credit authenticity and tracking of credit transfers and retirements. The immutable storage of token and carbon credit records on the blockchain 1562 may provide the transparency and auditability required for participants to trust the token economy and for regulators to verify compliance with applicable requirements.

Referring to FIG. 16, a carbon intensity module system architecture 1600 is illustrated in accordance with some embodiments of the present disclosure. The carbon intensity module system architecture 1600 represents an adjacent module within the traceability platform that leverages universal data collected through the supply chain infrastructure to generate program-specific submissions for carbon incentive programs and monetize stewardship practices. The carbon intensity module system architecture 1600 may address the data fragmentation problem described previously by maintaining a canonical universal data layer that normalizes agricultural operation data from heterogeneous sources into a standardized schema. The carbon intensity module system architecture 1600 may provide a system for agricultural carbon intensity tracking and certification that enables farmers to demonstrate lower carbon intensity scores that qualify for premium pricing and tax credit programs.

The carbon intensity module system architecture 1600 includes a plurality of client devices that enable supply chain participants to interact with the platform for carbon intensity data entry, submission, and verification. A farmer client device 1602 is included within the carbon intensity module system architecture 1600 and provides an interface for farmers to enter agricultural operation data, submit carbon intensity packages for certification, and associate certified carbon intensity scores with shipment identifiers. The farmer client device 1602 may correspond to the stakeholder devices 140 described with reference to FIG. 1, executing application software that provides carbon intensity functionality appropriate to farmer stakeholders. A co-op client device 1604 is included within the carbon intensity module system architecture 1600 and provides an interface for cooperative organizations to receive shipments, scan ZPTAG identifiers, retrieve carbon intensity attributes, and route incoming loads based on carbon intensity thresholds. The co-op client device 1604 may enable co-ops to segregate grain into different silos based on carbon intensity bands to avoid averaging higher carbon intensity grain into low carbon intensity lots. A processor client device 1606 is included within the carbon intensity module system architecture 1600 and provides an interface for processor organizations such as ethanol plants to verify carbon intensity credentials associated with incoming feedstocks and to access proof packages for aggregated lots.

The farmer client device 1602, the co-op client device 1604, and the processor client device 1606 communicate with a ZPTAG platform 1610 via a network 1608. The network 1608 may comprise one or more communication networks including the Internet, private networks, wireless networks, and combinations thereof, corresponding to the network 120 described with reference to FIG. 1. The ZPTAG platform 1610 provides the server-side infrastructure that implements carbon intensity tracking, certification, and binding functionality within the traceability ecosystem. The ZPTAG platform 1610 may host multiple services that collectively enable the carbon intensity workflows described herein, including data ingestion, template-driven form generation, carbon intensity computation, submission sealing, certification coordination, and shipment binding.

An organization onboarding service 1612 is included within the ZPTAG platform 1610 and manages organization profiles, facilities, fields, and crops for supply chain participants. The organization onboarding service 1612 may correspond to the organization management layer 1210 described with reference to FIG. 12, providing the foundational data structures that scope carbon intensity calculations and reports. The organization onboarding service 1612 may support hierarchical relationships where a co-op organization may include multiple farm organizations, and each farm organization may have relationships to other organizations in distinct supply chains. The organization onboarding service 1612 may enable farmers to define facilities where farmer facilities are farms, and to define fields within each farm facility with attributes such as acres that are used to scope carbon intensity calculations and reports.

A universal data store 1620 is included within the ZPTAG platform 1610 and is configured to store canonical agricultural operation records associated with a plurality of fields. The universal data store 1620 may maintain a universal dataset that mirrors a structured form layout consistent with carbon intensity form structure, enabling the same underlying data to support both compliance and traceability requirements as well as value-add program submissions such as carbon intensity certification. The universal data store 1620 may address the data integration and canonicalization problem by providing a single authoritative repository for agricultural operation data that can drive multiple program forms without requiring repeated data entry for each program.

The universal data store 1620 includes an immutable record subsystem 1622 that provides blockchain-anchored storage for submitted data. The immutable record subsystem 1622 may correspond to the master blockchain 114 described with reference to FIG. 1 and FIG. 2, ensuring that sealed submission records cannot be modified after storage. The immutable record subsystem 1622 may store sealed carbon intensity submissions with cryptographic hashes that enable verification of submission contents, supporting audit requirements for incentive programs and providing verifiable provenance for carbon credentials associated with agricultural products.

The universal data store 1620 stores multiple categories of canonical records that collectively capture the agricultural operation data required for carbon intensity calculations. Organization records 1624 are stored within the universal data store 1620 and capture organization profile data including organization type, hierarchical relationships, and organizational identifiers. Facility records 1626 are stored within the universal data store 1620 and capture facility data where farmer facilities are farms and processor facilities are processing plants, including facility locations and operational characteristics. Field records 1628 are stored within the universal data store 1620 and capture field-level data including field identifiers and acreage, where the field entity within a farm facility includes attributes such as acres that are used to scope carbon intensity calculations and reports.

Crop year records 1630 are stored within the universal data store 1620 and capture crop year data that scopes carbon intensity calculations and reports. The carbon intensity reporting is scoped by crop year and can be filtered and aggregated across multiple harvests and fields, enabling farmers to view aggregate carbon intensity metrics across their operations or to drill down to specific field and harvest combinations. Operation records 1632 are stored within the universal data store 1620 and capture operational data including tillage records, irrigation records, fertilizer records, chemical treatment records, and cover crop records. Each canonical agricultural operation record comprises at least one of tillage data, irrigation data, fertilizer data, or harvest data that contributes to carbon intensity calculations. Harvest records 1634 are stored within the universal data store 1620 and capture harvest data including yield quantity, yield units, and harvest dates that are used in carbon intensity calculations to determine emissions per unit of output.

With continued reference to FIG. 16, an ingestion layer 1640 is included within the ZPTAG platform 1610 and is communicatively coupled to the universal data store 1620. The ingestion layer 1640 is configured to receive agricultural operation data from a plurality of data sources and normalize the received agricultural operation data into the canonical agricultural operation records stored in the universal data store 1620. The ingestion layer 1640 may address the technical challenge of integrating data from heterogeneous systems that use different data formats, field naming conventions, units of measure, and data structures, unifying those records into a canonical dataset that program forms can consume.

The ingestion layer 1640 comprises multiple ingestion modules that support different data entry pathways. A manual entry module 1642 is included within the ingestion layer 1640 and is configured to receive agricultural operation data via a user interface. The manual entry module 1642 may provide drop-down selections, direct input fields, and guided data entry workflows that enable farmers to enter tillage practices, irrigation usage, fertilizer applications, chemical treatments, cover crop information, and harvest data through the farmer client device 1602. A CSV import module 1644 is included within the ingestion layer 1640 and is configured to receive agricultural operation data from uploaded files. The CSV import module 1644 may enable farmers to export data from external farm management platforms in comma-separated value format and upload the exported files to the platform for ingestion into the universal data store 1620. An API adapter module 1646 is included within the ingestion layer 1640 and is configured to receive agricultural operation data from external farm management platforms. The API adapter module 1646 may integrate with external machine telemetry and field operations platforms through API access or account-based sharing, depending on vendor constraints and available integration methods.

Each canonical agricultural operation record comprises provenance metadata 1648 indicating an ingestion method by which the agricultural operation data was received. The provenance metadata 1648 may indicate whether data was received through the manual entry module 1642, the CSV import module 1644, or the API adapter module 1646, enabling audit trails and data quality assessment. The provenance metadata 1648 may support verification activities by documenting the source and ingestion pathway for each data element, enabling certifiers and auditors to assess data reliability based on ingestion method.

A program template engine 1650 is included within the ZPTAG platform 1610 and is configured to retrieve a program template defining required fields and mapping rules for a carbon intensity program and auto-populate the required fields by mapping data from the canonical agricultural operation records according to the mapping rules. The program template engine 1650 may address the technical challenge of mapping a canonical schema to multiple program schemas and supporting auto-population with missing-field prompts, reducing the burden of repeated data entry for different incentive programs.

The program template engine 1650 includes a template registry 1652 that stores program templates for different carbon intensity programs. The program template engine 1650 supports multiple program templates beyond 45Z, where the same universal data can drive multiple different program forms. A 45Z program template 1654 is stored within the template registry 1652 and defines the fields, validations, and attestations required for 45Z program submissions. The 45Z program template 1654 includes required fields 1656 that specify which data elements must be populated for valid submission, enabling the platform to prompt farmers for missing information before allowing submission.

The 45Z program template 1654 includes conditional dependencies 1658 that specify fields that are required based on values of predicate fields. For example, when a predicate field indicating manure application takes a value of yes, the conditional dependencies 1658 may cause manure type and total pounds fields to become required, and the system may compute per-acre rate from the entered values. The conditional dependencies 1658 may be described as the rendering of underlying validation rules and dependency constraints in the template, enabling the program template engine 1650 to enforce completeness requirements that vary based on the specific practices employed by each farmer.

The 45Z program template 1654 includes mapping rules 1660 that define how data from the canonical agricultural operation records in the universal data store 1620 maps to fields in the program template. The mapping rules 1660 may specify that field acreage from the field records 1628 maps to an acreage field in the program template, that crop species from crop records maps to a crop type field, that planting date from the crop year records 1630 maps to a planting date field, and that irrigation totals from the operation records 1632 map to irrigation fields. The mapping rules 1660 enable the program template engine 1650 to auto-populate the required fields 1656 by mapping data from the canonical agricultural operation records according to the mapping rules 1660, reducing manual data entry and ensuring consistency between the universal data and program submissions.

The 45Z program template 1654 includes computed field definitions 1662 that specify derived values calculated from input fields. The computed field definitions 1662 may specify that a gallons-per-acre computed field is derived from total gallons and field acreage, that a manure-rate-per-acre computed field is derived from total manure pounds and field acreage, and that a yield rate is derived from total yield and field acreage. The computed field definitions 1662 enable the program template engine 1650 to calculate derived values automatically, ensuring accuracy and consistency in computed metrics used for carbon intensity calculations.

As further shown in FIG. 16, a CI computation service 1670 is included within the ZPTAG platform 1610 and is configured to compute an estimated carbon intensity score based on the auto-populated required fields. The CI computation service 1670 may implement carbon intensity calculations consistent with recognized methodologies such as the GREET model, processing the agricultural operation data to produce carbon intensity scores expressed as greenhouse gas emissions per unit of output such as grams of carbon dioxide equivalent per bushel of grain.

An estimated CI calculator 1672 is included within the CI computation service 1670 and computes preliminary carbon intensity scores for planning purposes. The estimated CI calculator 1672 may enable farmers to see how practice changes such as tillage choice, cover crop adoption, or nitrogen adjustments can alter carbon intensity before committing to a submission, providing a controlled sandbox for iterative optimization. The estimated CI calculator 1672 may update estimated carbon intensity scores in real-time as farmers modify input data or explore what-if scenarios through the farmer client device 1602.

A certification package generator 1674 is included within the CI computation service 1670 and compiles submission packages for accredited certifiers. The certification package generator 1674 may assemble the auto-populated required fields, computed values, and estimated carbon intensity score into a structured package suitable for transmission to external certification entities. The certification package generator 1674 may generate cryptographic hashes of the package contents that enable verification of package integrity during certification review.

A submission sealing service 1680 is included within the ZPTAG platform 1610 and is configured to receive a submission request for a carbon intensity submission, generate a sealed submission record comprising the auto-populated required fields and the estimated carbon intensity score, and store the sealed submission record in the immutable record subsystem 1622 such that the sealed submission record cannot be modified after storage. The submission sealing service 1680 may address the data lifecycle control problem by implementing state transitions that distinguish between editable draft submissions used for what-if planning and sealed submissions that become immutable upon filing.

A draft manager 1682 is included within the submission sealing service 1680 and maintains draft submissions in an editable state prior to receiving submission requests. The draft manager 1682 may enable farmers to save work in progress, return to partially completed submissions, and modify data across all sections while the submission remains in draft state. The draft manager 1682 may support the what-if analysis capability by allowing iterative adjustment and comparison of different practice scenarios before committing to a final submission.

A sealing module 1684 is included within the submission sealing service 1680 and generates sealed submission records upon receiving submission requests. The sealing module 1684 may transition submissions from draft state to submitted state, generating cryptographic hashes and timestamps that create tamper-evident records. The sealing module 1684 may store the sealed submission record in the immutable record subsystem 1622, ensuring that the submission cannot be modified through any interface after sealing. The sealing module 1684 may enforce the constraint that once a report is submitted, the report becomes locked and cannot be edited, with subsequent changes requiring a new submission.

An audit log 1686 is included within the submission sealing service 1680 and tracks all submission events for audit and compliance purposes. The audit log 1686 may record submission timestamps, user identifiers, submission hashes, and state transitions, creating an auditable record of what was submitted and when. The audit log 1686 may support regulatory compliance and dispute resolution by providing verifiable documentation of submission activities.

With continued reference to FIG. 16, a certification integration service 1690 is included within the ZPTAG platform 1610 and is configured to transmit the sealed submission record to an accredited certifier, receive a certified carbon intensity score from the accredited certifier, and store the certified carbon intensity score in association with the sealed submission record. The certification integration service 1690 may coordinate the handoff of sealed packages to external certification entities and the ingestion of certified results, supporting the distinction between estimated carbon intensity scores used for planning and certified carbon intensity scores used for monetization and counterparty transactions.

Accredited certifiers 1692 are external entities that review sealed submission packages and issue certified carbon intensity scores. The accredited certifiers 1692 may be third-party certification firms authorized to verify carbon intensity claims for incentive programs such as 45Z. A certifier handoff module 1694 is included within the certification integration service 1690 and transmits sealed submission packages to the accredited certifiers 1692. The certifier handoff module 1694 may format packages according to certifier requirements, manage transmission protocols, and track submission status during the certification review process. A certified result ingest module 1696 is included within the certification integration service 1690 and receives certified carbon intensity scores from the accredited certifiers 1692. The certified result ingest module 1696 may validate received certifications, associate certified scores with corresponding submission records, and store certified results in the universal data store 1620 for retrieval during shipment binding and verification activities.

A ZPTAG binding service 1700 is included within the ZPTAG platform 1610 and is configured to associate the sealed submission record with a shipment identifier corresponding to a physical shipment of agricultural product. The ZPTAG binding service 1700 may address the digital-to-physical binding problem by creating associations between certified carbon intensity datasets and tagged vessels or manifests, enabling verification of carbon credentials at handoff points such as co-op receiving facilities.

A shipment association module 1702 is included within the ZPTAG binding service 1700 and binds certified carbon intensity scores to ZPTAG identifiers. The ZPTAG binding service 1700 associates shipments with ZPTAG identifiers including zip tag plates that can be placed on trucks for scanning at co-ops. The shipment association module 1702 may create binding records that link a certified CI submission to a specific ZPTAG plate identifier, enabling downstream verification of carbon intensity credentials when the shipment arrives at a receiving facility. A scan event recorder 1704 is included within the ZPTAG binding service 1700 and captures scan events at handoff points such as co-op receiving facilities. The scan event recorder 1704 may record scan timestamps, scan locations, and operator identifiers, creating an auditable record of when and where Cl-bound shipments were received.

External systems communicatively coupled to the ZPTAG platform 1610 include farm management platforms 1710 that provide CSV and API data for ingestion into the universal data store 1620. Accredited certifier systems 1712 receive sealed submission packages from the certification integration service 1690 and return certified CI scores. Co-op receiving systems 1714 interface with the ZPTAG binding service 1700 to perform scan events, retrieve CI attributes for incoming shipments, and execute silo routing decisions based on certified CI scores and configured threshold bands.

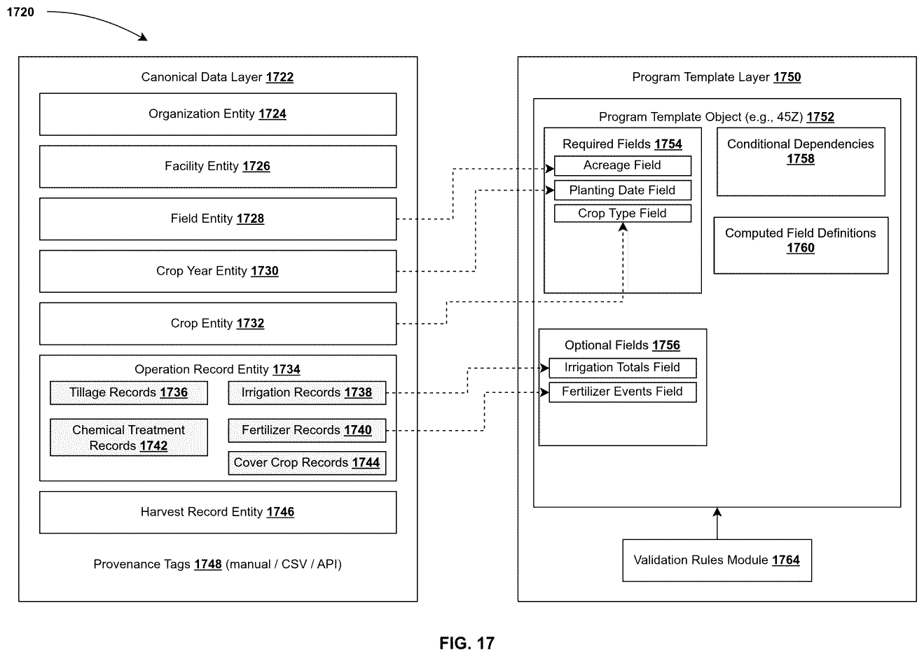

Referring to FIG. 17, a universal data schema and program template mapping 1720 is illustrated in accordance with some embodiments of the present disclosure. The universal data schema and program template mapping 1720 depicts how canonical universal data entities map to program-specific template fields to enable auto-population and reduce redundant data entry within the carbon intensity tracking and certification system. The universal data schema and program template mapping 1720 may provide a technical framework for addressing the data integration and canonicalization problem by establishing a standardized schema that normalizes agricultural operation data from heterogeneous sources and maps the normalized data to program-specific submission requirements through defined mapping relationships.

A canonical data layer 1722 is included within the universal data schema and program template mapping 1720 and contains a plurality of canonical entities that collectively capture the agricultural operation data required for carbon intensity calculations and program submissions. The canonical data layer 1722 may correspond to the data structures stored within the universal data store 1620 described with reference to FIG. 16, providing a detailed view of the entity relationships and data elements that form the foundation for program template auto-population. The canonical data layer 1722 may store canonical agricultural operation records that are normalized from agricultural operation data received from a plurality of heterogeneous data sources including the manual entry module 1642, the CSV import module 1644, and the API adapter module 1646 described with reference to FIG. 16. The ingestion layer 1640 may receive agricultural operation data from the plurality of data sources associated with one or more agricultural fields and normalize the agricultural operation data into the canonical agricultural operation records stored in the universal data store 1620.

An organization entity 1724 is included within the canonical data layer 1722 and stores organization profile data including organization type and hierarchical relationships between organizations within the supply chain. The organization entity 1724 may capture data for different organization types including farmers, co-ops, processors, manufacturers, distributors, and retailers, with each organization type having attributes appropriate to their role within the supply chain. The organization entity 1724 may support hierarchical relationships where a co-op organization may include multiple farm organizations, enabling aggregation of carbon intensity data across member farms while maintaining individual farm-level records. The organization entity 1724 may correspond to the organization records 1624 stored within the universal data store 1620, providing the organizational context that scopes carbon intensity calculations and program submissions.

A facility entity 1726 is included within the canonical data layer 1722 and stores facility data where farmer facilities are farms and processor facilities are processing plants. The facility entity 1726 may serve as a universal abstraction that represents different types of facilities depending on the organization type, enabling consistent data modeling across diverse supply chain participants. The facility entity 1726 may capture facility attributes including facility name, facility type, physical address, geographic coordinates, and operational characteristics that are relevant to carbon intensity tracking and compliance requirements. The facility entity 1726 may correspond to the facility records 1626 stored within the universal data store 1620, providing the facility-level context for agricultural operations and carbon intensity submissions.

A field entity 1728 is included within the canonical data layer 1722 and stores field-level data including field identifier and acreage for agricultural fields within farm facilities. The field entity 1728 may capture the geographic boundaries and size of each field, enabling carbon intensity calculations to be scoped to specific field areas and enabling per-acre metrics to be computed from total application amounts and field acreage. The field entity 1728 may correspond to the field records 1628 stored within the universal data store 1620, providing the field-level granularity that enables precise carbon intensity tracking for individual production areas within a farm operation. The field acreage stored within the field entity 1728 may be used by the program template engine 1650 to calculate derived values such as per-acre application rates and yield rates.

With continued reference to FIG. 17, a crop year entity 1730 is included within the canonical data layer 1722 and stores crop year data that scopes carbon intensity calculations and reports to specific production seasons. The crop year entity 1730 may capture the temporal boundaries of each production cycle, enabling carbon intensity submissions to be associated with specific growing seasons and enabling year-over-year comparisons of carbon intensity performance. The crop year entity 1730 may correspond to the crop year records 1630 stored within the universal data store 1620, providing the temporal context that enables filtering and aggregation of carbon intensity data across harvests and fields.

A crop entity 1732 is included within the canonical data layer 1722 and stores crop species and variety information for products grown within each field during each crop year. The crop entity 1732 may capture crop type, variety, and other attributes that affect carbon intensity calculations, as different crops may have different baseline carbon intensity values and may respond differently to various agricultural practices. The crop entity 1732 may enable the program template engine 1650 to apply crop-specific calculation factors when computing carbon intensity scores, ensuring that calculations reflect the characteristics of the specific crop being produced.

An operation record entity 1734 is included within the canonical data layer 1722 and stores operational data capturing the agricultural practices employed during production. The operation record entity 1734 may correspond to the operation records 1632 stored within the universal data store 1620, providing detailed records of the farming activities that contribute to carbon intensity calculations. The operation record entity 1734 may include multiple subcategories of operational data that capture different types of agricultural practices affecting carbon intensity.

Tillage records 1736 are included within the operation record entity 1734 and capture data regarding tillage practices employed during field preparation and cultivation. The tillage records 1736 may capture tillage type such as no-till, reduced till, or conventional tillage, tillage dates, tillage depth, and equipment used for tillage operations. The tillage records 1736 may affect carbon intensity calculations because different tillage practices have different implications for soil carbon sequestration and fuel consumption, with no-till practices generally resulting in lower carbon intensity compared to conventional tillage.

Irrigation records 1738 are included within the operation record entity 1734 and capture data regarding water application during the growing season. The irrigation records 1738 may capture irrigation method, water source, total water volume applied, and irrigation timing throughout the growing period. The irrigation records 1738 may affect carbon intensity calculations because irrigation requires energy for pumping and distribution, with different irrigation methods and water sources having different carbon intensity implications.

Fertilizer records 1740 are included within the operation record entity 1734 and capture data regarding fertilizer applications during production. The fertilizer records 1740 may capture fertilizer type, nitrogen content, application rate, total quantity applied, and application dates for each fertilizer application event. The fertilizer records 1740 may affect carbon intensity calculations because fertilizer production and application contribute to greenhouse gas emissions, with synthetic nitrogen fertilizers having different carbon intensity implications than organic fertilizers such as manure. The fertilizer records 1740 may include data for both synthetic fertilizers and organic amendments, enabling comprehensive tracking of nutrient inputs that affect carbon intensity.

Chemical treatment records 1742 are included within the operation record entity 1734 and capture data regarding pesticide and herbicide applications during production. The chemical treatment records 1742 may capture product names, active ingredients, application rates, coverage areas, and application dates for each chemical treatment event. The chemical treatment records 1742 may affect carbon intensity calculations because chemical production and application contribute to the overall carbon footprint of agricultural production.

Cover crop records 1744 are included within the operation record entity 1734 and capture data regarding cover crop usage between primary crop seasons. The cover crop records 1744 may capture cover crop species, planting dates, termination dates, and biomass estimates for cover crops planted to protect and improve soil health. The cover crop records 1744 may affect carbon intensity calculations because cover crops may sequester carbon in soil organic matter, potentially reducing the net carbon intensity of agricultural production when cover cropping practices are employed.

As further shown in FIG. 17, a harvest record entity 1746 is included within the canonical data layer 1722 and stores harvest data including yield quantity and yield units for each field and crop year combination. The harvest record entity 1746 may capture total yield, yield units such as bushels or tons, moisture content at harvest, and harvest dates that are used in carbon intensity calculations to determine emissions per unit of output. The harvest record entity 1746 may correspond to the harvest records 1634 stored within the universal data store 1620, providing the production output data that serves as the denominator in carbon intensity calculations expressed as emissions per unit of product.

Provenance tags 1748 are associated with each canonical entity within the canonical data layer 1722 and indicate the ingestion method by which the agricultural operation data was received. The provenance tags 1748 may indicate whether data was received through manual entry via a user interface, CSV file import, or API integration with an external farm management platform, corresponding to the provenance metadata 1648 described with reference to FIG. 16. The provenance tags 1748 may enable audit trails and data quality assessment by documenting the source and ingestion pathway for each data element, supporting verification activities by certifiers and auditors who may assess data reliability based on ingestion method. Storing provenance metadata with each canonical agricultural operation record enables the platform to maintain transparency regarding data origins and supports compliance with audit requirements for carbon intensity certification programs.

A program template layer 1750 is included within the universal data schema and program template mapping 1720 and contains program-specific template definitions that specify the fields, validations, and mapping rules required for carbon intensity program submissions. The program template layer 1750 may correspond to the template registry 1652 within the program template engine 1650 described with reference to FIG. 16, providing a detailed view of the template structure and mapping relationships that enable auto-population of program forms from canonical data.

A program template object 1752 is included within the program template layer 1750 and defines the structure and requirements for a specific carbon intensity program submission. The program template object 1752 may correspond to the 45Z program template 1654 described with reference to FIG. 16, illustrating the template components using the 45Z program as an example while supporting multiple program templates that may have different field requirements and mapping rules. The program template object 1752 may be retrieved by the program template engine 1650 when a user selects a program for submission, triggering form creation and auto-population from the canonical data stored in the universal data store 1620.

Required fields 1754 are included within the program template object 1752 and specify which data elements must be populated for valid submission to the carbon intensity program. The required fields 1754 may correspond to the required fields 1656 within the 45Z program template 1654 described with reference to FIG. 16, defining the mandatory data elements that the program template engine 1650 must ensure are present before allowing submission. The required fields 1754 may include field acreage, crop type, tillage practice, fertilizer application data, and harvest yield data that are required for carbon intensity calculations under the applicable program rules.

Optional fields 1756 are included within the program template object 1752 and specify data elements that may be populated if applicable to the specific farming operation but are not required for valid submission. The optional fields 1756 may include data elements that provide additional detail or that apply only to certain farming practices, enabling farmers to provide comprehensive data when available without blocking submission when optional data is not applicable. The optional fields 1756 may enable more precise carbon intensity calculations when populated while allowing submission with baseline calculations when optional data is not provided.

Conditional dependencies 1758 are included within the program template object 1752 and specify fields that are required based on values of predicate fields within the submission. The conditional dependencies 1758 may correspond to the conditional dependencies 1658 within the 45Z program template 1654 described with reference to FIG. 16, defining the dependency relationships that cause additional fields to become required when predicate fields take particular values. For example, when a predicate field indicating manure application takes a value indicating that manure was applied, the conditional dependencies 1758 may specify that manure type and total manure pounds fields become required, and the program template engine 1650 may compute a per-acre manure rate from the entered values and the field acreage. The program template engine 1650 may detect a value of a predicate field in the auto-populated required fields and, in response to detecting the value, prompt for entry of one or more additional fields specified by the conditional dependencies 1758. The conditional dependencies 1758 may be described as the rendering of underlying validation rules and dependency constraints in the template, enabling dynamic form behavior that adapts to the specific practices employed by each farmer.

Computed field definitions 1760 are included within the program template object 1752 and specify derived values that are calculated from input fields rather than entered directly by users. The computed field definitions 1760 may correspond to the computed field definitions 1662 within the 45Z program template 1654 described with reference to FIG. 16, defining the calculation rules that the program template engine 1650 applies to generate derived values from the auto-populated required fields. The program template engine 1650 may calculate derived values for computed fields based on the auto-populated required fields, ensuring accuracy and consistency in computed metrics used for carbon intensity calculations. The derived values may comprise at least one of a per-acre application rate derived from a total application amount and a field acreage, or a yield rate derived from a total yield and the field acreage. For example, a gallons-per-acre irrigation rate may be derived from total irrigation gallons and field acreage stored in the field entity 1728, and a bushels-per-acre yield rate may be derived from total harvest yield stored in the harvest record entity 1746 and field acreage. The computed field definitions 1760 may enable the program template engine 1650 to automatically calculate normalized metrics that are required for carbon intensity calculations without requiring farmers to perform manual calculations.

With continued reference to FIG. 17, mapping arrows 1762 connect canonical entities in the canonical data layer 1722 to corresponding fields in the program template layer 1750, illustrating the auto-population relationships that enable the program template engine 1650 to populate program forms from canonical data. The mapping arrows 1762 may correspond to the mapping rules 1660 within the 45Z program template 1654 described with reference to FIG. 16, providing a visual representation of how data flows from the canonical schema to program-specific fields. The mapping arrows 1762 may illustrate that field acreage from the field entity 1728 maps to an acreage field in the program template object 1752, that crop species from the crop entity 1732 maps to a crop type field, that planting date from the crop year entity 1730 maps to a planting date field, that irrigation totals from the irrigation records 1738 map to irrigation fields, and that fertilizer events from the fertilizer records 1740 map to fertilizer fields. The program template engine 1650 may auto-populate the required fields 1754 by mapping data from the canonical agricultural operation records to the required fields according to the mapping rules defined in the program template, reducing manual data entry and ensuring consistency between the universal data and program submissions.

The program template engine 1650 may enforce unit normalization when processing input data for program submissions, converting data from various units of measure used by different data sources into standard units required by the program template. The unit normalization may convert gallons to liters, pounds to kilograms, acres to hectares, or other unit conversions based on the requirements of the specific program template and the units in which source data was captured. The unit normalization may ensure that data from heterogeneous sources is consistently formatted for carbon intensity calculations regardless of the original units used by each data source.

A validation rules module 1764 is included within the universal data schema and program template mapping 1720 and is communicatively coupled to the program template object 1752 to enforce completeness checks before allowing submission. The validation rules module 1764 may verify that all required fields 1754 are populated with valid values before the submission sealing service 1680 generates a sealed submission record. The validation rules module 1764 may verify that conditional dependencies 1758 are satisfied by checking that fields specified as required based on predicate field values are populated when the predicate conditions are met. The validation rules module 1764 may verify that computed fields defined by the computed field definitions 1760 are correctly derived from their input values, ensuring mathematical accuracy in calculated metrics. The program template engine 1650 may perform completeness checks before allowing submission to ensure all required fields are populated, preventing incomplete submissions that would fail certification review or produce inaccurate carbon intensity calculations. The validation rules module 1764 may generate validation messages that identify specific fields requiring attention, enabling farmers to address data gaps before attempting submission. The validation rules module 1764 may distinguish between blocking validation errors that prevent submission and warning messages that alert users to potential data quality issues without blocking submission.

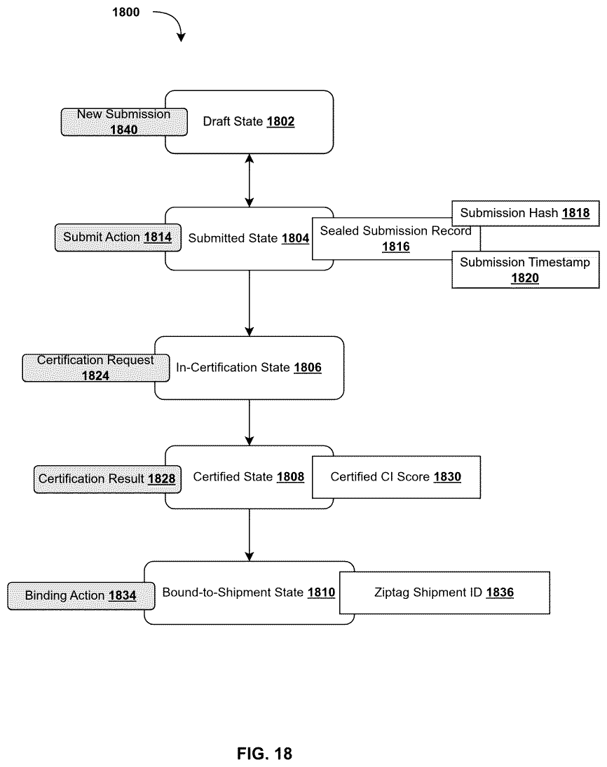

Referring to FIG. 18, a carbon intensity submission lifecycle state machine 1800 is illustrated in accordance with some embodiments of the present disclosure. The carbon intensity submission lifecycle state machine 1800 depicts the various states a carbon intensity submission may occupy and the transitions between states that enforce immutability and audit requirements within the carbon intensity tracking and certification system. The carbon intensity submission lifecycle state machine 1800 may provide a technical framework for managing submission status that distinguishes between editable draft submissions used for what-if planning and sealed submissions that become immutable upon filing, addressing the data lifecycle control problem described previously. The state machine represented by the carbon intensity submission lifecycle state machine 1800 may enforce constraints that ensure submissions progress through defined states in a controlled manner, with each state transition recorded on the distributed ledger network 110 to create an immutable history of the submission lifecycle.

A draft state 1802 represents the initial state where carbon intensity submissions begin upon creation within the ZPTAG platform 1610. In the draft state 1802, the submission is fully editable and supports what-if analysis, enabling farmers to modify any field, adjust practice parameters, and observe how changes affect the estimated carbon intensity score computed by the CI computation service 1670. The draft state 1802 functions as a controlled sandbox for iterative optimization, where farmers can explore how practice changes such as tillage choice, cover crop adoption, or nitrogen adjustments would alter carbon intensity before committing to an official submission. The submission sealing service 1680 is configured to maintain a draft submission in an editable state prior to receiving a submission request, enabling farmers to save work in progress, return to partially completed submissions, and modify data across all sections while the submission remains in the draft state 1802. The draft manager 1682 within the submission sealing service 1680 maintains draft submissions that can be edited, supporting the what-if analysis capability by allowing iterative adjustment and comparison of different practice scenarios before committing to a final submission. The estimated CI calculator 1672 within the CI computation service 1670 computes updated estimated carbon intensity scores in response to modifications to the auto-populated required fields to enable what-if analysis, providing real-time feedback as farmers explore different practice configurations within the draft state 1802.

A first transition 1812 moves a carbon intensity submission from the draft state 1802 to a submitted state 1804 when the farmer initiates a submission request. The first transition 1812 represents the point at which a submission transitions from an editable planning document to an immutable official record that cannot be modified through any interface. The first transition 1812 is triggered by a submit action 1814 initiated by the user through the farmer client device 1602, where the user confirms intent to finalize the submission and proceed with certification. The submit action 1814 may require user authentication and confirmation to prevent accidental submission of incomplete or incorrect data. The submission sealing service 1680 is configured to transition the draft submission to the submitted state 1804 upon generating a sealed submission record, wherein the submitted state 1804 prevents modification of the sealed submission record. The sealing module 1684 within the submission sealing service 1680 ensures that once a report is submitted, the report becomes locked and cannot be edited, requiring a new submission for any subsequent changes.

Upon the submit action 1814, the submission sealing service 1680 generates a sealed submission record 1816 that is immutably anchored to the blockchain or immutable ledger mechanism within the immutable record subsystem 1622. The sealed submission record 1816 comprises the auto-populated required fields from the program template engine 1650 and the estimated carbon intensity score computed by the CI computation service 1670, creating a complete package of the submission data at the time of sealing. The submission sealing service 1680 stores the sealed submission record 1816 in the immutable record subsystem 1622 such that the sealed submission record 1816 cannot be modified after storage, providing cryptographic assurance that the data presented for certification or monetization is the same data that was originally recorded. The submission sealing service 1680 records the sealed submission immutably on a blockchain or immutable ledger mechanism with a submission date, creating a tamper-evident record that supports audit and verification requirements.

The sealed submission record 1816 includes a submission hash 1818 that provides a cryptographic fingerprint of the submission contents. The submission hash 1818 may be computed using a cryptographic hash function that produces a fixed-length output from the submission data, where any modification to the submission data would produce a different hash value. The submission hash 1818 enables verification that the submission contents have not been modified since the hash was computed, supporting integrity verification by certifiers, auditors, and downstream supply chain participants. The submission sealing service 1680 is configured to generate the submission hash 1818 for the sealed submission record 1816, creating the cryptographic binding that enables tamper detection.

The sealed submission record 1816 also includes a submission timestamp 1820 that records when the submission was sealed and recorded on the immutable ledger. The submission timestamp 1820 may capture the date and time when the submit action 1814 was processed by the submission sealing service 1680, providing temporal ordering for audit and compliance purposes. The submission timestamp 1820 enables verification of when submissions were filed, supporting compliance with program deadlines and enabling chronological ordering of multiple submissions from the same farmer or field. The submission sealing service 1680 is configured to generate the submission timestamp 1820 for the sealed submission record 1816 and store the submission hash 1818 and the submission timestamp 1820 in the audit log 1686, creating an auditable record of what was submitted and when.

With continued reference to FIG. 18, the submitted state 1804 indicates that the carbon intensity submission has been sealed and recorded on the immutable ledger, and the submission is now view-only and cannot be modified through the application layer. Once in the submitted state 1804, the submission becomes eligible for transmission to accredited certifiers for review and certification. The submitted state 1804 prevents further modification of the sealed submission record 1816, ensuring that the data reviewed by certifiers is the same data that was originally submitted by the farmer. The user interface presented through the farmer client device 1602 may display the submission in read-only mode when the submission is in the submitted state 1804, preventing any edits to the sealed data while allowing the farmer to view the submission contents and track certification status.

A second transition 1822 moves a carbon intensity submission from the submitted state 1804 to an in-certification state 1806 when the submission is transmitted to an accredited certifier for review. The second transition 1822 is triggered by a certification request 1824 that initiates the certification workflow with external certification entities. The certification request 1824 may be generated automatically by the certification integration service 1690 upon completion of the first transition 1812, or may be triggered by a separate user action requesting certification of a previously submitted record. The certification integration service 1690 coordinates submission to accredited certification firms and tracks certification status and outputs, managing the handoff of sealed packages to external certification entities and monitoring the progress of certification review.

The in-certification state 1806 indicates that the carbon intensity submission is pending review by an accredited certifier and awaiting issuance of a certified carbon intensity score. The in-certification state 1806 may persist for a duration determined by the certification review process, which may vary based on certifier workload, submission complexity, and any requests for additional information or clarification. The certification integration service 1690 may track the status of submissions in the in-certification state 1806, providing visibility to farmers regarding the progress of their certification requests. The certifier handoff module 1694 within the certification integration service 1690 transmits sealed submission packages to the accredited certifiers 1692, formatting packages according to certifier requirements and managing transmission protocols.

A third transition 1826 moves a carbon intensity submission from the in-certification state 1806 to a certified state 1808 when the accredited certifier completes review and issues a certification determination. The third transition 1826 is triggered by a certification result 1828 returned by the accredited certifier, indicating that the certification review has been completed and a certified carbon intensity score has been determined. The certification result 1828 may include the certified carbon intensity score, certifier identification, certification date, and any conditions or limitations associated with the certification. The certified result ingest module 1696 within the certification integration service 1690 receives certified carbon intensity scores from the accredited certifiers 1692, validates received certifications, and associates certified scores with corresponding submission records in the universal data store 1620.

The certification result 1828 includes a certified CI score 1830 that represents the authoritative carbon intensity value determined by the accredited certifier based on review of the sealed submission record 1816. The certified CI score 1830 becomes the official value used for monetization and counterparty transactions, distinguishing the certified result from the estimated carbon intensity score computed by the estimated CI calculator 1672 during the draft state 1802. The certified CI score 1830 may differ from the estimated score if the certifier applies different calculation factors, identifies data quality issues, or applies adjustments based on certification review findings. The certified result ingest module 1696 stores the certified result and binds the certified CI score 1830 to shipments and contracts for monetization purposes, enabling farmers to demonstrate lower carbon intensity that qualifies for premium pricing from buyers such as ethanol plants.

The certified state 1808 indicates that the carbon intensity submission has received certification from an accredited certifier and the certified CI score 1830 is available for use in commercial transactions and program compliance. The certified state 1808 represents a stable state where the submission may remain indefinitely if no shipment binding is required, or may transition to a bound state when the certified credentials are associated with physical shipments. The certified CI score 1830 stored in association with the sealed submission record 1816 may be retrieved by downstream supply chain participants to verify carbon intensity credentials for incoming products.

As further shown in FIG. 18, a fourth transition 1832 moves a carbon intensity submission from the certified state 1808 to a bound-to-shipment state 1810 when the certified carbon intensity credentials are associated with a physical shipment of agricultural product. The fourth transition 1832 is triggered by a binding action 1834 that creates an association between the certified submission and a shipment identifier, enabling verification of carbon credentials at custody transfer points such as co-op receiving facilities. The binding action 1834 may be initiated by the farmer through the farmer client device 1602 when preparing a harvest shipment for delivery to a co-op or processor.

The binding action 1834 associates the certified submission with a ZPTAG shipment identifier 1836 that corresponds to a physical shipment of agricultural product. The ZPTAG shipment identifier 1836 may be implemented as a ZPTAG plate placed on a truck or other transport vessel, enabling scanning at receiving facilities to retrieve the associated carbon intensity credentials. The ZPTAG binding service 1700 creates binding records that link the certified CI score 1830 to the ZPTAG shipment identifier 1836, enabling downstream verification of carbon intensity credentials when the shipment arrives at a receiving facility. The shipment association module 1702 within the ZPTAG binding service 1700 binds certified carbon intensity scores to ZPTAG identifiers, creating the digital-to-physical association that enables verification of carbon credentials for specific shipments.

The bound-to-shipment state 1810 indicates that the carbon intensity credentials have been linked to a physical shipment and are available for verification at custody transfer points throughout the supply chain. The bound-to-shipment state 1810 enables co-ops to scan incoming shipments using the co-op client device 1604, retrieve the certified CI score 1830 associated with the ZPTAG shipment identifier 1836, and route incoming loads to appropriate storage locations based on carbon intensity thresholds. The bound-to-shipment state 1810 supports the commercial value proposition where co-ops can segregate grain into different silos based on carbon intensity bands to avoid averaging higher carbon intensity grain into low carbon intensity lots.

A modification path 1838 is available from any state except the draft state 1802 within the carbon intensity submission lifecycle state machine 1800. The modification path 1838 addresses the constraint that sealed submissions cannot be modified after the first transition 1812, providing a pathway for farmers who need to correct errors or update data after submission. If a farmer needs to modify a submitted, certified, or bound submission, the farmer must create a new submission 1840 that begins in the draft state 1802. The new submission 1840 represents a separate submission record that progresses through the state machine independently of the original submission, enabling the farmer to enter corrected or updated data while preserving the original submission as an immutable historical record. The original submission remains immutable and available for audit purposes, ensuring that the complete history of submissions is preserved even when subsequent submissions supersede earlier records. The modification path 1838 requiring the new submission 1840 for any changes to sealed records ensures that the integrity of the carbon intensity certification system is maintained, as all official submissions are immutably recorded and cannot be retroactively altered.

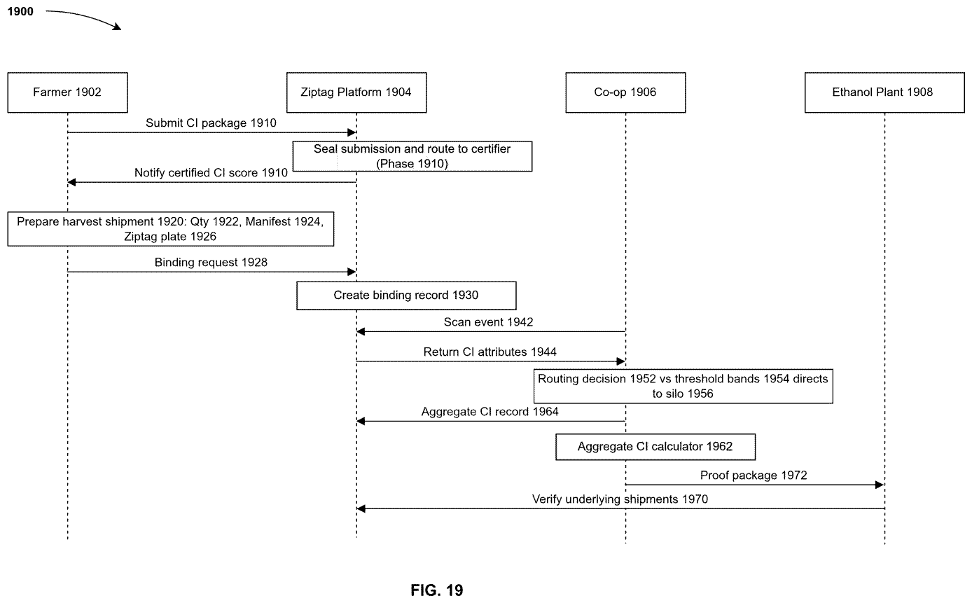

Referring to FIG. 19, a carbon intensity-to-shipment binding and co-op receiving flow 1900 is illustrated in accordance with some embodiments of the present disclosure. The carbon intensity-to-shipment binding and co-op receiving flow 1900 depicts how certified carbon intensity credentials are bound to physical shipments and verified at co-op receiving points to enable silo segregation based on carbon intensity attributes. The carbon intensity-to-shipment binding and co-op receiving flow 1900 may address the digital-to-physical binding problem by creating associations between certified carbon intensity datasets and tagged vessels or manifests, with scanning at handoff points that enables verification of carbon credentials throughout the supply chain. The carbon intensity-to-shipment binding and co-op receiving flow 1900 may support the commercial value proposition where co-ops can segregate grain into different silos based on carbon intensity thresholds to avoid averaging higher carbon intensity grain into low carbon intensity lots, thereby preserving the value of lower carbon intensity feedstocks for downstream buyers such as ethanol producers.

The carbon intensity-to-shipment binding and co-op receiving flow 1900 includes four swim lanes representing the participants involved in the carbon intensity binding and verification workflow. A farmer 1902 represents the agricultural producer who submits carbon intensity packages and prepares harvest shipments for delivery to receiving facilities. The farmer 1902 may correspond to a farmer organization registered within the ZPTAG platform 1610 through the organization onboarding service 1612, operating the farmer client device 1602 to interact with carbon intensity tracking and binding functionality. A ZPTAG platform 1904 represents the server-side infrastructure that implements carbon intensity tracking, certification, and binding functionality, corresponding to the ZPTAG platform 1610 described with reference to FIG. 16. The ZPTAG platform 1904 may host the services that coordinate carbon intensity submissions, certification workflows, binding operations, and scan event processing throughout the carbon intensity-to-shipment binding and co-op receiving flow 1900.

A co-op 1906 represents a cooperative organization that receives agricultural products from multiple farmers and aggregates products for sale to downstream buyers. The co-op 1906 may operate the co-op client device 1604 to perform scan events, retrieve carbon intensity attributes for incoming shipments, and execute routing decisions based on certified carbon intensity scores and configured threshold bands. The co-op 1906 may segregate incoming grain into different silos based on carbon intensity bands to avoid averaging higher carbon intensity grain into low carbon intensity lots, preserving the value differentiation that enables premium pricing for lower carbon intensity feedstocks. An ethanol plant 1908 represents a downstream processor that purchases aggregated lots from the co-op 1906 and values lower carbon intensity feedstocks for maximizing tax credit benefits under programs such as 45Z. The ethanol plant 1908 may operate the processor client device 1606 to verify carbon intensity credentials associated with purchased lots and to access proof packages that document the carbon intensity provenance of aggregated shipments.

With continued reference to FIG. 19, a first phase 1910 represents the initial stage of the carbon intensity-to-shipment binding and co-op receiving flow 1900 where the farmer 1902 submits a carbon intensity package to the ZPTAG platform 1904 for certification. During the first phase 1910, the farmer 1902 may submit a CI package through the farmer client device 1602, initiating the certification workflow described with reference to the carbon intensity submission lifecycle state machine 1800 in FIG. 18. The ZPTAG platform 1904 may seal the submission through the submission sealing service 1680, generating the sealed submission record 1816 that is stored in the immutable record subsystem 1622. The ZPTAG platform 1904 may route the sealed submission to an accredited certifier through the certification integration service 1690, transmitting the sealed submission record to the accredited certifier for review. The accredited certifier may review the submission and return a certified carbon intensity score to the ZPTAG platform 1904, which stores the certified result in association with the sealed submission record through the certified result ingest module 1696. The ZPTAG platform 1904 may notify the farmer 1902 that certification is complete and the certified CI score 1830 is available for binding to shipments.

A second phase 1920 represents the stage of the carbon intensity-to-shipment binding and co-op receiving flow 1900 where the farmer 1902 prepares a harvest shipment and associates the certified carbon intensity credentials with the physical shipment. During the second phase 1920, the farmer 1902 may prepare a harvest shipment by associating a harvest quantity 1922 from a specific field and harvest with a truckload manifest 1924 that documents the shipment contents. The harvest quantity 1922 may correspond to the yield data stored in the harvest records 1634 within the universal data store 1620, specifying the amount of agricultural product being shipped from the certified field and crop year. The truckload manifest 1924 may capture shipment details including the quantity 1922, the field and harvest association, the destination co-op facility, and the transport vehicle identification.

The farmer 1902 may attach a ZPTAG plate 1926 to the truck or transport vessel, creating a physical identifier that can be scanned at receiving facilities to retrieve the associated carbon intensity credentials. The ZPTAG plate 1926 may be implemented as a durable tag suitable for attachment to agricultural transport vehicles, encoding a unique identifier that links the physical shipment to the digital carbon intensity records stored on the ZPTAG platform 1904. The farmer 1902 may initiate a binding request 1928 through the farmer client device 1602, requesting that the ZPTAG platform 1904 create an association between the certified carbon intensity submission and the ZPTAG plate 1926 identifier. The binding request 1928 may specify the certified submission to be bound, the ZPTAG plate 1926 identifier, and the harvest quantity 1922 being shipped.

The ZPTAG platform 1904 may process the binding request 1928 through the ZPTAG binding service 1700, which creates a binding record 1930 linking the certified CI submission to the ZPTAG plate 1926 identifier. The ZPTAG binding service 1700 creates binding records that associate a certified CI dataset to a tagged vessel or manifest with scanning at handoff points, enabling downstream verification of carbon intensity credentials when the shipment arrives at receiving facilities. The shipment association module 1702 within the ZPTAG binding service 1700 may create the binding record 1930 that associates the sealed submission record with a shipment identifier to link the carbon intensity submission to a physical shipment of agricultural product. The binding record 1930 may be stored in the immutable record subsystem 1622, creating a tamper-evident association between the certified carbon intensity credentials and the physical shipment that can be verified throughout the supply chain.

As further shown in FIG. 19, a third phase 1940 represents the stage of the carbon intensity-to-shipment binding and co-op receiving flow 1900 where the shipment arrives at the co-op 1906 and a scan event retrieves the associated carbon intensity attributes. During the third phase 1940, the truck bearing the ZPTAG plate 1926 arrives at the co-op 1906 receiving facility. A co-op operator may perform a scan event 1942 by scanning the ZPTAG plate 1926 using the co-op client device 1604 or other scanning equipment at the receiving facility. The scan event 1942 may correspond to the shipment identifier encoded in the ZPTAG plate 1926, enabling the ZPTAG platform 1904 to retrieve the associated carbon intensity credentials.

The scan event recorder 1704 within the ZPTAG binding service 1700 may record the scan event 1942 with timestamps at the co-op facility, creating an auditable record of when and where the Cl-bound shipment was received. The scan event recorder 1704 records scan events with timestamps at co-op facilities when zip tags are scanned, supporting audit requirements and providing verification that shipments were received at expected locations and times. The scan event 1942 may be transmitted to the ZPTAG platform 1904, which retrieves the binding record 1930 associated with the scanned ZPTAG plate 1926 identifier.

The ZPTAG platform 1904 may return CI attributes 1944 to the co-op 1906 in response to the scan event 1942. The CI attributes 1944 may include the certified CI score 1830, the submission identifier, and the field and harvest provenance associated with the shipment. The certified carbon intensity score is retrievable upon scanning a tag corresponding to the shipment identifier, enabling the co-op 1906 to access verified carbon intensity credentials for the incoming shipment without requiring manual data entry or paper documentation. The CI attributes 1944 may be displayed on the co-op client device 1604, providing the co-op operator with the information needed to make routing decisions based on the carbon intensity of the incoming load.

A fourth phase 1950 represents the stage of the carbon intensity-to-shipment binding and co-op receiving flow 1900 where the co-op 1906 performs silo routing based on the retrieved carbon intensity attributes. During the fourth phase 1950, a routing decision module 1952 within the co-op receiving systems 1714 may compare the certified CI score 1830 from the CI attributes 1944 against CI threshold bands 1954 configured by the co-op 1906. The CI threshold bands 1954 may define ranges of carbon intensity values that correspond to different storage destinations, enabling the co-op 1906 to segregate incoming grain based on carbon intensity levels. For example, the CI threshold bands 1954 may specify that loads with carbon intensity below a first threshold are routed to a premium low-carbon silo, loads with carbon intensity between the first threshold and a second threshold are routed to a standard silo, and loads with carbon intensity above the second threshold are routed to a separate silo to avoid contaminating lower carbon intensity inventory.

The routing decision module 1952 routes inbound loads into silos based on verified CI attributes supported by scan events and immutable records, ensuring that routing decisions are based on authenticated carbon intensity credentials rather than unverified claims. Based on the comparison between the certified CI score 1830 and the CI threshold bands 1954, the routing decision module 1952 may direct the load to an appropriate silo 1956 within the co-op facility. The routing decision may be communicated to the co-op operator through the co-op client device 1604, indicating which silo 1956 should receive the incoming load. The co-op receiving systems 1714 may segregate grain into different silos based on CI thresholds to avoid averaging higher CI grain into low CI lots, preserving the value differentiation that enables premium pricing for lower carbon intensity feedstocks when selling to downstream buyers such as the ethanol plant 1908. The routing of the physical shipment of agricultural product to a storage location based on the certified carbon intensity score enables the co-op 1906 to maintain segregated inventory pools with known carbon intensity characteristics.

With continued reference to FIG. 19, a fifth phase 1960 represents the stage of the carbon intensity-to-shipment binding and co-op receiving flow 1900 where the co-op 1906 aggregates multiple loads into a silo lot and computes aggregate carbon intensity for the combined inventory. During the fifth phase 1960, an aggregate CI calculator 1962 within the co-op receiving systems 1714 may compute a weighted average carbon intensity for the aggregated lot based on the individual certified CI scores and quantities of each contributing load. The aggregate CI calculator 1962 computes precise average CI for aggregated lots because the system retains CI values per inbound load and provides proof for the aggregated value, enabling accurate carbon intensity tracking even when products from multiple sources are combined in common storage.

The aggregate CI calculator 1962 may access the binding records 1930 and Cl attributes 1944 for all loads that have been routed to a particular silo 1956, retrieving the certified Cl score 1830 and harvest quantity 1922 for each contributing shipment. The aggregate CI calculator 1962 may compute a quantity-weighted average of the individual carbon intensity scores, producing an aggregate carbon intensity value that reflects the combined characteristics of all contributing loads. The ZPTAG platform 1904 may store an aggregate CI record 1964 that captures the computed aggregate carbon intensity value along with provenance links to all contributing shipments. The aggregate CI record 1964 may include identifiers for each binding record 1930 that contributed to the aggregated lot, enabling downstream verification of the underlying shipments that comprise the aggregate.

A sixth phase 1970 represents the stage of the carbon intensity-to-shipment binding and co-op receiving flow 1900 where the co-op 1906 sells the aggregated lot to the ethanol plant 1908 and provides verification of the carbon intensity credentials. During the sixth phase 1970, the co-op 1906 may verify underlying shipments that comprise the aggregated lot being sold to the ethanol plant 1908. The co-op 1906 may provide a proof package 1972 to the ethanol plant 1908 that contains the aggregate carbon intensity score and provenance links to all contributing shipments. The proof package 1972 contains verification of underlying shipments that the co-op can provide when selling aggregated lots to ethanol plants, enabling the ethanol plant 1908 to verify the carbon intensity credentials of purchased feedstocks.

The proof package 1972 may include the aggregate CI record 1964, the binding records 1930 for each contributing shipment, the certified CI scores 1830 for each contributing farmer submission, and the scan event records documenting receipt of each shipment at the co-op facility. The ethanol plant 1908 may query the ZPTAG platform 1904 to verify the underlying shipment records referenced in the proof package 1972, confirming that the aggregate carbon intensity value is accurately computed from authenticated source data. The ethanol plant 1908 may use the verified carbon intensity credentials to support tax credit claims under programs such as 45Z, where lower carbon intensity feedstocks result in higher credit values. The proof package 1972 may be stored on the distributed ledger network 110, creating an immutable record of the carbon intensity provenance that supports audit and compliance requirements for carbon incentive programs.

The carbon intensity-to-shipment binding and co-op receiving flow 1900 enables end-to-end verification of carbon intensity credentials from farmer submission through co-op aggregation to ethanol plant purchase. The ZPTAG binding service 1700 associates the sealed submission record with a shipment identifier to bind the carbon intensity submission to a physical agricultural product shipment, creating the digital-to-physical association that enables verification at each custody transfer point. The certified carbon intensity score is stored in association with the sealed submission record and is retrievable upon scanning a tag corresponding to the shipment identifier, enabling automated retrieval of carbon credentials without manual data entry. In response to a scan event corresponding to the shipment identifier, the ZPTAG platform 1904 returns the certified carbon intensity score to enable routing of the physical agricultural product shipment based on the certified carbon intensity score, supporting segregation and aggregation workflows that preserve carbon intensity value throughout the supply chain.

In some embodiments, the platform maintains a mapping between GS1 identifiers printed on product packaging and corresponding ZPTAG authentication tag identifiers stored on the blockchain. GS1 identifiers may include Global Trade Item Numbers (GTINs), Universal Product Codes (UPCs), or GS1-128 barcodes that are printed on product packaging as part of standard retail labeling practices. When a ZPTAG authentication tag is activated and associated with a product that bears a GS1 identifier, the platform records the association between the GS1 identifier and the ZPTAG identifier in the master blockchain 114, creating a mapping that links the standard retail barcode to the ZPTAG traceability record. This GS1-to-ZPTAG mapping enables the platform to track product sales and update tag lifecycle states even when products are purchased at retail locations that do not participate in the ZPTAG scanning workflow described herein.

When a product is purchased at a retail location that does not use ZPTAG scanning, the point-of-sale system scans the GS1 barcode as part of the standard checkout process. The platform receives the GS1 scan event through integration with the retailer's point-of-sale system or inventory management system via the API integration layer 150 described with reference to FIG. 1. The platform cross-references the scanned GS1 identifier against the stored GS1-to-ZPTAG mapping to identify the corresponding ZPTAG authentication tag. Upon identifying the corresponding ZPTAG tag, the platform deactivates the identified tag by transitioning the tag from the active state 620 to the deactivated state 630 and updates the platform's inventory records to reflect the sale. This GS1 integration pathway enables the platform to maintain accurate inventory tracking and tag lifecycle management across retail environments that use standard GS1-based checkout systems without requiring those retailers to adopt ZPTAG-specific scanning equipment or workflows.

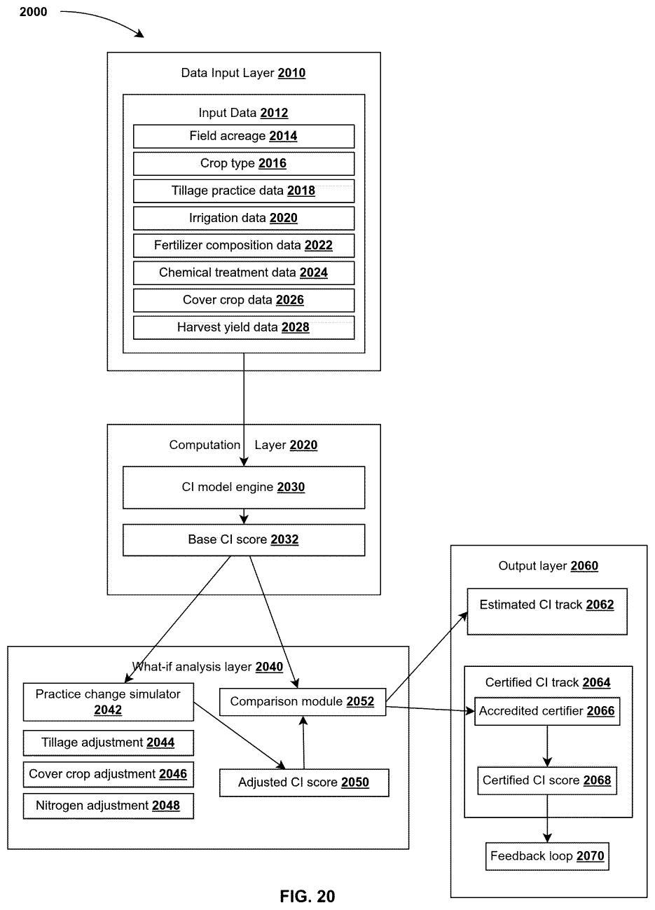

Referring to FIG. 20, a carbon intensity computation and what-if analysis pipeline 2000 is illustrated in accordance with some embodiments of the present disclosure. The carbon intensity computation and what-if analysis pipeline 2000 depicts the dual-track computation architecture that supports both estimated carbon intensity scores for planning purposes and certified carbon intensity scores for monetization through accredited certification. The carbon intensity computation and what-if analysis pipeline 2000 may provide a technical framework for enabling farmers to explore how practice changes would affect carbon intensity scores before committing to official submissions, while also supporting the certification workflow that produces authoritative carbon intensity values for commercial transactions and incentive program compliance. The carbon intensity computation and what-if analysis pipeline 2000 may interface with the CI computation service 1670 described with reference to FIG. 16, providing a detailed view of the data flows and processing stages that transform agricultural operation data into carbon intensity scores suitable for planning and monetization purposes.

A data input layer 2010 is included within the carbon intensity computation and what-if analysis pipeline 2000 and receives agricultural operation data from the universal data store 1620 for processing through the carbon intensity calculation stages. The data input layer 2010 may serve as the entry point for data flowing into the carbon intensity computation pipeline, aggregating the canonical agricultural operation records that have been normalized through the ingestion layer 1640 and stored according to the canonical data schema described with reference to FIG. 17. The data input layer 2010 may retrieve data associated with specific field and crop year combinations, enabling carbon intensity calculations to be scoped to particular production contexts. The data input layer 2010 may validate that required data elements are present before proceeding with carbon intensity calculations, ensuring that calculations are based on complete input datasets.

Input data 2012 is received by the data input layer 2010 and comprises the agricultural operation data elements required for carbon intensity calculations. The input data 2012 may correspond to the operation records 1632 and harvest records 1634 stored within the universal data store 1620, providing the raw data values that are processed through the carbon intensity computation stages. The input data 2012 may include multiple categories of agricultural operation data that collectively characterize the farming practices and production outcomes for a specific field and crop year combination.

Field acreage 2014 is included within the input data 2012 and captures the size of the agricultural field for which carbon intensity is being calculated. The field acreage 2014 may correspond to the acreage attribute stored within the field entity 1728 described with reference to FIG. 17, providing the area measurement that serves as a basis for per-acre calculations and yield rate determinations. The field acreage 2014 may be used by the carbon intensity computation stages to normalize total application amounts and production quantities into per-acre metrics that enable comparison across fields of different sizes.

A crop type 2016 is included within the input data 2012 and captures the species and variety of crop produced on the field during the crop year. The crop type 2016 may correspond to the crop species and variety information stored within the crop entity 1732 described with reference to FIG. 17, providing the crop identification that enables application of crop-specific calculation factors within the carbon intensity computation. Different crop types may have different baseline carbon intensity values and may respond differently to various agricultural practices, and the crop type 2016 enables the computation stages to apply appropriate factors based on the specific crop being produced.

Tillage practice data 2018 is included within the input data 2012 and captures information regarding tillage methods employed during field preparation and cultivation. The tillage practice data 2018 may correspond to the tillage records 1736 stored within the operation record entity 1734 described with reference to FIG. 17, capturing tillage type such as no-till, reduced till, or conventional tillage along with tillage dates and equipment information. The tillage practice data 2018 may affect carbon intensity calculations because different tillage practices have different implications for soil carbon sequestration and fuel consumption, with no-till practices generally resulting in lower carbon intensity compared to conventional tillage methods.

With continued reference to FIG. 20, irrigation data 2020 is included within the input data 2012 and captures information regarding water application during the growing season. The irrigation data 2020 may correspond to the irrigation records 1738 stored within the operation record entity 1734 described with reference to FIG. 17, capturing irrigation method, water source, total water volume applied, and irrigation timing throughout the growing period. The irrigation data 2020 may affect carbon intensity calculations because irrigation requires energy for pumping and distribution, with different irrigation methods and water sources having different carbon intensity implications based on energy consumption and water transport requirements.

Fertilizer composition data 2022 is included within the input data 2012 and captures information regarding fertilizer applications during production. The fertilizer composition data 2022 may correspond to the fertilizer records 1740 stored within the operation record entity 1734 described with reference to FIG. 17, capturing fertilizer type, nitrogen content, application rate, total quantity applied, and application dates for each fertilizer application event. The fertilizer composition data 2022 may affect carbon intensity calculations because fertilizer production and application contribute to greenhouse gas emissions, with synthetic nitrogen fertilizers having different carbon intensity implications than organic fertilizers such as manure based on manufacturing emissions and nitrous oxide releases from soil application.

Chemical treatment data 2024 is included within the input data 2012 and captures information regarding pesticide and herbicide applications during production. The chemical treatment data 2024 may correspond to the chemical treatment records 1742 stored within the operation record entity 1734 described with reference to FIG. 17, capturing product names, active ingredients, application rates, coverage areas, and application dates for each chemical treatment event. The chemical treatment data 2024 may affect carbon intensity calculations because chemical production and application contribute to the overall carbon footprint of agricultural production through manufacturing emissions and application energy consumption.

Cover crop data 2026 is included within the input data 2012 and captures information regarding cover crop usage between primary crop seasons. The cover crop data 2026 may correspond to the cover crop records 1744 stored within the operation record entity 1734 described with reference to FIG. 17, capturing cover crop species, planting dates, termination dates, and biomass estimates for cover crops planted to protect and improve soil health. The cover crop data 2026 may affect carbon intensity calculations because cover crops may sequester carbon in soil organic matter, potentially reducing the net carbon intensity of agricultural production when cover cropping practices are employed.

Harvest yield data 2028 is included within the input data 2012 and captures information regarding production output from the field during the crop year. The harvest yield data 2028 may correspond to the harvest record entity 1746 described with reference to FIG. 17, capturing total yield quantity, yield units such as bushels or tons, moisture content at harvest, and harvest dates. The harvest yield data 2028 may serve as the denominator in carbon intensity calculations expressed as emissions per unit of product, enabling determination of carbon intensity scores that reflect the efficiency of production in terms of greenhouse gas emissions per unit of output.

As further shown in FIG. 20, a computation layer 2020 is included within the carbon intensity computation and what-if analysis pipeline 2000 and processes the input data 2012 to compute carbon intensity scores based on the agricultural operation data. The computation layer 2020 may implement the calculation logic that transforms raw agricultural operation data into carbon intensity values expressed as greenhouse gas emissions per unit of output. The computation layer 2020 may correspond to the CI computation service 1670 described with reference to FIG. 16, providing a detailed view of the calculation engine that produces carbon intensity scores for planning and certification purposes.

A CI model engine 2030 is included within the computation layer 2020 and implements carbon intensity calculations consistent with recognized methodologies for carbon intensity measurement. The CI model engine 2030 may use a CI model consistent with the GREET model to calculate carbon intensity scores using the required inputs from the input data 2012, applying calculation factors that convert operational data into carbon equivalent values accounting for emissions associated with each agricultural practice and input. The GREET model, developed by Argonne National Laboratory, provides a framework for calculating lifecycle greenhouse gas emissions for transportation fuels and feedstocks, and the CI model engine 2030 may implement calculations that align with GREET methodology to produce carbon intensity scores suitable for incentive programs such as 45Z that reference GREET-based calculations.

The CI model engine 2030 receives the input data 2012 from the data input layer 2010 and processes the agricultural operation data through calculation stages that account for emissions from various sources. The CI model engine 2030 may calculate emissions associated with fertilizer production and application based on the fertilizer composition data 2022, accounting for manufacturing emissions for synthetic fertilizers and nitrous oxide releases from nitrogen application. The CI model engine 2030 may calculate emissions associated with tillage operations based on the tillage practice data 2018, accounting for fuel consumption during field operations and soil carbon impacts of different tillage methods. The CI model engine 2030 may calculate emissions associated with irrigation based on the irrigation data 2020, accounting for energy consumption for pumping and water distribution. The CI model engine 2030 may calculate carbon sequestration credits based on the cover crop data 2026, accounting for carbon captured in soil organic matter through cover cropping practices.

The CI model engine 2030 computes a base CI score 2032 that represents the carbon intensity of production based on the current agricultural operation data in the input data 2012. The base CI score 2032 may be expressed as greenhouse gas emissions per unit of output, such as grams of carbon dioxide equivalent per bushel of grain or per megajoule of fuel energy content. The base CI score 2032 may serve as the starting point for what-if analysis, representing the carbon intensity that would result from the current farming practices documented in the universal data store 1620. The base CI score 2032 may be computed by aggregating emissions from all sources documented in the input data 2012 and dividing by the production output documented in the harvest yield data 2028, producing a normalized metric that enables comparison across different production scales and contexts.

The what-if analysis layer 2040 is included within the carbon intensity computation and what-if analysis pipeline 2000 and computes alternative carbon intensity scores based on hypothetical practice parameter modifications. The what-if analysis layer 2040 receives the base Cl score 2032 from the computation layer 2020 and applies practice parameter modifications to compute adjusted carbon intensity scores. The what-if analysis layer 2040 maintains the original input data 2012 while applying hypothetical modifications for simulation purposes, preserving the underlying canonical data stored in the universal data store 1620.

A practice change simulator 2042 is included within the what-if analysis layer 2040 and computes carbon intensity scores for different agricultural practice configurations. The practice change simulator 2042 provides interfaces through the farmer client device 1602 that accept practice parameter inputs and return computed carbon intensity scores. The practice change simulator 2042 invokes the CI model engine 2030 with modified practice parameters to compute adjusted carbon intensity scores for each simulated configuration.

A tillage adjustment module 2044 is included within the practice change simulator 2042 and computes carbon intensity scores for different tillage practice configurations. The tillage adjustment module 2044 accepts tillage practice parameters including conventional tillage, reduced till, and no-till, and applies corresponding adjustment factors that account for fuel consumption differences and soil carbon impacts associated with each tillage method.

A cover crop adjustment module 2046 is included within the practice change simulator 2042 and computes carbon intensity scores for different cover crop configurations. The cover crop adjustment module 2046 accepts cover crop parameters including species, planting dates, and termination dates, and applies carbon sequestration factors that account for carbon captured in soil organic matter through cover crop biomass incorporation.

A nitrogen adjustment module 2048 is included within the practice change simulator 2042 and computes carbon intensity scores for different nitrogen fertilizer configurations. The nitrogen adjustment module 2048 accepts nitrogen application parameters including application rates and nitrogen sources, and applies emission factors that account for fertilizer manufacturing emissions and nitrous oxide releases from soil application.

With continued reference to FIG. 20, the practice change simulator 2042 invokes the CI model engine 2030 for each simulated practice change to compute an adjusted CI score 2050 that reflects the hypothetical practice configuration. The adjusted CI score 2050 may represent the carbon intensity that would result if the simulated practice changes were implemented, enabling farmers to quantify the potential carbon intensity improvements achievable through specific practice modifications. The practice change simulator 2042 may compute multiple adjusted CI scores 2050 for different practice change scenarios, enabling farmers to compare the carbon intensity impacts of various practice modification options.

A comparison module 2052 is included within the what-if analysis layer 2040 and displays the base CI score 2032 alongside one or more adjusted CI scores 2050. The comparison module 2052 retrieves historical certified CI scores 1830 from the master blockchain 114 and displays them alongside current estimated scores. The comparison module 2052 renders carbon intensity values in tabular or graphical formats through the farmer client device 1602, presenting the base CI score 2032, the adjusted CI scores 2050 for various scenarios, and historical certified Cl scores 1830 in a unified display.

An output layer 2060 is included within the carbon intensity computation and what-if analysis pipeline 2000 and provides the computed carbon intensity scores through two distinct output tracks that serve different purposes within the carbon intensity tracking and certification system. The output layer 2060 may route carbon intensity scores to appropriate destinations based on whether the scores are intended for planning purposes or for official certification and monetization.

An estimated CI track 2062 is included within the output layer 2060 and delivers computed carbon intensity scores to the farmer client device 1602 for display. The estimated CI track 2062 delivers the base CI score 2032 and the adjusted CI scores 2050 to the farmer dashboard. The estimated CI track 2062 updates displayed carbon intensity scores when the farmer modifies input data or practice parameters through the what-if analysis layer 2040. The estimated CI track 2062 does not require external certification and the scores produced through the estimated CI track 2062 are not used for monetization or official program compliance.

A certified CI track 2064 is included within the output layer 2060 and provides the pathway for obtaining authoritative carbon intensity scores through external certification for monetization and program compliance purposes. The certified CI track 2064 may route sealed submission records from the submission sealing service 1680 to external certification entities for review and certification. The certified CI track 2064 may correspond to the certification integration service 1690 described with reference to FIG. 16, implementing the certification workflow that produces official carbon intensity values suitable for commercial transactions and incentive program claims.

An accredited certifier 2066 is included within the certified CI track 2064 and represents the external certification entity that reviews sealed submission packages and issues certified carbon intensity determinations. The accredited certifier 2066 may correspond to the accredited certifiers 1692 described with reference to FIG. 16, representing third-party certification firms authorized to verify carbon intensity claims for incentive programs such as 45Z. The accredited certifier 2066 may review the sealed submission record 1816 transmitted through the certifier handoff module 1694, verifying the accuracy and completeness of the agricultural operation data and applying certification standards to determine the official carbon intensity value.

The accredited certifier 2066 produces a certified CI score 2068 that represents the authoritative carbon intensity value determined through the certification review process. The certified CI score 2068 may correspond to the certified CI score 1830 described with reference to FIG. 18, representing the official value used for monetization and counterparty transactions. The certified CI score 2068 may differ from the estimated carbon intensity scores produced through the estimated CI track 2062 if the accredited certifier 2066 applies different calculation factors, identifies data quality issues, or applies adjustments based on certification review findings. The certified CI score 2068 may be returned to the ZPTAG platform 1610 through the certified result ingest module 1696 and stored in association with the sealed submission record 1816 for retrieval during shipment binding and verification activities.

A feedback loop 2070 is included within the carbon intensity computation and what-if analysis pipeline 2000 and connects the certified CI track 2064 to the what-if analysis layer 2040. The feedback loop 2070 retrieves historical certified CI scores 2068 from the master blockchain 114 and provides them to the comparison module 2052 for display alongside current estimated scores. The feedback loop 2070 enables the comparison module 2052 to display comparisons between current estimates and prior certified results across multiple crop years.

Referring to FIG. 21, an exemplary computing device 2100 is illustrated in accordance with some embodiments of the present disclosure. The exemplary computing device 2100 may be used to implement any of the nodes 110N within the distributed ledger network 110, the consumer devices 130, the stakeholder devices 140, the farmer client device 1602, the co-op client device 1604, the processor client device 1606, or servers that host components of the ZPTAG platform 1610. The exemplary computing device 2100 may provide the hardware and software infrastructure that enables participation in the traceability platform, execution of smart contracts, storage of blockchain data, and interaction with user interfaces for product verification, compliance tracking, and carbon intensity management. The exemplary computing device 2100 may be configured differently depending on the role the device serves within the system architecture 100, with nodes requiring blockchain storage and consensus capabilities, client devices requiring user interface and scanning capabilities, and servers requiring high-throughput processing and network connectivity.

A processor 2110 is included within the exemplary computing device 2100 and executes instructions to perform the various functions described throughout the present disclosure. The processor 2110 may include one or more central processing units (CPUs) that execute general-purpose instructions for application logic, operating system functions, and data processing operations. The processor 2110 may include one or more graphics processing units (GPUs) that accelerate cryptographic operations, hash calculations, and other computationally intensive tasks associated with blockchain validation and smart contract execution. The processor 2110 may include specialized processing components such as cryptographic accelerators that perform digital signature generation and verification, hash computation, and encryption operations with improved performance compared to general-purpose processors. The processor 2110 may execute instructions stored in a memory 2120 to implement the consumer application 132, the stakeholder application 142, the consensus module 2174, the smart contract engine 2176, and other software components that enable participation in the traceability platform. The processor 2110 may support multi-threaded execution that enables concurrent processing of multiple transactions, verification requests, and user interface operations.

The memory 2120 is included within the exemplary computing device 2100 and stores instructions and data for execution by the processor 2110. The memory 2120 includes volatile memory such as random access memory (RAM) 2122 that provides high-speed storage for actively executing programs and data being processed. The RAM 2122 may store currently executing application code, blockchain state data being validated, smart contract execution contexts, and user interface elements being rendered. The memory 2120 may include non-volatile memory such as read-only memory (ROM) 2124 that stores firmware, boot code, and other instructions that persist when power is removed from the exemplary computing device 2100. The ROM 2124 may store cryptographic keys, device identifiers, and configuration parameters that are established during device manufacturing or initial setup. The memory 2120 may be organized into separate regions for different purposes, with protected regions storing cryptographic keys and sensitive data, and shared regions storing application data and cached blockchain records.

A storage device 2130 is included within the exemplary computing device 2100 and provides non-volatile storage for persistent data that must be retained across power cycles and system restarts. The storage device 2130 may include hard disk drives that provide high-capacity storage at lower cost per gigabyte, solid-state drives that provide faster access times and improved durability compared to mechanical drives, or other persistent storage technologies appropriate to the device form factor and performance requirements. The storage device 2130 may store a blockchain copy 2132 containing a local copy of the distributed ledger maintained by the distributed ledger network 110. The blockchain copy 2132 may include the complete transaction history recorded on the master blockchain 114, enabling the exemplary computing device 2100 to validate transactions, verify product authenticity, and retrieve traceability records without requiring network queries for each operation. The blockchain copy 2132 may be synchronized with other nodes 110N within the distributed ledger network 110 through the consensus module 2174, ensuring that the local copy remains consistent with the authoritative ledger state.

The storage device 2130 may also store application data 2134 including product records, user preferences, transaction history, and cached data that supports application functionality. The application data 2134 may include the purchase history database 1186 that maintains records of consumer purchases for recall notification purposes. The application data 2134 may include the tag inventory 1232 that tracks tags assigned to stakeholder organizations. The application data 2134 may include the universal data store 1620 contents for devices that implement carbon intensity tracking functionality. The application data 2134 may include configuration settings, user credentials, and session data that personalize the application experience for individual users. The storage device 2130 may implement encryption for sensitive data stored in the application data 2134, protecting user credentials, cryptographic keys, and personal information from unauthorized access.

With continued reference to FIG. 21, a network interface 2140 is included within the exemplary computing device 2100 and enables communication with other devices over networks. The network interface 2140 may include multiple interface types that support different network technologies, enabling the exemplary computing device 2100 to connect to the network 120 and the distributed ledger network 110 through various connectivity options depending on availability and performance requirements. The network interface 2140 enables the exemplary computing device 2100 to participate in the distributed ledger network 110, communicate with the ZPTAG platform 1610, and exchange data with other system components including the API gateway 1410, the accredited certifiers 1712, and the co-op receiving systems 1714.

An Ethernet 2142 interface is included within the network interface 2140 and provides wired network connectivity through physical cable connections. The Ethernet 2142 interface supports various Ethernet standards including 100 Mbps, 1 Gbps, and 10 Gbps connections depending on the device capabilities and network infrastructure. The Ethernet 2142 interface connects devices deployed in fixed locations such as servers, desktop computers, and point-of-sale terminals to local area networks.

A Wi-Fi 2144 interface is included within the network interface 2140 and provides wireless network connectivity through local area wireless networks. The Wi-Fi 2144 interface supports various Wi-Fi standards including 802.11n, 802.11ac, and 802.11ax. The Wi-Fi 2144 interface connects mobile devices, tablets, and laptops to wireless access points without physical cable connections. The consumer devices 130 use the Wi-Fi 2144 interface to connect to retail store networks for product scanning and verification, and the stakeholder devices 140 use the Wi-Fi 2144 interface to connect to facility networks for compliance tracking and tag management operations.

A cellular 2146 interface is included within the network interface 2140 and provides wireless network connectivity through cellular data networks. The cellular 2146 interface supports various cellular standards including 4G LTE and 5G. The cellular 2146 interface connects mobile devices operating in locations without Wi-Fi coverage, agricultural equipment 1422 operating in rural areas, and IoT sensors 1424 deployed in remote locations. The farmer client device 1602 uses the cellular 2146 interface to submit carbon intensity data from field locations, and the scan event recorder 1704 uses the cellular 2146 interface to capture scan events at co-op receiving facilities.

A Bluetooth 2148 interface is included within the network interface 2140 and provides short-range wireless connectivity for communication with nearby devices and peripherals. The Bluetooth 2148 interface supports various Bluetooth standards including Bluetooth Classic and Bluetooth Low Energy. The Bluetooth 2148 interface connects to peripherals such as barcode scanners, RFID readers, and external sensors. The Bluetooth 2148 interface communicates with the IoT sensors 1424 that capture temperature, humidity, and location data during product transportation and storage.

As further shown in FIG. 21, an input/output interface 2150 is included within the exemplary computing device 2100 and connects to user input devices, display devices, and external sensors. The input/output interface 2150 includes multiple interface types that support different input and output modalities. The input/output interface 2150 configuration varies depending on the device form factor and intended use, with consumer devices including display and camera interfaces, and stakeholder devices including interfaces for operational equipment and sensors.

A display interface 2152 is included within the input/output interface 2150 and drives visual displays for presenting information to users. The display interface 2152 connects to integrated displays on mobile devices and tablets, or connects to external monitors for desktop computers and servers. The display interface 2152 renders the user interface 136 for consumer applications, displaying product information, traceability data, and recall notifications retrieved from the distributed ledger network 110. The display interface 2152 renders the stakeholder interfaces 354 for stakeholder applications, displaying compliance dashboards, tag management interfaces, and reporting outputs.

A camera interface 2154 is included within the input/output interface 2150 and captures images for tag scanning and documentation. The camera interface 2154 connects to integrated cameras on mobile devices and tablets, or connects to external cameras for specialized scanning applications. The camera interface 2154 captures images of QR codes and other visual tags for decoding by the tag decoder 1024 within the scanning module 1022. The camera interface 2154 captures photographs of products, facilities, and documentation for storage as supporting evidence within the traceability records on the master blockchain 114.

An audio interface 2156 is included within the input/output interface 2150 and generates auditory output for feedback and notifications. The audio interface 2156 drives integrated speakers on mobile devices and tablets, or connects to external speakers and headphones. The audio interface 2156 plays confirmation tones generated by the audio feedback module 1028 when products are successfully verified and warning tones when verification fails or when allergen alerts are triggered. The audio interface 2156 plays auditory notifications for recall alerts delivered through the recall notification module 1070.

A sensor interface 2158 is included within the input/output interface 2150 and connects to external sensors that capture environmental and operational data. The sensor interface 2158 connects to temperature sensors, humidity sensors, GPS receivers, accelerometers, and other sensors that provide data relevant to supply chain traceability and compliance verification. The sensor interface 2158 receives data from the IoT sensors 1424 deployed throughout the supply chain, capturing the temperature log data 924 used by the cold chain verification contract 922 to validate transportation conditions. The sensor interface 2158 receives GPS coordinates used by the GPS verification module 1216 to verify that scan events occur at expected facility locations.

A bus 2160 is included within the exemplary computing device 2100 and connects the processor 2110, the memory 2120, the storage device 2130, the network interface 2140, and the input/output interface 2150. The bus 2160 implements various bus architectures including system buses that connect the processor 2110 to the memory 2120, peripheral buses that connect to the storage device 2130 and the input/output interface 2150, and expansion buses for optional components. The bus 2160 supports direct memory access that enables the network interface 2140 and the storage device 2130 to transfer data to and from the memory 2120 without requiring processor intervention for each transfer.

A software layer 2170 executes on the exemplary computing device 2100 and includes software components that implement platform functionality. The software layer 2170 includes multiple software components that implement different aspects of platform functionality, from low-level operating system services to high-level application logic. The software layer 2170 configuration varies depending on the role the exemplary computing device 2100 serves within the system architecture 100, with nodes including consensus and smart contract execution capabilities, and client devices including user interface and scanning capabilities.

An operating system 2172 is included within the software layer 2170 and manages hardware resources, executes applications, and enforces security controls. The operating system 2172 includes process management services that execute multiple applications and background services concurrently. The operating system 2172 includes memory management services that allocate memory to applications and protect application memory spaces from unauthorized access. The operating system 2172 includes file system services that organize data storage on the storage device 2130 and enforce access controls for sensitive data. The operating system 2172 includes network services that manage connections through the network interface 2140 and implement network protocols. The operating system 2172 may be implemented using various operating system platforms including Linux, Windows, macOS, iOS, or Android depending on the device form factor and intended use.

A consensus module 2174 is included within the software layer 2170 and operates as a node in the distributed ledger network 110, validating transactions and participating in block generation. The consensus module 2174 implements the consensus mechanisms described with reference to the consensus module 330 in FIG. 3, coordinating agreement among the nodes 110N regarding which transactions should be added to the master blockchain 114. The consensus module 2174 implements a simplified consensus mechanism that does not require computationally intensive proof-of-work calculations. The consensus module 2174 validates incoming transactions by verifying digital signatures, checking transaction formats, and confirming that transactions do not conflict with previously recorded transactions. The consensus module 2174 participates in block generation by proposing new blocks containing validated transactions and voting on blocks proposed by other nodes. The consensus module 2174 synchronizes the blockchain copy 2132 with other nodes 110N.

A smart contract engine 2176 is included within the software layer 2170 and executes smart contract logic for the platform. The smart contract engine 2176 executes the smart contracts 322 within the smart contract layer 320, including the compliance contract 442, the tracking contract 444, the rewards contract 446, and the carbon contract 448 described with reference to FIG. 4. The smart contract engine 2176 isolates smart contract execution from other system processes, preventing smart contracts from accessing unauthorized resources. The smart contract engine 2176 manages smart contract state, reading current state from the state storage 464 and writing updated state after contract execution. The smart contract engine 2176 invokes the directive loaders 324 to query external systems when smart contracts require additional data not present in the immediate transaction context. The smart contract engine 2176 supports the smart contract daisy-chaining 900 described with reference to FIG. 9.

An application layer 2178 is included within the software layer 2170 and implements the consumer application 132 or the stakeholder application 142 functionality depending on the device role. The application layer 2178 implements the consumer application architecture and workflow 1000 described with reference to FIG. 10, including the authentication layer 1010, the core functionality layer 1020, the personalization layer 1040, and the rewards layer 1060 for consumer devices. The application layer 2178 implements the stakeholder application architecture 1200 described with reference to FIG. 12, including the organization management layer 1210, the product management layer 1220, the tag management layer 1230, the compliance management layer 1250, and the reporting layer 1270 for stakeholder devices. The application layer 2178 implements the carbon intensity module functionality described with reference to FIG. 16, including the ingestion layer 1640, the program template engine 1650, the CI computation service 1670, and the submission sealing service 1680 for devices that support carbon intensity tracking. The application layer 2178 interfaces with the blockchain interface 1280 to submit transactions to and retrieve data from the distributed ledger network 110.

The exemplary computing device 2100 may take various form factors depending on the intended use within the system architecture 100. Desktop computers serve as stakeholder devices 140 in office environments. Laptop computers serve as portable stakeholder devices 140 for use at multiple facility locations. Smartphones and tablets serve as consumer devices 130 for product scanning and verification, and serve as farmer client devices 1602 for carbon intensity data entry in field locations. Servers host components of the ZPTAG platform 1610 including the universal data store 1620, the program template engine 1650, and the certification integration service 1690. Specialized embedded devices serve as nodes 110N within the distributed ledger network 110 for blockchain validation and consensus operations. The specific configuration of the processor 2110, the memory 2120, the storage device 2130, the network interface 2140, and the input/output interface 2150 varies across form factors based on performance requirements, power constraints, and physical dimensions appropriate to each device type.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative implementations of the foregoing can be realized without departing from the scope of the claims below. It will be understood that various modifications may be made without departing from the spirit and scope of the disclosure, and accordingly, other implementations are within the scope of the following claims. Certain features and subcombinations may be useful independently and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for agricultural carbon intensity tracking and certification, comprising:
a universal data store configured to store canonical agricultural operation records associated with a plurality of fields, wherein each canonical agricultural operation record comprises at least one of tillage data, irrigation data, fertilizer data, or harvest data;
an ingestion layer communicatively coupled to the universal data store and configured to receive agricultural operation data from a plurality of data sources and normalize the received agricultural operation data into the canonical agricultural operation records;
a program template engine configured to:
retrieve a program template defining required fields and mapping rules for a carbon intensity program; and
auto-populate the required fields by mapping data from the canonical agricultural operation records according to the mapping rules;
a carbon intensity computation service configured to compute an estimated carbon intensity score based on the auto-populated required fields;
a submission sealing service configured to:
receive a submission request for a carbon intensity submission;
generate a sealed submission record comprising the auto-populated required fields and the estimated carbon intensity score; and
store the sealed submission record in an immutable record subsystem such that the sealed submission record cannot be modified after storage; and
a binding service configured to associate the sealed submission record with a shipment identifier corresponding to a physical shipment of agricultural product.

2. The system of claim 1, wherein the ingestion layer comprises:
a manual entry module configured to receive agricultural operation data via a user interface;
a CSV import module configured to receive agricultural operation data from uploaded files; and
an API adapter module configured to receive agricultural operation data from external farm management platforms.

3. The system of claim 2, wherein each canonical agricultural operation record comprises provenance metadata indicating an ingestion method by which the agricultural operation data was received.

4. The system of claim 1, wherein the program template further defines conditional dependencies specifying fields that are required based on values of one or more predicate fields.

5. The system of claim 4, wherein the program template engine is further configured to:
detect a value of a first predicate field of the one or more predicate fields in the auto-populated required fields; and
in response to detecting the value, prompt for entry of one or more additional fields specified by the conditional dependencies.

6. The system of claim 1, wherein the program template further defines computed field definitions, and wherein the program template engine is further configured to calculate derived values for computed fields based on the auto-populated required fields.

7. The system of claim 6, wherein the derived values comprise at least one of a per-acre application rate derived from a total application amount and a field acreage, or a yield rate derived from a total yield and the field acreage.

8. The system of claim 1, further comprising a certification integration service configured to:
transmit the sealed submission record to an accredited certifier;
receive a certified carbon intensity score from the accredited certifier; and
store the certified carbon intensity score in association with the sealed submission record.

9. The system of claim 8, wherein the binding service is further configured to associate the certified carbon intensity score with the shipment identifier such that a scan of a tag corresponding to the shipment identifier retrieves the certified carbon intensity score.

10. The system of claim 1, wherein the submission sealing service is further configured to:
maintain a draft submission in an editable state prior to receiving the submission request; and
transition the draft submission to a submitted state upon generating the sealed submission record, wherein the submitted state prevents modification of the sealed submission record.

11. The system of claim 10, wherein the submission sealing service is further configured to generate a submission hash and a submission timestamp for the sealed submission record, and store the submission hash and the submission timestamp in an audit log.

12. A method for managing carbon intensity data in an agricultural supply chain, comprising:
receiving, by an ingestion layer, agricultural operation data from a plurality of data sources associated with one or more agricultural fields;
normalizing, by the ingestion layer, the agricultural operation data into canonical agricultural operation records stored in a universal data store;
retrieving, by a program template engine, a program template defining required fields and conditional dependencies for a carbon intensity program;
auto-populating, by the program template engine, the required fields by mapping data from the canonical agricultural operation records to the required fields according to mapping rules defined in the program template;
computing, by a carbon intensity computation service, an estimated carbon intensity score based on the auto-populated required fields;
receiving a submission request to transition a carbon intensity submission from a draft state to a submitted state;
in response to the submission request, generating a sealed submission record comprising the auto-populated required fields and storing the sealed submission record in an immutable record subsystem; and
associating, by a binding service, the sealed submission record with a shipment identifier to link the carbon intensity submission to a physical shipment of agricultural product.

13. The method of claim 12, wherein receiving agricultural operation data from the plurality of data sources comprises receiving agricultural operation data via at least one of manual entry through a user interface, CSV file import, or API integration with an external farm management platform.

14. The method of claim 13, further comprising storing provenance metadata with each canonical agricultural operation record, wherein the provenance metadata indicates an ingestion method by which the agricultural operation data was received.

15. The method of claim 12, further comprising:
detecting a value of a predicate field in the auto-populated required fields;
determining, based on the conditional dependencies, that one or more additional fields are required in response to the value; and
prompting for entry of the one or more additional fields.

16. The method of claim 12, further comprising:
transmitting the sealed submission record to an accredited certifier;
receiving a certified carbon intensity score from the accredited certifier; and
storing the certified carbon intensity score in association with the sealed submission record, wherein the certified carbon intensity score is retrievable upon scanning a tag corresponding to the shipment identifier.

17. The method of claim 16, further comprising:
receiving a scan event at a co-op facility, wherein the scan event corresponds to the shipment identifier;
retrieving the certified carbon intensity score associated with the shipment identifier; and
routing the physical shipment of agricultural product to a storage location based on the certified carbon intensity score.

18. A non-transitory computer-readable medium storing instructions that, when executed by one or more processors, cause the one or more processors to perform operations comprising:
storing canonical agricultural operation records in a universal data store, wherein the canonical agricultural operation records are normalized from agricultural operation data received from a plurality of heterogeneous data sources;
retrieving a program template defining required fields for a carbon intensity program submission;
auto-populating the required fields by mapping data from the canonical agricultural operation records according to mapping rules defined in the program template;
computing an estimated carbon intensity score based on the auto-populated required fields;
in response to a submission request, generating a sealed submission record and storing the sealed submission record in an immutable record subsystem to prevent modification of the sealed submission record; and
associating the sealed submission record with a shipment identifier to bind the carbon intensity submission to a physical agricultural product shipment.

19. The non-transitory computer-readable medium of claim 18, wherein the operations further comprise:
maintaining a draft submission in an editable state that permits modification of the auto-populated required fields;
computing updated estimated carbon intensity scores in response to modifications to the auto-populated required fields to enable what-if analysis; and
transitioning the draft submission to a submitted state upon receiving the submission request, wherein the submitted state prevents further modification.

20. The non-transitory computer-readable medium of claim 19, wherein the operations further comprise:
transmitting the sealed submission record to an accredited certifier;
receiving a certified carbon intensity score from the accredited certifier;
storing the certified carbon intensity score in association with the sealed submission record; and
in response to a scan event corresponding to the shipment identifier, returning the certified carbon intensity score to enable routing of the physical agricultural product shipment based on the certified carbon intensity score.
